(19) United States
(12) Patent Application Publication
(10) Pub. No.: US 2006/0233972 A1
(43) Pub. Date: Oct. 19, 2006

(54) Optical functional film, production method thereof, and polarizing plate and image display device using the same

(75) Inventors: Yuuzou Muramatsu, Minami-Ashigara-shi (JP); Naohiro Matsunaga, Minami-Ashigara-shi (JP)

Correspondence Address: BUCHANAN INGERSOLL PC, POST OFFICE BOX 1404, ALEXANDRIA, VA, 22313-1404, US

(73) Assignee: FUJI PHOTO FILM CO., LTD., Minami-Ashigara-shi (JP)

(21) Appl. No.: 11/359,507

(22) Filed: Feb. 23, 2006

(30) Foreign Application Priority Data
Mar. 3, 2005 (JP) 2005-059123

(51) Int. Cl. C09K 19/00

(52) U.S. Cl. 428/1.31; 428/1.1

(57) ABSTRACT

An optical functional film comprises: a transparent support comprising a cellulose acylate film and having a thickness of less than 80 μm; and at least one coating layer on at least one surface of the transparent support, wherein said at least one coating layer has a total thickness of 5 μm or less.

### BACKGROUND OF THE INVENTION

1. Field of the Invention

The present invention relates to an optical functional film comprising a cellulose acylate film having formed thereon a coating layer, a production method thereof, and a polarizing plate and an image display device using the optical functional film.

2. Description of the Related Art

With recent progress of a liquid crystal display device (LCD) having a large screen, a liquid crystal display device in which an optical functional film such as antireflection film or light-diffusing sheet is disposed is increasing. For example, in various image display devices such as liquid crystal display device (LCD), plasma display panel (PDP), electroluminescence display (ELD) and cathode ray tube display device (CRT), the antireflection film is disposed on the display surface to prevent reduction in the contrast due to reflection of outside light or projection of an image. Also, the light-diffusing sheet is used for backlight of a liquid crystal display device.

The liquid crystal display device usually has a main construction such that a thin liquid crystal layer is sandwiched by substrates and a plurality of films having a functional layer are further stacked therein. This device can be fabricated to have a relatively small thickness as compared with conventional display devices, but since the number of layers stacked is large, sufficient reduction in the total thickness cannot be achieved and more thinning is demanded. Also, there arises a phenomenon that the optical functional film disposed in the liquid crystal display device undergoes a physical change, for example, due to change in the environmental conditions and affects the visibility. In various papers, it is reported that this phenomenon is related to the thinning of film. In order to avoid this, attempts are being recently made to reduce the thickness of a support for various functional layers.

One problem caused by the thinning of a support is increase of curling and in order to improve the curling, for example, a technique of providing a backcoat layer on another surface of the functional layer across the support has been proposed (see, JP-A-2004-109771). However, this technique has a problem that the thickness increases by just the film thickness of the additionally provided layer and the cost rises, and the deterioration of the physical strength still remains as a defect. Accordingly, improvement is demanded.

On the other hand, the polarizing plate is an indispensable optical material in a liquid crystal display device and generally has a structure such that two sheets of protective film are protecting a polarizing film. When an antireflective function or other optical functions can be imparted to such a protective film, this can lead to enhancement of visibility and thinning of a display device.

The protective film for use in the polarizing plate must have a sufficiently high adhesive property for ensuring lamination with a polarizing film. As for the method of improving the adhesive property to a polarizing film, the protective film is usually subjected to a saponification treatment so as to render the protective film surface hydrophilic.

### SUMMARY OF THE INVENTION

An object of the present invention is to provide an optical functional film excellent in the antireflectivity and other optical performances and reduced in the thickness and recover the worsened curling properties and reduced surface strength attributable to the reduction in the thickness, and also provide a method for stably supplying a coated material thereof Another object of the present invention is to provide a polarizing plate and an image display device which are subjected to an antireflection treatment by using the film.

The above-described objects can be attained by an optical functional film having the following constitutions, a production method thereof, and a polarizing plate and an image display device each using the optical functional film.

(1) An optical functional film comprising: a transparent support comprising a cellulose acylate film and having a thickness of less than 80 μm; and at least one coating layer on at least one surface of the transparent support, wherein said at least one coating layer has a total thickness of 5 μm or less.

(2) The optical functional film as described in (1) above, wherein the transparent support has a thickness of 10 to 40 μm.

(3) The optical functional film as described in (1) or (2) above, wherein said at least one coating layer comprises at least one inorganic fine particle-containing layer, and at least one of said at least one inorganic fine particle-containing layer comprises an inorganic fine particle having an average particle diameter of 0.02 to 0.3 μm.

(4) The optical functional film as described in (3) above, wherein the inorganic fine particle in at lease one of said at least one inorganic fine particle-containing layer is an electrically conducting inorganic fine particle.

(5) The optical functional film as described in (4) above,

wherein the coating layer comprising the electrically conducting inorganic fine particle is coated on the side closest to the support out of all of said at least one coating layer.

(6) The optical functional film as described in any one of (1) to (5) above,

wherein at least one of said at least one coating layer comprises a composition obtained by curing a polyfunctional acrylate-based compound having added thereto alkylene oxides.

(7) The optical functional film as described in any one of (1) to (6) above,

wherein said at least one layer comprises at least two layers including a light-diffusing layer and a low refractive index layer lower in the refractive index by 0.02 or more than the light-diffusing layer, and

the light-diffusing layer is provided on the side closer to the support than the low refractive index layer.

(8) The optical functional film as described in any of (1) to (7) above, wherein said at least one coating layer comprises a light-diffusing layer comprising a light-transparent fine particle, and the light-transparent fine particle are a resin particle having a compressive strength of 22 to 59 N/mm² (2.2 to 6.0 kg f/mm²).

(9) The optical functional film as described in any of (1) to (8) above, wherein said at least one coating layer comprises a light-diffusing layer comprising a light-transparent fine particle, and the light-transparent fine particle has an average particle diameter of from 20 to 100% of a film thickness of the light-diffusing layer.

(10) The optical functional film as described in any of (1) to (9) above, wherein said at least one coating layer comprises a light-diffusing layer comprising a light-transparent fine particle, and the light-transparent fine particle has a flat shape like that of a blood platelet and have an average thickness (T₁) to average maximum diameter (D₁) ratio (T₁/D₁) in the range of 0.4 to 0.7.

(11) The optical functional film as described in any of (1) to (10) above, wherein said at least one coating layer comprises a light-diffusing layer, the light-diffusing layer comprises: a light-transparent resin having a refractive index of 1.45 to 1.90; and a light-transparent fine particle, and the difference in the refractive index between the light-transparent resin and the light-transparent fine particle is from 0 to 0.30.

(12) The optical functional film as described in any one of (1) to (11) above, wherein any one of said at least coating layer comprises at least one of an organosilane compound represented by formula (a) and a derivative thereof:
(R¹⁰)ₛ—Si(Z)₄₋ₛ Formula (a):
wherein R¹⁰ represents a substituted or unsubstituted alkyl group or a substituted or unsubstituted aryl group, Z represents a hydroxyl group or a hydrolyzable group, and s represents an integer of 1 to 3.

(13) The optical functional film as described in any one of (7) to (12) above, wherein the low refractive index layer comprises a hollow silica fine particle.

(14) The optical functional film as described in any one of (7) to (13) above,

wherein the low refractive index layer is formed by a crosslinking or polymerization reaction of a fluorine-containing compound represented by formula (1): 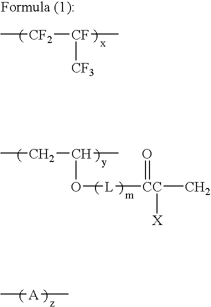
wherein L represents a linking group having a carbon number of 1 to 10, m represents 0 or 1, X represents a hydrogen atom or a methyl group, A represents an arbitrary vinyl monomer polymerization unit and may be a single polymerization unit or may comprise a plurality of polymerization units, x, y and z represent mol% of respective constituent polymerization units and each represents a value satisfying 30≦x≦60, 5≦y≦70 and 0≦z≦65.

(15) The optical functional film as described in (14) above, wherein the low refractive index layer comprises a silicone compound and its surface has a dynamic friction coefficient of 0.15 or less.

(16) The optical functional film as described in any of (1) to (15) above,

wherein the cellulose acylate film is a cellulose acylate film having a water content of 2.9% by mass or less at 25° C. and a relative humidity of 80%.

(17) The optical functional film as described in any of (1) to (16) above, wherein the cellulose acylate film is a cellulose acylate film comprising: at least one hydrophobizing agent having a hydrogen-bonding and hydrogen- donating group; and at least one low-molecular compound having a mass-average octanol-water partition coefficient (hereinafter log P) of 4 to 12 and a molecular weight of 100 to 2,000.

(18) The optical functional film as described in any of (1) to (17) above, wherein the transparent support is a transparent support comprising a cellulose acylate film having a water content of 2.9% by mass or less at 25° C. and a relative humidity of 80% and containing at least one hydrophobizing agent having a hydrogen-bonding and hydrogen-donating group and at least one low-molecular compound having a mass-average octanol-water partition coefficient (hereinafter log P) of 4 to 12 and a molecular weight of 100 to 2,000.

(19) The optical functional film as described in (17) or (18) above, wherein the hydrophobizing agent is a phosphoric ester compound and the cellulose acylate film contains the phosphoric ester compound in the amount of 5% by weight or less of the cellulose acylate.

(20) The optical functional film as described in any of (15) to (19) above, wherein the cellulose acylate film is a cellulose acylate film having a moisture permeability of 20 to 200 g/m² per 24 hours in an environment having a temperature of 25° C. and a relative humidity of 90%.

(21) A method for producing the optical functional film described in any one of (1) to (20) above, comprising forming any one of said at least one coating layer by coating a coating solution according to a die coating method.

(22) A polarizing plate comprising: a polarizing film; and two protective films for the polarizing film, wherein the optical functional film claimed described in any one of (1) to (20) above is used for at least one of the protective films.

(23) An image display device in which the antireflection film described in any one of (1) to (20) above or the polarizing plate described in (22) above is disposed on the image display surface.

(24) The image display device as described in (23) above, wherein the image display device is a TN-mode, STN-mode, IPS-mode, VA-mode or OCB-mode transmissive, reflective or semi-transmissive liquid crystal display device.

### BRIEF DESCRIPTION OF THE DRAWINGS

FIG. 1 is a cross-sectional view schematically showing one preferred embodiment (layer structure of antireflection film) of the optical functional film of the present invention;

FIG. 2 is a cross-sectional view of a coater 10 using a slot die 13 with which the present invention is practiced;

FIG. 3A shows the cross-sectional shape of the slot die 13 of the present invention;

FIG. 3B is the cross-sectional shape of a conventional slot die 30;

FIG. 4 is a perspective view showing the slot die 13 and its periphery in the coating step when the present invention is practiced;

FIG. 5 is a cross-sectional view showing the low-pressure chamber 40 and the web W approaching closer (the back plate 40a is integral with the chamber 40 body); and

FIG. 6 is a cross-sectional view showing the low-pressure chamber 40 and the web W approaching closer (the back plate 40a is fixed to the chamber 40 with a screw 40c).

1 denotes an optical functional film (antireflection film); 2 denotes a transparent support; 3 denotes a light-diffusing layer; 4 denotes a low refractive index layer; 5 denotes a light-transparent fine particle; 10 denotes a coater; 11 denotes a backup roller; W denotes a web; 13 denotes a slot die; 14 denotes a coating solution; 14a denotes a bead; 14b denotes a coating film; 15 denotes a pocket; 16 denotes a slot; 17 denotes an end lip; 18 denotes a land; 18a denotes a upstream lip land; 18b denotes a downstream lip land; lup denotes a land length, of upstream lip land 18a; I_{LO} denotes a land length of downstream lip land 18b; LO denotes an overbite length (difference between the distance from the downstream lip land 18b to the web W and the distance from the upstream lip land 18a to the web W); G_{L} denotes a gap between the end lip 17 and the web W (gap between the downstream lip land 18b and the web W); 30 denotes a conventional slot die; 31a denotes an upstream lip land; 31b denotes a downstream lip land; 32 denotes a pocket; 33 denotes a slot; 40 denotes a low-pressure chamber; 40a denotes a back plate; 40b denotes a side plate; 40c denotes a screw; G_{B} denotes a gap between the back plate 40a and the web W; and G_{S} denotes a gap between the side plate 40b and the web W

### DETAILED DESCRIPTION OF THE INVENTION

In the present invention, the term “from (numerical value I) to (numerical value II)” as used for expressing a physical value, a characteristic value or the like means that “(numerical value I) or more and (numerical value II) or less”. Also, the term “(meth)acryloyl” means “at least either acrylate or methacrylate”. The same applies to “(meth)acrylate”, “(meth)acrylic acid” and the like.

The present invention is described in detail below.

<Layer Construction>

In the optical functional film of the present invention, the following known layer constructions can be used.

Representative examples of the layer construction include:

transparent support/light-diffusing layer,

transparent support/light-diffusing layer/low refractive index layer,

transparent support/hard coat layer/low refractive index layer, and

transparent support/hard coat layer/medium refractive index layer/high refractive index layer/low refractive index layer.

Examples of the layer which may be provided between the transparent support and the surface layer include a light-diffusing layer, an antistatic layer (for example, when reduction in the surface resistivity from the display side is required or attachment of dusts to the surface becomes a problem), a hard coat layer (when the hardness is insufficient only by the antiglare layer), a low refractive index layer, a moisture-proof layer, an adhesion improving layer and a rainbow unevenness (interference unevenness) preventing layer. Also, an antifouling layer containing a slipping agent or the like may be provided on the low refractive index layer. In the case where a light-diffusing layer is provided on a transparent support and the hardness is insufficient only by the light-diffusing layer, a hard coat layer may be provided between the transparent support and the light-diffusing layer.

The antistatic layer is preferably in contact with the transparent support but may be provided in other positions.

When a low refractive index layer is provided on an antiglare layer to a thickness of around ¼ of the light wavelength, the surface reflection can be reduced by the principle of thin-film interference.

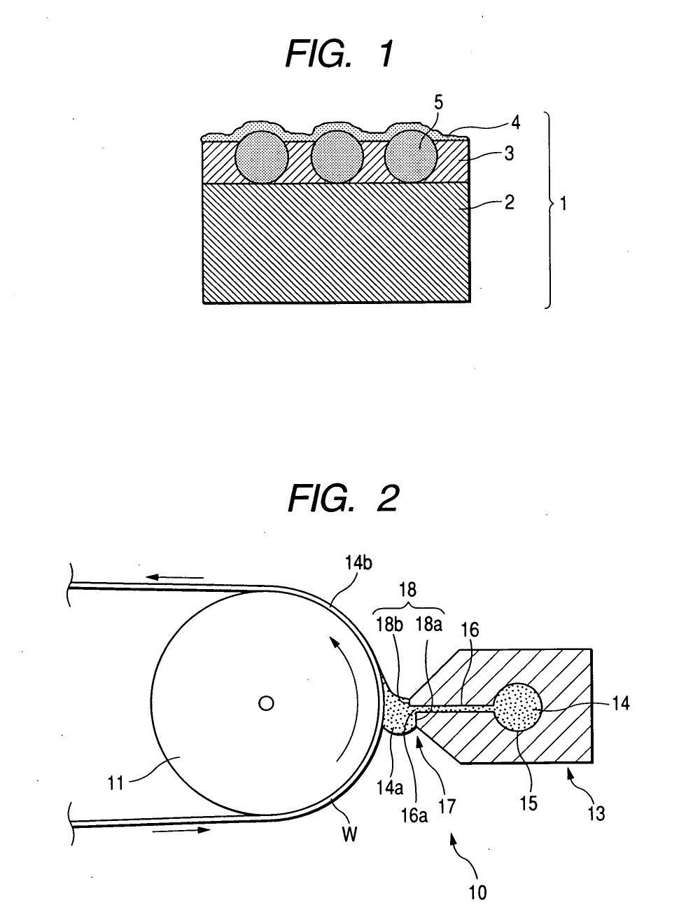

FIG. 1 is a cross-sectional view schematically showing one preferred embodiment of the optical functional film of the present invention.

The optical functional film 1 in this embodiment shown in FIG. 1 comprises a transparent support 2, a light-diffusing layer 3 formed on the transparent support 2, and a low refractive index layer 4 formed on the light-diffusing layer 3. Other than these, for example, a layer for preventing attachment of stains to the surface may be provided.

The light-diffusing layer 3 comprises a light-transparent resin and a light-transparent fine particle 5 dispersed in the light-transparent resin.

In the present invention, the refractive indexes of the layers constituting the optical functional film having an antireflection layer preferably satisfy the following relationship:

refractive index of light-diffusing layer>refractive index of transparent support>refractive index of low refractive index layer.

The light-diffusing layer having antiglare property and light-diffusing property preferably has all of antiglare property, light-diffusing property, hard coat property and high refractive index property. In this embodiment, the light-diffusing layer comprises one layer but may comprise a plurality of layers, for example, from 2 to 4 layers. Furthermore, the light-diffusing layer may be provided directly on the transparent support as shown in this embodiment but may also be provided through another layer such as antistatic layer or moisture-proof layer.

In order to reduce the curling, the total film thickness of the coating layer in the optical functional film of the present invention needs to be 5 μm or less based on the film thickness of the support. The total film thickness is preferably 4.5 μm, more preferably 4 μm or less.

The light-diffusing layer is described below.

<Light-Diffusing Layer>

The light-diffusing layer is formed for the purpose of imparting an antiglare property by the effect of surface scattering and preferably a hard coat property for enhancing the scratch resistance of the film, and if desired, for utilizing the scattering effect inside the layer. Also, the refractive index of the light-diffusing layer is preferably high relatively to the low refractive index layer and for enhancing the antireflectivity, the refractive index is preferably higher by 0.02 or more, more preferably by 0.03 or more, than that of the low refractive index layer. The light-diffusing layer preferably comprises, as essential components, a light-transparent resin capable of imparting a hard coat property, a light-transparent fine particle for imparting light diffusibility, and a solvent.

The thickness of the light-diffusing layer is preferably 5 μm or less, more preferably from 2 to 4.5 μm, and most preferably from 3 to 4 μm.

<Light-Transparent Fine Particle>

The average particle diameter of the light-transparent fine particle is preferably from 0.5 to 8 μm, more preferably from 0.7 to 6 μm, still more preferably from 1 to 5 μm. Also, the average particle diameter of the light-transparent fine particle is preferably from 20 to 100%, more preferably from 15 to 90%, still more preferably from 20 to 80%, of the thickness of the light-diffusing layer.

If the average particle diameter is less than 0.5 μm, the scattering angle distribution of light expands to a wide angle and this disadvantageously brings about letter blurring of the display, whereas if it exceeds 8 μm, the coated surface is excessively glared and also, there arises a problem such as rising of the material cost.

Specific preferred examples of the light-transparent fine particle include a resin particle such as poly((meth)acrylate) particle, a crosslinked poly((meth)acrylate) particle, polystyrene particle, crosslinked polystyrene particle, crosslinked poly(acryl-styrene) particle, melamine resin particle and benzoguanamine resin particle. Examples of the inorganic fine particle include a silica bead (refractive index: 1.44) and an alumina bead (refractive index: 1.63). For the purpose of preventing precipitation or reducing the refractive index, a hollow inorganic bead is also preferably used.

Among these, a crosslinked polystyrene particle, a crosslinked poly((meth)acrylate) particle and a crosslinked poly(acryl-styrene) particle are preferred. By adjusting the refractive index of the light-transparent resin according to the refractive index of the light-transparent fine particle selected from these particles, the internal haze, surface haze and centerline average roughness of the present invention can be achieved. More specifically, a combination of a light-transparent resin (refractive index after curing: 1.50 to 1.53) mainly comprising a trifunctional or greater functional (meth)acrylate monomer which is preferably used in the antiglare layer of the present invention, and a light-transparent fine particle comprising a crosslinked poly(meth)acrylate polymer having an acryl content of 50 to 100 mass %, is preferred, and a combination of the above-described light-transparent resin and a light-transparent fine particle (refractive index: 1.48 to 1.54) comprising a crosslinked poly(styrene-acryl) copolymer is more preferred.

Also, two or more kinds of light-transparent fine particles differing in the particle diameter may be used in combination. In this case, an antiglare property can be imparted by virtue of a light-transparent fine particle having a larger particle diameter and the surface roughness can be reduced by virtue of a light-transparent fine particle having a smaller particle diameter.

The light-transparent fine particle is blended such that the content thereof in the formed light-diff-using layer becomes from 3 to 30 mass %, more preferably from 5 to 20 mass %, based on the entire solid content of the layer. If the light-transparent fine particle content is less than 3 mass %, the antiglare property and the light-diffusing property are insufficient, whereas if it exceeds 30 mass %, there arises a problem such as image blurring, white turbid surface or glaring.

The coated amount of the light-transparent fine particle is preferably from 10 to 1,000 mg/m², more preferably from 100 to 700 mg/m².

The light-transparent fine particles according to the present invention preferably have a refractive index of from 1.40 to 1.90, more preferably from 1.44 to 1.75 and still more preferably from 1.48 to 1.65. Moreover, the light- transparent fine particles are preferably resin particles, so that those particles may not settle in the coating solution.

Also, in the present invention, the difference in the refractive index between the light-transparent resin and the light-transparent fine particle (refractive index of light-transparent fine particle−refractive index of light-transparent resin) is preferably, in terms of the absolute value, from 0 to 0.30, more preferably from 0 to 0.2. If this difference exceeds 0.30, there arises a problem such as film letter burring, reduction in dark room contrast or white turbid surface.

Here, the refractive index of the light-transparent resin may be quantitatively evaluated by directly measuring the refractive index with an Abbe refractometer or by measuring a spectral reflection spectrum or a spectral ellipsometry. The refractive index of the light-transparent fine particle is determined by dispersing light-transparent fine particles in an equal amount in solvents prepared by changing the mixing ratio of two kinds of solvents differing in the refractive index and thereby varied in the refractive index, measuring the turbidity, and reading the refractive index of the solvent on giving a minimum turbidity by an Abbe refractometer.

When the light-transparent fine particles according to the present invention are resin particles, they are preferably resin particles having a compressive strength of from 22 to 59 N/mm² (from 2.2 to 6.0 kgf/mm²) and more preferably from 29 to 59 N/mm² (from 3.0 to 6.0 kgf/mm²) so that the optical functional film may have an improved surface strength and may not be brittle.

For the purpose of the present invention, the compressive strength is the compressive strength which causes the diameter of the particles to undergo 10% of deformation. The compressive strength which causes the diameter of the particles to undergo 10% of deformation is the value of particle compressive strength (S10 strength) obtained by introducing into the following formula the load which causes the particle diameter to undergo 10% of deformation when a compression test is conducted up to a load of 1 gf (9.8 mN) on a single resin particle by using a micro compression testing machine, MCTW201, of Shimadzu Corpoartion, and the original particle diameter (Incidentally, since the following value is expressed by kgf/mm², the value is further multiplied by 9.8 for being expressed by N/mm²:
S10 strength (kgf/mm²)=2.8× load (kgf)/{(π×particle diameter (mm)×particle diameter (mm)}

The proportion of the crosslinking monomers in all of the monomers forming the resin particles according to the present invention may be employed as an index for the cross-linking ratio of those particles. The proportion of the crosslinking monomers is preferably 15% or more, more preferably from 17 to 80% and still more preferably from 20 to 70%, all on a mass basis, for realizing an improved film strength.

Examples of the production method for the light-transparent fine particle include a suspension polymerization method, an emulsion polymerization method, a soap-free emulsion polymerization method, a dispersion polymerization method and a seed polymerization method, and any of these production methods may be employed. These methods may be performed by referring to a method described, for example, Takayuki Ohtsu and Masaetsu Kinoshita, Kobunshi Gosei no Jikken Ho Experimental Technique for the Synthesis of Polymer), page 130 and pp. 146-147, Kagaku Dojin Sha, Gosei Kobunshi (Synthetic Polymer), Vol. 1, pp. 246-290, ibid., Vol. 3, pp. 1-10, U.S. Pat. Nos. 2,543,503, 3,508,304, 2,746,275, 3,521,560 and 3,580,320, JP-A-10-1561, JP-A-7-2908, JP-A-5-297506 and JP-A-2002-145919.

As for the particle size distribution of the light-transparent fine particle, in view of the controllability of haze value and diffusing property as well as the homogeneity of coated surface state, a monodisperse particle is preferred. For example, when a particle having a particle size 20% or more larger than the average particle diameter is defined as a coarse particle, the proportion of the coarse particle is preferably 1% or less, more preferably 0.1% or less, still more preferably 0.01% or less, based on the number of all particles. For obtaining a particle having such a particle size distribution, classification after preparation or synthesis reaction is effective and by increasing the number of classifications or intensifying the classification degree, a particle having a preferred distribution can be obtained.

The classification is preferably performed by using a method such as air classification method, centrifugal classification method, precipitation classification method, filtration classification method and electrostatic classification method.

The light-transparent fine particles are not specifically limited in shape and may be shaped like balls, spindles, rods, blood platelets or bowls or irregularly, though they are preferably shaped like blood platelets, or flat. In a relatively thin particle-containing layer like the coating layer according to the present invention, the particles shaped like blood platelets are effective for both increasing the clarity of blackness of any black portion of the screen of a liquid crystal display unit when the optical functional film is disposed on the surface of the screen, and preventing dazzling.

When the particles are flat like blood platelets, they preferably have an average thickness (T₁) to average maximum diameter (D₁) ratio (T₁/D₁) in the range of from 0.4 to 0.7 and more preferably from 0.4 to 0.6. The average thickness (T₁) of platelet-shaped particles means the average of lengths of 100 arbitrary particles as measured along the sides of shorter diameter and the average maximum diameter (D₁) means the average of the lengths as measured along the sides of the maximum diameter. It is preferable for the ease of particle preparation that the platelet-shaped particles be resin particles.

Platelet-shaped, or flat particles can be prepared by a method in which seed polymerization is carried out by dispersing a monomer capable of forming an acrylic resin in a reaction medium having seed particles dispersed therein, the monomer being dispersed in the amount of 120 to 2,500 parts by weight against 100 parts by weight of seed particles, the acrylic resin having a solubility parameter (σ₂) SO related to the solubility parameter (σ₁) of the resin forming the seed particles that the difference (σ₁−σ₂) may be in the range of 0.1 to 6.5, as described in JP-A-2000-38455.

(Light-Transparent Resin)

The light-transparent resin is preferably a binder polymer having, as its main chain, a saturated hydrocarbon chain or a polyether chain, more preferably, is a binder polymer having a saturated hydrocarbon chain as its main chain. Also, the binder polymer preferably has a crosslinked structure.

The binder polymer having a saturated hydrocarbon chain as its main chain is preferably a polymer of an unsaturated ethylene monomer. The binder polymer having a saturated hydrocarbon chain as its main chain and a crosslinked structure is preferably a polymer (copolymer) of monomer(s) having two or more unsaturated ethylene groups.

For allowing the binder polymer to have a high refractive index, it is possible to select a high refractive index monomer containing, in its monomer structure, at least one type of atom selected from an aromatic ring, a halogen atom other than fluorine, a sulfur atom, a phosphorus atom, and a nitrogen atoms, a monomer having a fluorene backbone in its molecule, or the like.

Examples of the monomer having two or more unsaturated ethylene groups include esters of polyalcohol and (meth)acrylic acid (e.g., ethylene glycol di(meth)acrylate, butanediol di(meth)acrylate, hexanediol di(meth)acrylate, 1,4-cyclohexane diacrylate, pentaerythritol tetra(meth)acrylate, pentaerythritol tri(meth)acrylate, trimethylolpropane tri(meth)acrylate, trimethylolethane tri(meth)acrylate, dipentaerythritol tetra(meth)acrylate, dipentaerythritol penta(meth)acrylate, dipentaerythritol hexa(meth)acrylate, pentaerythritol hexa(meth)acrylate, 1,2,3-cyclohexane tetramethacrylate, polyurethane polyacrylate, and polyesters polyacrylate), modified ethylene oxides or modified caprolactones of the esters, vinyl benzene and derivatives thereof (e.g., 1,4-divinylbenzene, 4-vinylbenzoic acid-2-acryloyl ethyl esters, and 1,4-divinylcyclohexanone), vinyl sulfone (e.g., divinyl sulfone), acrylamide (e.g., methylene bisacrylamide) and methacrylamide. Two or more types of monomers may be used in combination.

Specific examples of the high refractive index monomers include (meth)acrylates having a fluorene backbone, bis(4-methacryloylthiophenyl)sulfide, vinylnaphthalene, vinyl phenyl sulfide, 4-methacryloxyphenyl-4′-methoxyphenylthioether, and the like. Two or more types of monomers may be used in combination.

The polymerization of such an ethylenically unsaturated group-containing monomer can be performed by the irradiation of ionizing radiation or under heating in the presence of a photoradical initiator or a thermal radical initiator.

Accordingly, the light-diffusing layer may be formed by preparing a coating solution containing a monomer for the formation of a light-transparent resin, such as ethylenically unsaturated monomer described above, a photoradical or thermal radical initiator and a light-transparent particle and if desired, further containing an inorganic filler described later, coating the coating solution on a transparent support, and curing it through a polymerization reaction by the effect of ionizing radiation or heat.

Examples of the photoradical polymerization initiator include acetophenones, benzoins, benzophenones, phosphine oxides, ketals, anthraquinones, thioxanthones, azo compounds, peroxides, 2,3-dialkyldione compounds, disulfide compounds, fluoroamine compounds, aromatic sulfoniums, lophine dimers, onium salts, borates, active esters, active halogens, an inorganic complex and coumarins.

Examples of the acetophenones include 2,2-dimethoxyacetophenone, 2,2-diethoxyacetophenone, p-dimethylacetophenone, 1-hydroxydimethyl phenyl ketone, 1-hydroxydimethyl-p-isopropyl phenyl ketone, 1-hydroxycyclohexyl phenyl ketone, 2-methyl-4-methylthio-2-morpholinopropiophenone, 2-benzyl-2-dimethylamino-1-(4-morpholinophenyl)-butanone, 4-phenoxydichloroacetophenone and 4-tert-butyldichloroacetophenone.

Examples of the benzoins include benzoin, benzoin methyl ether, benzoin ethyl ether, benzoin isopropyl ether, benzyl dimethyl ketal, benzoin benzenesulfonic acid ester, benzoin toluenesulfonic acid ester, benzoin methyl ether, benzoin ethyl ether and benzoin isopropyl ether.

Examples of the benzophenones include benzophenone, hydroxybenzophenone, 4-benzoyl-4′-methyldiphenyl sulfide, 2,4-dichlorobenzophenone, 4,4-dichlorobenzophenone, p-chlorobenzophenone, 4,4′-dimethylaminobenzophenone (Michler's ketone) and 3,3′,4,4′-tetra(tert-butylperoxycarbonyl)benzophenone.

Examples of the phosphine oxides include 2,4,6-trimethylbenzoyldiphenylphosphine oxide.

Examples of the active esters include 1,2-octanedione, 1-[4-(phenylthio)-2-(O-benzoyloxime)], sulfonic acid esters and cyclic active ester compounds.

Examples of the onium salts include an aromatic diazonium salt, an aromatic iodonium salt and an aromatic sulfonium salt.

Examples of the borates include ion complexes with a cationic coloring matter.

As for the active halogens, an S-triazine compound and an oxathiazole compound are known, and examples thereof include 2-(p-methoxyphenyl)-4,6-bis(trichloromethyl)-s-triazine, 2-(p-methoxyphenyl)-4,6-bis(trichloromethyl)-s-triazine, 2-(p-styrylphenyl)-4,6-bis(trichloromethyl)-s-triazine, 2-(3-Br-4-di(ethyl acetate)amino)phenyl)-4,6-bis(trichloromethyl)-s-triazine and 2-trihalomethyl-5-(p-methoxyphenyl)-1,3,4-oxadiazole.

Examples of the inorganic complex include bis-(η⁵-2,4-cyclopentadien-1-yl)-bis(2,6-difluoro-3-(1 H-pyrrol-1-yl)-phenyl)titanium.

Examples of the coumarins include 3-ketocoumarin.

One of these initiators may be used alone or a mixture thereof may be used.

Various examples are also described in Saishin UV Koka Gijutsu (Latest UV Curing Technologies), page 159, Technical Information Institute Co., Ltd. (1991), and these are useful in the present invention.

Preferred examples of the commercially available photoradical polymerization initiator of photo-cleavage type include IRGACURE (e.g., 651, 184, 819, 907, 1870 (7/3 mixed initiator of CGI-403/Irg 184), 500, 369, 1173, 2959, 4265, 4263, OXE01) produced by Ciba Specialty Chemicals, KAYACURE (e.g., DETX-S, BP-100, BDMK, CTX, BMS, 2-EAQ, ABQ, CPTX, EPD, ITX, QTX, BTC, MCA) produced by Nippon Kayaku Co., Ltd., and Esacure (e.g., KIP100F, KB1, EB3, BP, X33, KT046, KT37, KIP150, TZT) produced by Sartomer Company Inc.

The photopolymerization initiator is preferably used in an amount of 0.1 to 15 parts by mass, more preferably from 1 to 10 parts by mass, per 100 parts by mass of the polyfunctional monomer.

In addition to the photopolymerization initiator, a photosensitizer may be used. Specific examples of the photosensitizer include n-butylamine, triethylamine, tri-n-butylphosphine, Michler's ketone and thioxanthone.

Furthermore, one or more auxiliary agent such as azide compound, thiourea compound and mercapto compound may be used in combination.

Examples of the commercially available photosensitizer include KAYACURE Series (e.g., DMBI, EPA) produced by Nippon Kayaku Co., Ltd.

With respect to the thermal radical initiator, for example, an organic or inorganic peroxide, or an organic azo or diazo compound may be used.

More specifically, examples of the organic peroxide include benzoyl peroxide, halogen benzoyl peroxide, lauroyl peroxide, acetyl peroxide, dibutyl peroxide, cumene hydroperoxide and butyl hydroperoxide; examples of the inorganic peroxide include hydrogen peroxide, ammonium persulfate and potassium persulfate; examples of the azo compound include 2,2′-azobis(isobutyronitrile), 2,2′-azobis(propionitrile) and 1,1′-azobis(cyclohexanecarbonitrile); and examples of the diazo compound include diazoaminobenzene and p-nitrobenzenediazonium.

The polymer containing a polyether as the main chain is preferably a ring-opened polymer of a polyfunctional epoxy compound. The ring-opening polymerization of a polyfunctional epoxy compound may be performed by the irradiation of ionizing radiation or under heating in the presence of a photoacid generator or a thermal acid generator.

Accordingly, the light-diffusing layer can be formed by preparing a coating solution containing a polyfunctional epoxy compound, a photoacid or thermal acid generator, a light-transparent fine particle and an inorganic filler, coating the coating solution on a transparent support, and then curing it through a polymerization reaction by the effect of ionizing radiation or heat.

A crosslinked structure may be introduced into the binder polymer by using a crosslinking functional group-containing monomer in place of or in addition to the monomer having two or more ethylenically unsaturated groups to introduce the crosslinking functional group into the polymer, and reacting the crosslinking functional group.

Examples of the crosslinking functional group include an isocyanate group, an epoxy group, an aziridine group, an oxazoline group, an aldehyde group, a carbonyl group, a hydrazine group, a carboxyl group, a methylol group and an active methylene group. In addition, a vinylsulfonic acid, an acid anhydride, a cyanoacrylate derivative, a melamine, an etherified methylol, an ester, a urethane, and a metal alkoxide (e.g., tetramethoxysilane) may also be utilized as the monomer for introducing a crosslinked structure. A functional group which exhibits a crosslinking property as a result of decomposition reaction, such as block isocyanate group, may also be used. That is, in the present invention, the crosslinking functional group may be a functional group which exhibits reactivity not directly but as a result of decomposition.

The binder polymer having such a crosslinking functional group can form a crosslinked structure after coating and heating.

For increasing the film strength or reducing the cure shrinkage and in turn curling and in the case where reduction of internal scattering is intended, for decreasing the haze value ascribable to the internal scattering, the light-diffusing layer preferably contains an inorganic fine particle comprising an oxide of at least one metal selected from silicon, titanium zirconium, aluminum, indium, zinc, tin and antimony, in addition to the light-transparent fine particle. Particularly, use of an electrically conducting inorganic fine particle such as ATO, ITO, zinc antimonate and antimony pentoxide is preferred, because antistatic property can be imparted at the same time. The average particle diameter of the particle which is substantially used after dispersion of the inorganic fine particle is preferably from 0.3 to 0.02 μm, more preferably from 0.2 to 0.02 μm, still more preferably from 0.1 to 0.02 μm. The average primary particle diameter of the inorganic fine particle is preferably 0.2 μm or less, more preferably 0.1 μm or less, still more preferably 0.05 μm or less. Such an inorganic fine particle generally has a specific gravity higher than that of an organic material and can increase the density of the coating composition and therefore, there is provided an effect of decreasing the precipitation rate of the light-transparent fine particle.

The surface of the inorganic fine particle for use in the light-diff-using layer is preferably subjected to a silane coupling treatment or a titanium coupling treatment, and a surface treating agent having a functional group capable of reacting with the binder species on the filler surface is preferred.

In the case of using an inorganic fine particle, the amount added thereof is preferably from 10 to 90%, more preferably from 20 to 80%, still more preferably from 30 to 75%, based on the entire mass of the antiglare layer.

Incidentally, such an inorganic fine particle has a particle diameter sufficiently smaller than the wavelength of light and therefore, causes no scattering, and the dispersion obtained by dispersing the fine particle in the binder polymer possesses a property as an optically uniform substance.

Also, an organosilane compound may be used in the light-diffulsing layer. The amount added of the organosilane compound is preferably from 0.001 to 50 mass %, more preferably from 0.01 to 20 mass %, still more preferably from 0.05 to 10 mass %, yet still more preferably from 0.1 to 5 mass %, based on the entire solid content of the layer containing it (layer to which added).

<Polyfunctional Acrylate-Based Compound Having Added Thereto Alkylene Oxides>

The light-diffusing layer preferably contains a polyfunctional acrylate-based compound having added thereto alkylene oxides so as to reduce the curling. The acrylate-based compound as used in the present invention indicates an acrylate monomer containing an acryloyl group, or a methacrylate monomer containing a methacryloyl group.

The alkylene oxides for use in the present invention include ethylene oxide, propylene oxide, an alkylene oxide having a carbon number larger than that of those oxides, and modified alkylene oxides. In the present invention, the ethylene oxide is referred to as “EO”, the propylene oxide is referred to as “PO”, the alkylene oxide having a carbon number larger than that of those oxides is referred to as “AO”, and the alkylene oxide which can be regarded as “AO” containing a functional group (e.g., carbonyl), such as caprolactone, is referred to as “modified AO” in a broad sense. Furthermore, the number of repetitions of EO, PO, AO or modified AO is indicated by “n”.

In the oxide-added polyfunctional acrylate-based monomer, the number n of EO, PO, AO or modified AO is preferably n=1 to 15, more preferably n=1 to 10, still more preferably n=1 to 6, yet still more preferably n=1 to 3 (at this time, n represents an average number). Also, in the case where alkylene oxides are added to a plurality of sites in one molecule of the compound, the number of sites is preferably from 1 to 6, more preferably 3 to 6.

Specific examples thereof include the following monomers, but the present invention is not limited thereto.
A-1 EO-Added trimethylolpropane tri(meth)acrylate (n=1)
A-2 EO-Added trimethylolpropane tri(meth)acrylate (n=1.5)
A-3 EO-Added trimethylolpropane tri(meth)acrylate (n=2)
A-4 EO-Added trimethylolpropane tri(meth)acrylate (n=6)
A-5 PO-Added trimethylolpropane tri(meth)acrylate (n=1)
A-6 PO-Added trimethylolpropane tri(meth)acrylate (n=2)
A-7 EO-Added glycerin tri(meth)acrylate (n=2)
A-8 PO-Added glycerin tri(meth)acrylate (n=2)
A-9 EO-Added pentaerythritol tetra(meth)acrylate (n=2)
A-10 PO-Added pentaerythritol tetra(meth)acrylate (n=2)
A-11 EO-Added ditrimethylolpropane tetra(meth)acrylate (n=2)
A-12 PO-Added ditrimethylolpropane tetra(meth)acrylate (n=2)
A-13 EO-Added dipentaerythritol penta(meth)acrylate (n=1.5)
A-14 EO-added dipentaerythritol hexa(meth)acrylate (n=1)
A-15 PO-Added dipentaerythritol penta(meth)acrylate (n=1.5)
A-16 PO-Added dipentaerythritol hexa(meth)acrylate (n=1)
A-17 Tris(2-hydroxyethyl)isocyanurate tri(meth)acrylate
A-18 AO-added dipentaerythritol hexa(meth)acrylate (n=1)
A-19 Modified AO-added dipentaerythritol hexa(meth)acrylate (n=1)
A-20 Modified AO-added dipentaerythritol hexa(meth)acrylate (n=2)

These compounds may be used in combination.

Among those specific examples, A-1, A-2, A-10 and A-19 are preferred.

The polyfunctional acrylate-based compound having added thereto alkylene oxides is preferably used in an amount of 3 to 80 mass %, more preferably from 5 to 60 mass %, still more preferably from 7 to 40 mass %, based on all compounds for forming the light-transparent resin in the coating composition. Other examples of the compounds for forming the light-transparent resin include ethylenically unsaturated group-containing monomers described above and polymers dissolvable in the coating solvent for the light-diffusing layer.

(Surfactant for Anti-Glare Layer)

In order to ensure the uniform surface state against, in particular, uneven coating, uneven drying, a point defect, or the like, the light-difffusing layer of the present invention preferably has either or both of fluorine-based and silicone-based surfactants contained in a coating composition for use in forming an optical diffusion layer. Particularly, the fluorine-based surfactant is preferably used because the addition of a smaller amount thereof suppresses a defective surface state, such as uneven coating, uneven drying, a point defect, or the like, of the anti-reflection film of the present invention.

The purpose thereof is to increase the uniformity of a surface state and provide the suitability for high-speed coating, thereby increasing the productivity.

A preferable example of the fluorine-based surfactant is a fluoroaliphatic group-containing copolymer (which may be abbreviated as a “fluorine-based polymer”), and the fluorine-based polymer is an acryl or methacrylic resin which is characterized by containing a repeating unit corresponding to a monomer described in (i) below or a repeating unit corresponding to a monomer described in (ii) below, or a copolymer with a vinyl monomer copolymerizable therewith.

(i) Fluoroaliphatic group-containing monomer represented by the following general formula A

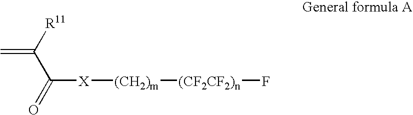

In general formula A, R¹¹ denotes a hydrogen atom or a methyl group, X denotes an oxygen atom, a sulfur atom, or —N(R¹²)—, m denotes an integer from 1 to 6, and n denotes an integer from 2 to 4. R¹² denotes a hydrogen atom or an alkyl group having one to four carbon atoms (specifically, a methyl group, an ethyl group, a propyl, or a butyl group), preferably a hydrogen atom or a methyl group. X is preferably an oxygen atom.

(ii) Monomer copolymerizable with the above (i), represented by the following general formula B

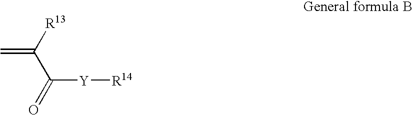

In general formula B, R¹³ denotes a hydrogen atom or a methyl group, and Y denotes an oxygen atom, a sulfur atom, or —N(R¹⁵)—. R¹⁵ denotes a hydrogen atom or alkyl having one to four carbon atoms (specifically, a methyl group, an ethyl group, a propyl group, or a butyl group), preferably a hydrogen atom or a methyl group. Y is preferably an oxygen atom, —N(H)—, or N(CH₃)—.

R¹⁴ denotes a straight-chain, branched, or cyclic alkyl group having four to twenty carbon atoms, which may have a substituent group. Examples of the substituent group for alkyl of R¹⁴ include, but not limited to, a hydroxy group, an alkyl carbonyl group, an aryl carbonyl group, a carboxyl group, an alkyl ether group, an aryl ether group, a halogen atom (e.g., a fluorine atom, a chlorine atom, a bromine atom, etc.), nitro, a cyano group, an amino group, and the like. As the straight-chain, branched, or cyclic alkyl group having four to twenty carbon atoms, a butyl group, a pentyl group, a hexyl group, a heptyl group, an octyl group, a nonyl group, a decyl group, an undecyl group, a dodecyl group, a tridecyl group, a tetradecyl group, a pentadecyl group, an octadecyl group, or an eicosanyl group, which may be straight-chained or branched, or a monocyclic cycloalkyl group, such as a cyclohexyl group, a cycloheptyl group, or the like, or a polycyclic cycloalkyl group, such as a bicycloheptyl group, a bicyclodecyl group, a tricycloundecyl group, a tetracyclododecyl group, an adamanthyl group, a norbomyl group, a tetracyclodecyl group, or the like, is preferably used.

The amount of the fluoroaliphatic group-containing monomer represented by general formula A and used in the fluorine-based polymer for use in the present invention is in an amount of 10 mol % or more, preferably 15 to 70 mol %, and more preferably 20 to 60 mol %, based on each monomer of the fluorine-based polymer.

The mass average molecular weight of the fluorine-based polymer for use in the present invention is preferably from 3,000 to 100,000, more preferably from 5,000 to 80,000.

Furthermore, the amount added of the fluorine-based polymer for use in the present invention is preferably from 0.001 to 5 mass %, more preferably from 0.005 to 3 mass %, still more preferably from 0.01 to I mass %, based on the coating solution. If the amount added of the fluorine-based polymer is less than 0.001 mass %, a sufficiently high effect may not be obtained, whereas if it exceeds 5 mass %, drying of the coating film does not proceed satisfactorily or the performance (for example, reflectance and scratch resistance) as the coating film may be adversely affected.

Specific exemplary structures of the fluorine-based polymer composed of the fluoroaliphatic group-containing monomer represented by general formula A are shown below. The present invention is not limited to these examples. Note that numbers in the following formulas indicate a molar ratio of monomer components, and Mw indicates a mass-average molecular weight.

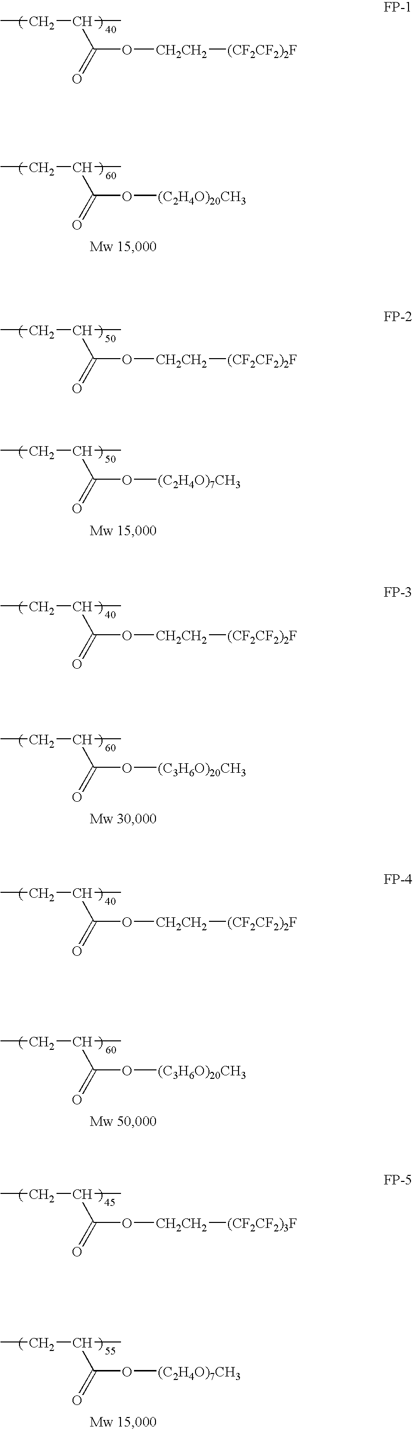

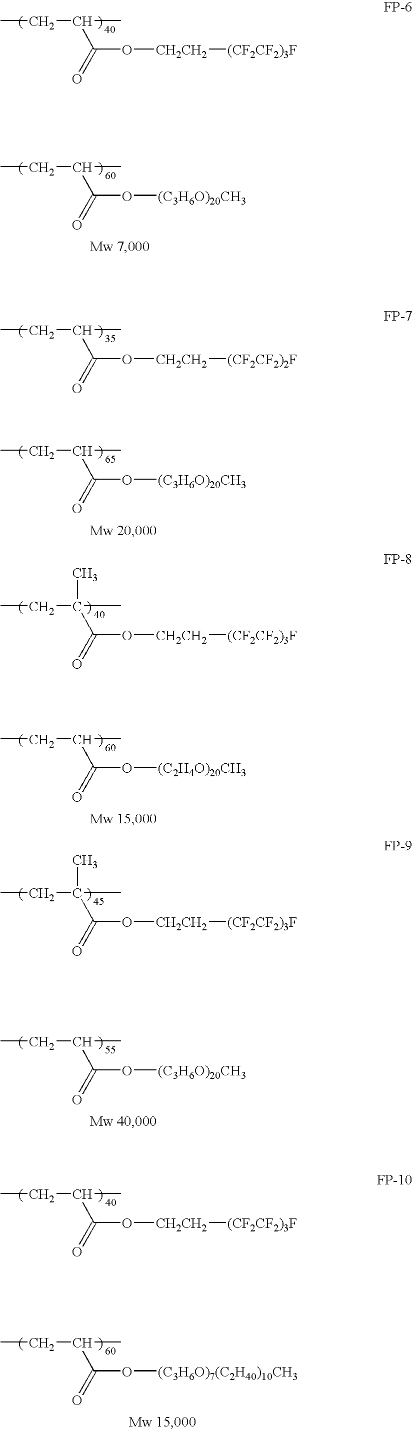

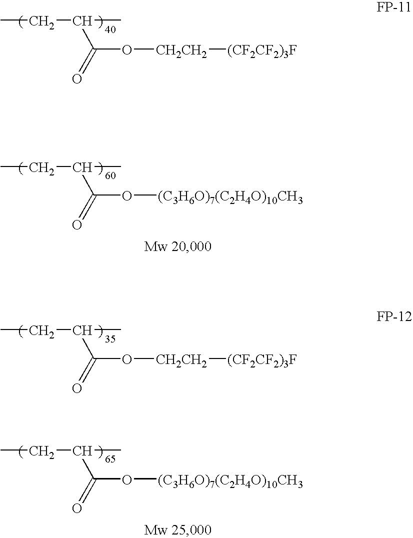

However, by using the fluorine-based polymer as described above, an F atom-containing functional group is caused to segregate on a surface of the light-diffusing layer, leading to a reduction in the surface energy of the light-diff-using layer, and causing a deterioration in the anti-reflection property when the light-diffusing layer is overcoated with a low refractive index layer. It is presumed that this is due to a deterioration in the wettability of a curable composition used for forming the low refractive index layer, which increases fine roughness of the low refractive index layer which cannot be visually observed. The present inventors found that in order to solve such a problem, it is effective to adapt the structure and added amount of the fluorine-based polymer to control the surface energy of the light-diffusing layer to be preferably 20 mN·m⁻¹ to 50 mN·m⁻¹, more preferably 30 mN·m⁻¹ to 40 mN·m⁻¹. In order to realize the surface energy as described above, an F/C ratio of peaks derived from fluorine and carbon atoms, which is measured by X-ray photoelectron spectroscopy, needs to be 0.1 to 1.5.

Alternatively, the above purpose can also be achieved by selecting, when applying an upper layer, a fluorine-based polymer which can be extracted into a solvent for forming the upper layer, so that uneven distribution does not occur on a surface (=interface) of a lower layer, to provide tight adhesion ability between the upper and lower layers, thereby preventing a reduction in the surface free energy, which can, even in the case of high-speed coating, maintain the uniformity of a surface state and provide an anti-reflection film with high abrasion resistance, to control the surface energy of the anti-glare layer to fall within the above range before the application of the low refractive index layer. An example of such a material is an acryl or methacrylic resin which is characterized by containing a repeating unit corresponding to a fluoroaliphatic group-containing monomer represented by general formula C shown below, and a copolymer thereof with a vinyl monomer copolymerizable therewith.

(iii) Fluoroaliphatic group-containing monomer represented by the following general formula C

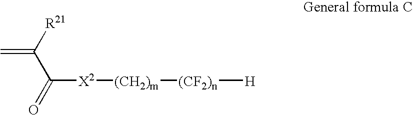

In general formula C, R²¹ denotes a hydrogen atom, a halogen atom, or a methyl group, more preferably a hydrogen atom and a methyl group. X² denotes an oxygen atom, a sulfur atom, or —N(R²²)—, more preferably an oxygen atom and —N(R²²)—, and even more preferably an oxygen atom. “mn” is an integer from 1 to 6 (more preferably 1 to 3, and even more preferably 1), and n is an integer from 1 to 18 (more preferably 4 to 12, and even more preferably 6 to 8). R²² denotes a hydrogen atom or an alkyl group having one to eight carbon atoms, which may have a substituent group, more preferably a hydrogen atom and an alkyl group having one to four carbon atoms, and even more preferably a hydrogen atom or a methyl group. X is preferably an oxygen atom.

Also, the fluorine-based polymer may contain, as its components, two or more types of fluoroaliphatic group-containing monomers represented by general formula C.

(iv) Monomer copolymerizable with the above (iii), represented by the following general formula D

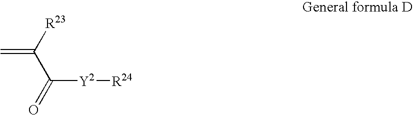

In general formula D, R²³ denotes a hydrogen atom, a halogen atom, or a methyl group, more preferably a hydrogen atom and a methyl group. Y² denotes an oxygen atom, a sulfur atom, or —N(R²⁵)—, more preferably an oxygen atom and —N(R²⁵)—, and even more preferably an oxygen atom. R²⁵ denotes a hydrogen atom or an alkyl group having one to eight carbon atoms, more preferably a hydrogen atom and an alkyl group having one to four carbon atoms, and even more preferably a hydrogen atom and a methyl group.

R²⁴ denotes a straight-chain, branched, or cyclic alkyl group having one to twenty carbon atoms, which may have a substituent group, an alkyl group including a poly(alkyleneoxy) group, or an aromatic group (e.g., a phenyl group or a naphthyl group) which may have a substituent group, more preferably a straight-chain, branched, or cyclic alkyl group having one to twelve carbon atoms and an aromatic group whose total number of carbon atoms is 6 to 18, and even more preferably a straight-chain, branched, or cyclic alkyl group having one to eight carbon atoms.

Specific exemplary structures of a fluorine-based polymer including a repeating unit corresponding to the fluoroaliphatic group-containing monomer represented by general formula C are shown below. The present invention is not limited to these examples. Note that numbers in the following formulas indicate a molar ratio of monomer components, and Mw indicates a mass-average molecular weight.

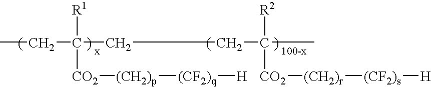

| | R | n | Mw |
|---|---|---|---|
| P-1 | H | 4 | 8000 |
| P-2 | H | 4 | 16000 |
| P-3 | H | 4 | 33000 |
| P-4 | CH₃ | 4 | 12000 |
| P-5 | CH₃ | 4 | 28000 |
| P-6 | H | 6 | 8000 |
| P-7 | H | 6 | 14000 |
| P-8 | H | 6 | 29000 |
| P-9 | CH₃ | 6 | 10000 |
| P-10 | CH₃ | 6 | 21000 |
| P-11 | H | 8 | 4000 |
| P-12 | H | 8 | 16000 |
| P-13 | H | 8 | 31000 |
| P-14 | CH₃ | 8 | 3000 |

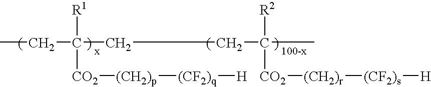

| | x | R¹ | p | q | R² | r | s | Mw |
|---|---|---|---|---|---|---|---|---|
| P-15 | 50 | H | 1 | 4 | CH₃ | 1 | 4 | 10000 |
| P-16 | 40 | H | 1 | 4 | H | 1 | 6 | 14000 |
| P-17 | 60 | H | 1 | 4 | CH₃ | 1 | 6 | 21000 |
| P-18 | 10 | H | 1 | 4 | H | 1 | 8 | 11000 |
| P-19 | 40 | H | 1 | 4 | H | 1 | 8 | 16000 |
| P-20 | 20 | H | 1 | 4 | CH₃ | 1 | 8 | 8000 |
| P-21 | 10 | CH₃ | 1 | 4 | CH₃ | 1 | 8 | 7000 |
| P-22 | 50 | H | 1 | 6 | CH₃ | 1 | 6 | 12000 |
| P-23 | 50 | H | 1 | 6 | CH₃ | 1 | 6 | 22000 |
| P-24 | 30 | H | 1 | 6 | CH₃ | 1 | 6 | 5000 |

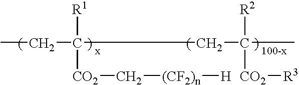

| | x | R¹ | n | R² | R³ | Mw |
|---|---|---|---|---|---|---|
| FP-148 | 80 | H | 4 | CH₃ | CH₃ | 11000 |
| FP-149 | 90 | H | 4 | H | C₄H₉(n) | 7000 |
| FP-150 | 95 | H | 4 | H | C₆H₁₃(n) | 5000 |
| FP-151 | 90 | CH₃ | 4 | H | CH₂CH(C₂H [symbol] )C₄H₉(n) | 15000 |
| FP-152 | 70 | H | 6 | CH₃ | C₂H₅ | 18000 |
| FP-153 | 90 | H | 6 | CH₃ | 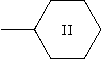 | 12000 |
| FP-154 | 80 | H | 6 | CH₃ | C₄H₉(sec) | 9000 |
| FP-155 | 90 | H | 6 | CH₃ | C₁₂H₂₅(n) | 21000 |
| FP-156 | 60 | CH₃ | 6 | H | CH₃ | 15000 |
| FP-157 | 60 | H | 8 | H | CH₃ | 10000 |
| FP-158 | 70 | H | 8 | H | C₂H₅ | 24000 |
| FP-159 | 70 | H | 8 | H | C₄H₉(n) | 5000 |
| FP-160 | 50 | H | 8 | H | C₄H₉(n) | 16000 |
| FP-161 | 80 | H | 8 | CH₃ | C₄H₉(iso) | 13000 |
| FP-162 | 80 | H | 8 | CH₃ | C₄H₉(t) | 9000 |
| FP-163 | 60 | H | 8 | H | 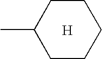 | 7000 |
| FP-164 | 80 | H | 8 | H | CH₂CH(C₂H [symbol] )C₄H₉(n) | 8000 |
| FP-165 | 90 | H | 8 | H | C₁₂H₂₅(n) | 6000 |
| FP-166 | 80 | CH₃ | 8 | H | C₄H₉(sec) | 18000 |
| FP-167 | 70 | CH₃ | 8 | H | CH₃ | 22000 |
| FP-168 | 70 | H | 10 | CH₃ | H | 17000 |
| FP-169 | 90 | H | 10 | H | H | 9000 |

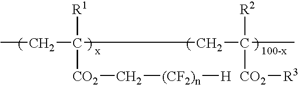

| | x | R¹ | n | R² | R³ | Mw |
|---|---|---|---|---|---|---|
| FP-170 | 95 | H | 4 | CH₃ | -13 (CH₂CH₂O)₂—H | 18000 |
| FP-171 | 80 | H | 4 | H | -13 (CH₂CH₂O)₂—CH₃ | 16000 |
| FP-172 | 80 | H | 4 | H | -13 (CH₃CH₆O)₇—H | 24000 |
| FP-173 | 70 | CH₃ | 4 | H | -13 (CH₃CH₆O)₁₂—H | 18000 |
| FP-174 | 90 | H | 6 | H | -13 (CH₂CH₂O)₂—H | 21000 |
| FP-175 | 90 | H | 6 | CH₃ | -13 (CH₂CH₂O) [symbol] —H | 9000 |
| FP-176 | 80 | H | 6 | H | -13 (CH₂CH₂O)₂—C₄H₉(n) | 12000 |
| FP-177 | 80 | H | 6 | H | -13 (CH₃CH₆O)₇—H | 34000 |
| FP-178 | 75 | F | 6 | H | -13 (CH₃CH₆O)₁₂—H | 11000 |
| FP-179 | 85 | CH₃ | 6 | CH₃ | -13 (CH₃CH₆O)₂₀—H | 18000 |
| FP-180 | 95 | CH₃ | 6 | CH₃ | -13 (CH₂CH₂OH | 27000 |
| FP-181 | 80 | H | 8 | CH₃ | -13 (CH₂CH₂O) [symbol] —H | 12000 |
| FP-182 | 95 | H | 8 | H | -13 (CH₂CH₂O)₉—CH₃ | 20000 |
| FP-183 | 90 | H | 8 | H | -13 (CH₃CH₆O)₇—H | 8000 |
| FP-184 | 95 | H | 8 | H | -13 (CH₃CH₆O)₂₀—H | 15000 |
| FP-185 | 90 | F | 8 | H | -13 (CH₃CH₆O)₁₂—H | 12000 |
| FP-186 | 80 | H | 8 | CH₃ | -13 (CH₂CH₂O)₂—H | 20000 |
| FP-187 | 95 | CH₃ | 8 | H | -13 (CH₂CH₂O)₉—CH₃ | 17000 |
| FP-188 | 90 | CH₃ | 8 | H | -13 (CH₃CH₆O)₇—H | 34000 |
| FP-189 | 80 | H | 10 | H | -13 (CH₂CH₂O)₂—H | 19000 |
| FP-190 | 90 | H | 10 | H | -13 (CH₃CH₆O)₇—H | 8000 |
| FP-191 | 80 | H | 12 | H | -13 (CH₂CH₂O)₇—CH₃ | 7000 |
| FP-192 | 95 | CH₃ | 12 | H | -13 (CH₃CH₆O)₇—H | 10000 |

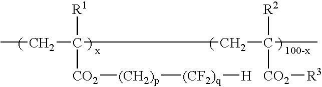

| | x | R¹ | p | q | R² | R³ | Mw |
|---|---|---|---|---|---|---|---|
| FP- | 80 | H | 2 | 4 | H | C₄H₉(n) | 18000 |
| 193 | | | | | | | |
| FP- | 90 | H | 2 | 4 | H | —(CH₂CH₂O)₉—CH₃ | 16000 |
| 194 | | | | | | | |
| FP- | 90 | CH₃ | 2 | 4 | F | C₆H₁₃(n) | 24000 |
| 195 | | | | | | | |
| FP- | 80 | CH₃ | 1 | 6 | F | C₄H₉(n) | 18000 |
| 196 | | | | | | | |
| FP- | 95 | H | 2 | 6 | H | —(C₃H₆O)₇—H | 21000 |
| 197 | | | | | | | |
| FP- | 90 | CH₃ | 3 | 6 | H | —CH₂CH₂OH | 9000 |
| 198 | | | | | | | |
| FP- | 75 | H | 1 | 8 | F | CH₃ | 12000 |
| 199 | | | | | | | |
| FP- | 80 | H | 2 | 8 | H | —CH₂CH(C [symbol] H [symbol] )C [symbol] H [symbol] (n) | 34000 |
| 200 | | | | | | | |
| FP- | 90 | CH₃ | 2 | 8 | H | —(C₃H₆O)₇—H | 11000 |
| 201 | | | | | | | |
| FP- | 80 | H | 3 | 8 | CH₃ | CH₃ | 18000 |
| 202 | | | | | | | |
| FP- | 90 | H | 1 | 10 | F | C₄H₉(n) | 27000 |
| 203 | | | | | | | |
| FP- | 95 | H | 2 | 10 | H | —(CH₂CH₂O)₉—CH₃ | 12000 |
| 204 | | | | | | | |
| FP- | 85 | CH₃ | 2 | 10 | CH₃ | C₄H₉(n) | 20000 |
| 205 | | | | | | | |
| FP- | 80 | H | 1 | 12 | H | C₆H₁₃(n) | 8000 |
| 206 | | | | | | | |
| FP- | 90 | H | 1 | 12 | H | —(C₃H₆O)₁₃—H | 15000 |
| 207 | | | | | | | |
| FP- | 60 | CH₃ | 3 | 12 | CH₃ | C₂H₅ | 12000 |
| 208 | | | | | | | |
| FP- | 60 | H | 1 | 16 | H | —CH₂CH(C [symbol] H [symbol] )C [symbol] H [symbol] (n) | 20000 |
| 209 | | | | | | | |
| FP- | 80 | CH₃ | 1 | 16 | H | —(CH₂CH₂O)₂—C₄H₉(n) | 17000 |
| 210 | | | | | | | |
| FP- | 90 | H | 1 | 18 | H | —CH₂CH₂OH | 34000 |
| 211 | | | | | | | |
| FP- | 60 | H | 3 | 18 | CH₃ | CH₃ | 19000 |
| 212 | | | | | | | |

Also, by preventing reduction of the surface energy at the time of overcoating the light-diffusing layer with the low refractive index layer, deterioration of the anti-reflection property can be prevented. The above purpose can also be achieved by using a fluorine-based polymer, when applying the light-diffusing layer, to reduce the surface tension of a coating liquid and thereby to increase the uniformity of a surface state and maintain the high productivity resulted from high-speed coating, and employing, after the application of the anti-glare layer, a surface treatment technique, such as corona treatment, UV treatment, heat treatment, saponification treatment, or solvent treatment (particularly preferable is corona treatment) to prevent reduction of the surface free energy and thereby to control the surface energy of the light-diffusing layer to fall within the above range before applying the low refractive index layer.

Also, the coating composition for forming the light-diffusing layer of the present invention may additionally contain a thixotropy agent. Examples of the thixotropy agent include silica, mica, and the like, which are 0.1 μm or less in size. Typically, the content of the additive is preferably about 1 to 10 parts by mass with respect to 100 parts by mass of an ultraviolet curable resin.

The light-diffusing layer for use in the present invention is wet-coated directly on a transparent support in many cases and therefore, the solvent used for the coating composition is a particularly important factor. Examples of the property required of the solvent include to satisfactorily dissolve various solutes such as light-transparent resin described above, not to dissolve the above-described light-transparent fine particle, to less generate coating unevenness and drying unevenness in the process from coating to drying, not to dissolve the support (this is necessary for preventing a trouble such as worsening of planarity or whitening) and at the same time, to swell the support to a minimum extent (this is necessary for ensuring adhesive property).

In the case of using a triacetyl cellulose for the support, specific preferred examples of the main solvent include various ketones (e.g., methyl ethyl ketone, acetone, methyl isobutyl ketone, cyclohexanone) and various cellosolves (e.g., ethyl cellosolve, butyl cellosolve, propylene glycol monomethyl ether). By adding a small amount of a solvent having a hydroxyl group to the main solvent selected from the above, the antiglare property can be adjusted and this is particularly preferred. When the hydroxyl group-containing solvent added in a small amount remains later than the main solvent in the drying process of the coating composition, the antiglare property can be strengthened. Therefore, the vapor pressure of this solvent at a temperature of 20 to 30° C. is preferably lower than that of the main solvent. For example, a combination of methyl isobutyl ketone (vapor pressure at 21.7° C: 16.5 mmHg) as the main solvent and propylene glycol (vapor pressure at 20.0° C.: 0.08 mmHg) as the hydroxyl group-containing solvent added in a small amount, is preferred. The mixing ratio of the main solvent to the hydroxyl group-containing solvent added in a small amount is, in terms of the mass ratio, preferably from 99:1 to 50:50, more preferably from 95:5 to 70:30. If the ratio exceeds 50:50, the stability of the coating solution or the surface quality in the drying step after coating greatly fluctuates and this is not preferred.

<Hard Coat Layer>

For imparting physical strength to the optical functional film of the present invention, a hard coat may be provided. In particular, the hard coat layer is preferably provided between the transparent support and the outermost layer.

The hard coat layer is preferably formed by a crosslinking or polymerization reaction of an ionizing radiation-curable compound. For example, a coating material containing an ionizing radiation-curable polyfunctional monomer or oligomer is coated on a transparent support, and the polyfunctional monomer or oligomer is caused to undergo a crosslinking or polymerization reaction, whereby the hard coat layer can be formed. The functional group of the ionizing radiation-curable polyfunctional monomer or oligomer is preferably a functional group polymerizable by the effect of light, electron beam or radiation, more preferably a photopolymerizable functional group.

Examples of the photopolymerizable functional group include an unsaturated polymerizable functional group such as (meth)acryloyl group, vinyl group, styryl group and allyl group. Among these, a (meth)acryloyl group is preferred.

Specific examples of the photopolymerizable polyfunctional monomer having a photopolymerizable functional group include those described above with respect to the light-diffusing layer. The polyfunctional monomer is preferably polymerized by using a photopolymerization initiator or a photosensitizer, and the photopolymerization reaction is preferably performed by irradiating an ultraviolet ray after the hard coat layer is coated and dried.

The hard coat layer is preferably provided on the surface of a transparent support by coating a coating material for the formation of a hard coat layer.

The coating solvent is preferably methyl ethyl ketone, methyl isobutyl ketone or cyclohexanone. The coating solvent is preferably used such that the content of the ketone-based solvent is 10 mass % or more, more preferably 30 mass % or more, still more preferably 60 mass % or more, based on all solvents contained in the coating composition.

In the case of producing the hard coat layer by a crosslinking or polymerization reaction of an ionizing radiation-curable compound, the crosslinking or polymerization reaction is preferably performed in an atmosphere having an oxygen concentration of 4 vol % or less.

The thickness of the hard coat layer may be appropriately designed according to usage. The thickness of the hard coat layer is preferably from 1 to 10 μm, more preferably from 2 to 7 μm, still more preferably from 3 to 5 μm.

The strength of the hard coat layer is, in the pencil hardness test according to JIS K5400, preferably H or more, more preferably 2H or more, and most preferably 3H or more. Also, in the Taber test according to JIS K5400, the abrasion loss of the specimen between before and after the test is preferably smaller.

In the hard coat layer, a resin, a dispersant, a surfactant, an antistatic agent, a silane coupling agent, a thickener, a coloration inhibitor, a coloring agent (e.g., pigment, dye), a defoaming agent, a leveling agent, a flame retardant, an ultraviolet absorbent, an adhesion-imparting agent, a polymerization inhibitor, an antioxidant, a surface modifier and the like may also be added. Furthermore, for the purpose of, for example, increasing the hardness of the hard coat layer, suppressing the cure shrinkage or controlling the refractive index, an inorganic fine particle having an average particle diameter of 1 to 200 nm, which is described later, may be added.

In addition, for the purpose of imparting an antiglare or light-diffusing function or a function of enlarging a view angle of a liquid crystal display device, a particle having an average particle diameter of 0.2 to 10 μm, which is described later, may also be incorporated.

<Antistatic Layer>

In the optical functional film of the present invention, an antistatic layer is preferably used for preventing dusts (e.g., dirt) from attaching to the surface. The dust resistance can be brought out by decreasing the surface resistance on the surface. The surface resistance is preferably 1×10¹³ Ω/square or less, more preferably 1×10¹² Ω/square or less, still more preferably 1×10¹⁰ Ω/square or less.

The antistatic layer is preferably provided between the light-diffusing layer and the low refractive index layer or between the transparent support and the light-diffusing layer. The latter embodiment is more preferred.

The antistatic layer is preferably formed by coating a coating solution comprising an electrically conducting material (for example, an electronic conduction-type electrically conducting particle or an ion conduction-type organic compound) contained in a binding agent (e.g., binder). In particular, an electron conduction-type electrically conducting material is preferred because of its insusceptibility to the environmental change.

Preferred examples of the electrically conducting material for use in the antistatic layer include tin oxide, antimony-doped tin oxide (ATO), indium oxide, tin-doped indium oxide (ITO), zinc oxide, aluminum-doped zinc oxide, zinc antimonate and antimony pentoxide.

The primary particle of the electrically conducting material preferably has a mass average particle diameter of 1 to 200 nm, more preferably from 1 to 100 nm. The specific surface area of the electrically conducting material is preferably from 10 to 400 m²/g, more preferably from 20 to 200 m²/g.

At the dispersion, the electrically conducting material is preferably dispersed in a dispersion medium in the presence of a dispersant. The dispersion may be performed, for example, by using a dispersant containing an anionic group having an acidic proton, such as carboxyl group, sulfonic acid group (sulfo group), phosphoric acid group (phosphono group) and sulfonamide group). Examples of the dispersant having an anionic polar group include Phosphanol (e.g., PE-510, PE-610, LB-400, EC-6103, RE-410; produced by Toho Chemical Industrial Co., Ltd.), and Disperbyke (e.g., -110,-111,-116,-140,-161,-162,-163,-164, -164,-170,-171; produced by BYK Chemie Japan). The dispersant preferably further contains a crosslinking or polymerizable functional group.

As for the dispersion medium, a liquid having a boiling point of 60 to 170° C. is preferably used.

In particular, toluene, xylene, methyl ethyl ketone, methyl isobutyl ketone, cyclohexanone, butanol, propanol and cellosolves (e.g., propylene glycol monomethyl ether) are preferred, and methyl ethyl ketone, methyl isobutyl ketone and cyclohexanone are more preferred.

The electrically conducting material is preferably dispersed by using a medium-type dispersing machine such as sand grinder mill (e.g., bead mill with pin), Dyno mill, high-speed impeller mill, Eiger mill, pebble mill, roller mill, attritor, colloid mill and paint shaker.

The electrically conducting material is preferably dispersed in the dispersion medium to have a particle size as small as possible. The average particle diameter after the dispersion is preferably from 1 to 200 nm.

The binder precursor of the antistatic layer for use in the present invention is preferably, for example, an ionizing radiation-curable polyfunctional monomer or oligomer such as (meth)acryloyl group, vinyl group, styryl group and allyl group which are described above with respect to the light-diffusing layer.

The antistatic layer is preferably formed by a crosslinking or polymerization reaction of an ionizing radiation-curable compound in an atmosphere of 4 vol % or less.

The thickness of the antistatic layer may be appropriately designed according to usage. In the case of forming the antistatic layer in favor of transparency, the thickness is preferably 1 μm or less, more preferably 500 nm or less, still more preferably 200 nm or less, yet still more preferably 150 nm or less.

Also, when the antistatic layer is subjected to a hard coat treatment to serve also as a hard coat layer, the thickness is preferably from 1 to 3 μm, more preferably from 1 to 2 μm.

In addition to the above-described components (e.g., electrically conducting material, polymerization initiator, photosensitizer, binder), a resin, a surfactant, a coupling agent, a thickener, a coloration inhibitor, a coloring agent (e.g., pigment, dye), a defoaming agent, a leveling agent, a flame retardant, an ultraviolet absorbent, an infrared absorbent, an adhesion-imparting agent, a polymerization inhibitor, an antioxidant, a surface modifier and the like can also be added to the antistatic layer.

The low refractive index layer is described below.

<Low Refractive Index Layer>

In the optical functional film of the present invention, the refractive index of the low refractive index layer is from 1.30 to 1.55, preferably from 1.35 to 1.45.

If the refractive index is less than 1.30, the antireflective function may be enhanced, but the mechanical strength of the film decreases, whereas if it exceeds 1.55, the antireflective performance seriously deteriorates.

Furthermore, in view of reducing the reflectance, the low refractive index layer preferably satisfies the following mathematical formula (I):
(m/4)×0.7<n1×d1<(m/4)×1.3 Mathematical formula (I):
wherein m is a positive odd number, n1 is the refractive index of the low refractive index layer, d1 is the film thickness (nm) of the low refractive index layer, and λ is a wavelength and is a value in the range of 500 to 550 nm.

Incidentally, when mathematical formula (I) is satisfied, this means that m (a positive odd number, usually 1) satisfying mathematical formula (I) is present within the above-described wavelength range.

With respect to the low refractive index layer, for example, a low refractive index layer formed by crosslinking of a fluorine-containing resin capable of undergoing crosslinking by the effect of heat or ionizing radiation (embodiment 1), a low refractive index layer formed by a sol-gel method (embodiment 2), or a low refractive index layer using a particle and a binder polymer and having a void between particles or inside a particle (embodiment 3) is used.

The material for forming the low refractive index layer formed by crosslinking of a fluorine-containing resin capable of undergoing crosslinking by the effect of heat or ionizing radiation (embodiment 1) is described below.

The low refractive index layer is, for example, a cured film formed by coating a curable composition mainly comprising a fluorine-containing polymer, and drying and curing the coating.

<Fluorine-Containing Polymer for Low Refractive Index Layer>

The fluorine-containing polymer is preferably a polymer capable of giving, when cured, a film having a dynamic friction coefficient of 0.03 to 0.20, a contact angle with water of 90 to 120° and a pure water sliding angle of 70° or less, and undergoing crosslinking by the effect of heat or ionizing radiation, because the productivity is enhanced, for example, in the case of coating and curing the coating solution on a roll film while transporting the film as a web.

Also, in the case of applying the optical functional film of the present invention to an image display device, as the peel force with a commercially available adhesive tape is lower, a seal or a memo attached can be more easily peeled off. Therefore, the peel force is preferably 500 gf (4.9 N) or less, more preferably 300 gf (2.9N) or less, and most preferably 100 gf (0.98N) of less. Furthermore, as the surface hardness measured by a microhardness tester is higher, the optical functional film is less scratched. Therefore, the surface hardness is preferably 0.3 GPa or more, more preferably 0.5 GPa or more.

The fluorinated polymer used for the low refractive index layer is a fluorinated polymer containing fluorine atoms in an amount of 35 to 80% by mass, and a crosslinkable or polymerizable functional group. Examples of the fluorinated polymer include, in addition to hydrolysates of perfluoroalkyl group-containing silane compounds (e.g., (heptadecafluoro-1,1,2,2-tetrahydrodecyl)triethoxysilane) and dehydrated condensates thereof, fluorinated copolymers having a fluorinated monomeric unit and a crosslinkable reactiv unit as structural units. In the case of a fluorinated copolymer, the main chain thereof is preferably composed only of carbon atoms. That is, the main chain backbone preferably contains no oxygen or nitrogen atoms.

Specific examples of the fluorinated monomeric unit include fluoroolefins (e.g., fluoroethylene, vinylidenefluoride, tetrafluoroethylene, perfluorooctyl ethylene, hexafluoropropylene, and perfluoro-2,2-dimethyl-1,3-dioxole), partially or completely fluorinated alkyl ester derivatives of (meth)acrylic acid (e.g., Viscoat 6FM (manufactured by Osaka Organic Chemical Industry, Ltd.), M-2020 (manufactured by Daikin Industries, Ltd.), etc.), completely or partially fluorinated vinyl ethers, and the like. Perfluoroolefins are preferable, and hexafluoropropylene is particularly preferable from the viewpoint of refractive index, solubility, translucency, availability, and the like.

Examples of the crosslinkable reactive unit include: a structural unit obtained by polymerization of a monomer, such as glycidyl methacrylate or glycidyl vinyl ether, which originally has a self-crosslinkable functional group in its molecule; and a structural unit obtained through a polymer reaction by which a crosslinkable reactive group, such as (meth)acryloyl or the like, is introduced into a structural unit obtained by polymerization of a monomer having a carboxyl group, a hydroxy group, an amino group, a sulfo group, or the like (e.g., (meth)acrylic acid, methylol (meth)acrylate, hydroxyalkyl (meth)acrylate, allyl acrylate, hydroxyethyl vinyl ether, hydroxybutyl vinyl ether, maleic acid, crotonic acid, etc.) (note that the introduction can be carried out by, for example, a method of reacting acrylic acid chloride with a hydroxy group).

Also, in addition to the fluorinated monomeric unit and the crosslinkable reactive unit, other polymeric units can be introduced by suitably copolymerizing a monomer containing no fluorine atom, from the viewpoint of the solubility to a solvent, the translucency of the coating, and the like. The monomeric unit which can be used in combination with the fluorinated monomeric unit is not particularly limited. Examples of such a monomeric unit include olefines (ethylene, propylene, isoprene, vinyl chloride, vinylidene chloride, etc.), acrylic acid esters (acrylic acid methyl, acrylic acid methyl, acrylic acid ethyl, and acrylic acid 2-ethyl hexyl), methacrylic acid esters (methacrylic acid methyl, methacrylic acid ethyl, methacrylic acid butyl, ethylene glycol dimethacrylate, etc.), styrene derivatives (styrene, divinyl benzene, vinyl toluene, a-methylstyrene, etc.), vinyl ethers (methyl vinyl ether, ethyl vinyl ether, cyclohexyl vinyl ether, etc.), vinyl esters (vinyl acetate, vinyl propionate, vinyl cinnamate, etc.), acrylamides (N-tertbutylacrylamide, N-cyclohexylacrylamide, etc.), methacrylamides, acrylonitrile derivatives, and the like.

The fluorinated polymer may be used as appripriate in combination with a curing agent as described in Japanese Unexamined Patent Publication Nos. H10-25388 and H10-147739.

The fluorinated polymer which is particularly useful in the present invention is a random copolymer of perfluoroolefine with vinyl ethers or vinyl esters. It is particularly preferable that the fluorinated polymer have a group crosslinkable by itself (e.g., a radical reactive group, such as (meth)acryloyl or the like, and a ring-opening polymerizable group, such as an epoxy group, an oxetanyl group, or the like).

These crosslinkable group-containing polymeric units preferably account for 5 to 70 mol %, particularly preferably 30 to 60 mol %, with respect to all the polymeric units of the fluorinated polymer.

A preferable form of the fluorinated polymer for a low refractive index layer for use in the present invention is a copolymer represented by general formula (1).

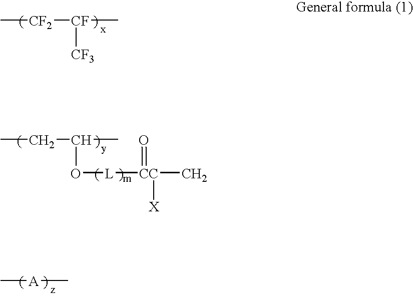

In general formula (1), L denotes a linking group having one to ten carbon atoms, more preferably a linking group having one to six carbon atoms, and particularly preferably two to four linking groups, and may have a straight-chain, branched, or cyclic structure, and may have a heteroatom selected from among O, N, and S.

Preferable examples of L include *—(CH₂)₂—O—**, *—(CH₂)₂—NH—**, *—(CH₂)₄—O—**, *—(CH₂)₆—O—**, *—(CH₂)₂O—(CH₂)₂O—**, *—CONH—(CH₂)₃—O—**, *—CH₂CH(OH)CH₂—O—**, *—CH₂CH₂OCONH(CH₂)₃—O—**, and the like (where * denotes a link site on the polymer main chain side, and ** denotes a link site on the (meth)acryloyl group side). “m” denotes 0 or 1.

In general formula (1), X denotes a hydrogen atom or a methyl group. From the viewpoint of curing reactivity, a hydrogen atom is more preferable.

In general formula (1), A denotes a repeating unit derived from any vinyl monomer, which is not limited as long as it is a monomer copolymerizable with hexafluoropropylene, and can be selected as appropriate in view of various factors, such as adhesion ability to a base material, a Tg of the polymer (which contributes to coating hardness), solubility to a solvent, translucency, a slippery property, a dust-/stain-proof property, and the like. The repeating unit may be composed of a single or a plurality of vinyl monomers, depending on the purpose.

Preferable examples of A include vinyl ethers, such as methyl vinyl ether, ethyl vinyl ether, t-butyl vinyl ether, cyclohexyl vinyl ether, isopropyl vinyl ether, hydroxyethyl vinyl ether, hydroxybutyl vinyl ether, glycidyl vinyl ether, aryl vinyl ether, and the like; vinyl esters, such as vinyl acetate, vinyl propionate, vinyl butyrate, and the like; (meth)acrylates, such as methyl (meth)acrylate, ethyl (meth)acrylate, hydroxyethyl (meth)acrylate, glycidyl methacrylate, furyl (meth)acrylate, (meth)acryloyloxypropyltrimethoxysilane, and the like; styrene derivatives, such as styrene, p-hydroxymethylstyrene, and the like; unsaturated carbonic acids, such as crotonic acid, maleic acid, itaconic acid, and the like, and derivatives thereof; and the like. Vinyl ether derivatives and vinyl esters derivatives are more preferable, and vinyl ether derivatives are particularly preferable.

“x”, “y”, and “z” denote mol % of components, preferably 30≦x≦60, 5≦y≦70, and 0≦z≦65, even more preferably 35≦x≦55, 30≦y≦60, and 0≦z≦20, and particularly preferably 40≦x≦55 , 40≦y≦55, and 0≦z≦10. Note that x+y+z=100.

A particularly preferable form of the copolymer for use in the present invention is represented by, for example, general formula (2).

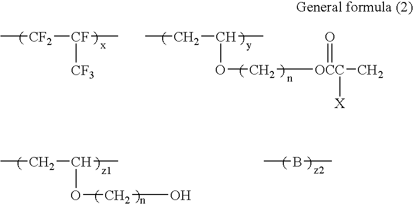

In general formula (2), X denotes the same as in general formula (1), and the preferable range thereof is also the same.

“n” denotes an integer in the range of 2≦n≦10, preferably in the range of 2≦n≦6, and particularly preferably in the range of 2≦n≦4.

B denotes a repeating unit derived from any vinyl monomers, which may be composed of a single composition or a plurality of compositions. B includes the above-described examples of A in general formula 1.

“x”, “y”, “z1”, and “z2” denote mol % of repeating units, “x” and “y” preferably satisfy 30≦x≦60 and 5≦y≦70, respectively, more preferably 35≦x≦55 and 30≦y≦60, and particularly preferably 40≦x≦55 and 40≦y≦55. “z1” and “z2” preferably satisfy 0≦z1≦65 and 0≦z2≦65, more preferably 0≦z1≦30 and 0≦z2≦10, and particularly preferably 0≦z1≦10 and 0≦z2≦5. Note that x+y+z1+z2=100.

The copolymer represented by general formula (1) or (2) can be synthesized by, for example, introducing (meth)acryloyl into a copolymer containing hexafluoropropylene and hydroxyalkyl vinyl ether components using any of the above-described methods. The reprecipitation solvent used therefor is preferably isopropanol, hexane, methanol, or the like.

Specific preferable examples of the copolymer represented by general formula (1) or (2) include those described in [0035] to [0047] of Japanese Unexamined Patent Publication No. 2004-45462, and they can be synthesized by a method described therein.

The curable composition for the low refractive index layer preferably comprises (A) the above-described fluorine polymer, (B) an inorganic fine particle and (C) an organosilane compound described later.

<Inorganic Fine Particle for Low Refractive Index Layer>

A layer where an inorganic or organic fine particle is used and a microvoid is formed between fine particles or inside the fine particle is also preferred as the low refractive layer. The average particle diameter of the fine particle is preferably from 0.5 to 200 mm, more preferably from 1 to 100 nm, still more preferably from 3 to 70 nm, and most preferably from 5 to 40 nm. The particle diameter of the fine particle is preferably as uniform (monodisperse) as possible.

The inorganic fine particle is preferably amorphous and preferably comprises an oxide, nitride, sulfide or halide of a metal, more preferably a metal oxide or a metal halide, and most preferably a metal oxide or a metal fluoride. The metal atom is preferably Na, K, Mg, Ca, Ba, Al, Zn, Fe, Cu, Ti, Sn, In, W, Y, Sb, Mn, Ga, V, Nb, Ta, Ag, Si, B, Bi, Mo, Ce, Cd, Be, Pb or Ni, more preferably Mg, Ca, B or Si. An inorganic compound containing two kinds of metals may also be used. In particular, the inorganic compound is preferably silicon dioxide, that is, silica.

The microvoid inside the inorganic fine particle can be formed, for example, by crosslinking the molecules of silica forming the particle. When the molecules of silica are crosslinked, the volume is reduced and the particle becomes porous. The microvoid-containing (porous) inorganic fine particle can be directly synthesized as a dispersion by a sol-gel method (see, JP-A-53-12732 and JP-B-57-9051 (the term “JP-B” as used herein means an “examined Japanese patent publication”)) or a precipitation method (see, Applied Optics, 27, page 3356 (1988)).

Also, the dispersion may be obtained by mechanically grinding a powder prepared by a drying-precipitation method. A commercially available porous inorganic fine particle (e.g. silicon dioxide sol) may also be employed. The inorganic fine particle having a microvoid is preferably used as a dispersion in an appropriate medium for forming the low refractive index layer. The dispersion medium is preferably water, an alcohol (e.g., methanol, ethanol, isopropanol) or a ketone (e.g., methyl ethyl ketone, methyl isobutyl ketone).

The microvoid between particles can be formed by piling at least two fine particles.

The low refractive index layer preferably contains from 5 to 50 mass % of a polymer. The polymer has a function of bonding fine particles together and maintaining the void-containing structure of the low refractive index layer. The amount of the polymer used is adjusted so that the strength of the low refractive index layer can be maintained without allowing for filling of the void.

The fine particle (particularly, inorganic fine particle) is preferably subjected to a surface treatment so as to improve the affinity for the polymer. The surface treatment can be classified into a physical surface treatment such as plasma discharge treatment and corona discharge treatment, and a chemical surface treatment using a coupling agent. The surface treatment is preferably performed by using only a chemical surface treatment or by using a physical surface treatment and a chemical surface treatment in combination. As for the coupling agent, an organoalkoxymetal compound (e.g., titanium coupling agent, silane coupling agent) is preferably used. In the case where the fine particle comprises silicon dioxide, a surface treatment with a silane coupling agent is particularly effective. The surface treatment with a coupling agent may be performed by adding a coupling agent to a fine particle dispersion and allowing the dispersion to stand at a temperature from room temperature to 60° C. for a few hours to 10 days. In order to accelerate the surface treatment reaction, an inorganic acid, an organic acid, or a salt thereof (e.g., metal salt, ammonium salt) may be added to the dispersion.

The shell-forming polymer is preferably a polymer having a saturated hydrocarbon as the main chain. A polymer containing a fluorine atom in the main or side chain is preferred, and a polymer containing a fluorine atom in the side chain is more preferred. A polyacrylic acid ester and a polymethacrylic acid ester are preferred, and an ester of a fluorine-substituted alcohol and a polyacrylic or polymethacrylic acid is most preferred.

The blending amount of the inorganic fine particle is preferably from 1 to 100 mg/m², more preferably from 5 to 80 mg/m², still more preferably from 10 to 60 mg/m². If the blending amount is too small, the effect of improving the scratch resistance decreases, whereas if it is excessively large, fine irregularities are generated on the low refractive index layer surface and the appearance (e.g., real black) or the integrated reflectance may be deteriorated. Therefore, the blending amount is preferably in the above-described range.

The average particle diameter of the inorganic fine particle is preferably from 30 to 100%, more preferably from 35 to 80%, still more preferably from 40 to 60%, of the thickness of the low refractive index layer. In other words, when the thickness of the low refractive index layer is 100 nm, the particle diameter of the inorganic fine particle is preferably from 30 to 100 nm, more preferably from 35 to 80 nm, still more preferably from 40 to 60 nm.

If the particle diameter of the inorganic fine particle is too small, the effect of improving the scratch resistance is reduced, whereas if it is excessively large, fine irregularities are generated on the low refractive index layer surface and the appearance (e.g., real black) or the integrated reflectance may be deteriorated. Therefore, the particle diameter is preferably in the above-described range. The inorganic fine particle may be either crystalline or amorphous and may be a monodisperse particle or may be even an aggregate particle as long as the predetermined particle diameter is satisfied. The shape is most preferably spherical but even if amorphous, there arises no problem.

The average particle diameter of the inorganic fine particle is measured by a Coulter counter.

In order to further reduce an increase in the refractive index of the low refractive index layer, the inorganic microparticle preferably has a hollow structure, and a refractive index of 1.17 to 1.40, more preferably 1.17 to 1.35, and even more preferably 1.17 to 1.30. The refractive index as used herein means the total refractive index of the particles, but not the refractive index of only an inorganic substance of an outer shell of the hollow structured inorganic microparticle. In this case, assuming that the radius of a void in the particle is a and the radius of the outer shell of the particle is b, the void fraction x represented by the following expression (II) is preferably 10 to 60%, more preferably 20 to 60%, and most preferably 30 to 60%.
x=(47πa³/3)/(47πb³/3)×100 Expression (II):

When the void fraction is increased so as to reduce the refractive index of the hollow inorganic microparticle, the thickness of the outer shells becomes thinner, reducing the strength of the particle. From the viewpoint of abrasion resistance, a particle having a low refractive index of less than 1.17 is useless.

Note that the refractive index of the inorganic microparticle was measured by an Abbe refractometer (manufactured by Atago Co., Ltd.).

Also, at least one type of inorganic microparticle which has an average particle size of less than 25% of the thickness of the low refractive index layer (hereinafter, referred to as a “small size inorganic microparticle”) may be used in combination with an inorganic microparticles having a particle size within the above preferable range (hereinafter, referred to as a “large size inorganic microparticle”).

The small size inorganic microparticle can be present in a gap between each large size inorganic microparticle, and therefore, can contribute as an agent for holding the large size inorganic microparticle.

In the case where the low refractive index layer is 100 nm in thickness, the average particle size of the small size inorganic microparticle is preferably 1 nm to 20 nm, more preferably 5 nm to 15 nm, and particularly preferably 10 nm to 15 nm. The use of such an inorganic microparticle is preferable in terms of material cost and the effect as a holding agent.

As described above, as the inorganic microparticle, one which has an average particle size of 30 to 100% of the thickness of the low refractive index layer as described above, a hollow structure, and a refractive index of 1.17 to 1.40 as described above, is particularly preferably used.

The inorganic microparticle may be subjected to physical surface treatment, such as plasma discharge treatment or corona discharge treatment, or chemical surface treatment with a surfactant, a coupling agent, or the like, in order to stabilize its dispersion in a dispersion or coating liquid or enhance its affinity for or adhesion ability to a binder component. The use of a coupling agent is particularly preferable. As the coupling agent, an alkoxy metal compound (e.g., a titanium coupling agent or a silane coupling agent) is preferably used. Among them, silane coupling treatment is particularly effective.

The coupling agent may be used as a surface treatment agent for the inorganic microparticle of the low refractive index layer in order to perform surface treatment before preparing the layer coating liquid. Preferably, the coupling agent may be further added as an additive when preparing the coating liquid, so that the coupling agent can be contained in the layer.

The inorganic microparticle is preferably dispersed in a medium before the surface treatment in order to reduce the load of the surface treatment.

The organic fine particle contained in the low refractive index layer according to the present invention is also preferably amorphous. The organic fine particle is preferably a polymer fine particle synthesized by a polymerization reaction (e.g., emulsion polymerization) of a monomer. The polymer as the organic fine polymer preferably contains a fluorine atom, and the proportion of the fluorine atom in the polymer is preferably 35 to 80 mass %, more preferably from 45 to 75 mass %. It is also preferred to form a microvoid inside the organic fine particle, for example, by crosslinking the polymer constituting the particle, thereby reducing the volume.

With respect to the monomer for use in the synthesis of the organic fine particle, a fluorine atom-containing monomer employed for synthesizing a fluorine-containing polymer may be used. Examples of the monomer include fluoroolefins (e.g., fluoroethylene, vinylidene fluoride, tetrafluoroethylene, hexafluoropropylene, perfluoro-2,2-dimethyl-1,3-dioxole), and fluorinated alkyl esters and fluorinated vinyl ethers of an acrylic acid or a methacrylic acid. A copolymer of a fluorine atom-containing monomer and a monomer containing no fluorine atom may also be used.

Examples of the monomer containing no fluorine atom include olefins, acrylic acid esters, methacrylic acid esters, styrenes, vinyl ethers, vinyl esters, acrylamides, methacrylamides and acrylonitriles. Examples of the polyfunctional monomer include dienes, an ester of polyhydric alcohol and acrylic acid, an ester of polyhydric alcohol and methacrylic acid, a divinyl compound, a divinylsulfone, bisacrylamides and bismethacrylamides.

<Organosilane Compound for Low Refractive Index Layer>

In view of scratch resistance, particularly, for satisfying both the antireflective ability and the scratch resistance, the curable composition preferably contains, for example, a hydrolysate and/or a partial condensate of an organosilane compound (hereinafter, the obtained reaction solution is sometimes referred to as a “sol component”).

This sol component is condensed to form a cured product during drying and heating after the coating of the curable composition, and thereby functions as a binder of the low refractive index layer. Furthermore, in the present invention, the above-described fluorine-containing polymer is contained and therefore, a binder having a three-dimensional structure is formed by the irradiation of actinic rays.

The organosilane compound is preferably an organosilane compound represented by the following formula [A]:
(R¹⁰)ₘ—Si(X)₄₋ₘ Formula [A]:

In formula [A], R¹⁰ represents a substituted or unsubstituted alkyl group or a substituted or unsubstituted aryl group. Examples of the alkyl group include methyl, ethyl, propyl, isopropyl, hexyl, decyl and hexadecyl. The alkyl group is preferably an alkyl group having a carbon number of 1 to 30, more preferably from 1 to 16, still more preferably from 1 to 6. Examples of the aryl group include phenyl and naphthyl, with a phenyl group being preferred.

X represents a hydroxyl group or a hydrolyzable group, and examples thereof include an alkoxy group (preferably an alkoxy group having a carbon number of 1 to 5, such as methoxy group and ethoxy group), a halogen atom (e.g., Cl, Br, I) and a group represented by R²COO (wherein R² is preferably a hydrogen atom or an alkyl group having a carbon number of 1 to 5, such as CH₃COO and C₂H₅COO). Among these, an alkoxy group is preferred, and a methoxy group and an ethoxy group are more preferred.

m represents an integer of 1 to 3, preferably 1 or 2, more preferably 1.

When a plurality of R¹⁰'s or X's exist, the plurality of R¹⁰'s or X's may be the same or different from each other.

Examples of a substituent contained in R¹⁰ include, but are not limited to, halogen atoms (e.g., fluorine, chlorine, bromine, etc.), a hydroxy group, a mercapto group, a carboxyl group, an epoxy group, alkyl groups (e.g., methyl, ethyl, i-propyl, propyl, t-butyl, etc.), aryl groups (e.g., phenyl, naphthyl, etc.), aromatic heterocyclic groups (e.g., furyl, pyrazolyl, pyridyl, etc.), alkoxy groups (e.g., methoxy, ethoxy, i-propoxy, hexyloxy, etc.), aryloxy (e.g., phenoxy, etc.), alkylthio groups (e.g., methylthio, ethylthio, etc.), arylthio groups (e.g., phenylthio, etc.), alkenyl groups (e.g., vinyl, l-propenyl, etc.), acyloxy groups (e.g., acetoxy, acryloyloxy, methacryloyloxy, etc.), alkoxycarbonyl groups (e.g., methoxycarbonyl, ethoxycarbonyl, etc.), aryloxycarbonyl groups (e.g., phenoxycarbonyl, etc.), carbamoyl groups (e.g., carbamoyl, N-methylcarbamoyl, N,N-dimethylcarbamoyl, N-methyl-N-octylcarbamoyl, etc.), acylamino groups (e.g., acetylamino, benzoylamino, acrylamino, methacrylamino, etc.), and the like. These substituents may be further substituted.

When a plurality of R¹⁰'s exist, at least one of them is preferably a substituted alkyl group or a substituted aryl group.

Among the organosilane compounds represented by general formula (A), organosilane compounds having a vinyl-polymerizable substituent represented by the following general formula (B) are preferable.

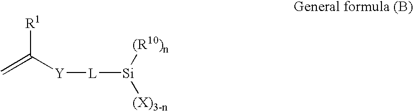

In general formula (B), R¹ denotes a hydrogen atom, a methyl group, an ethoxy group, an alkoxycarbonyl group, a cyano group, a fluorine atom, or a chlorine atom. Examples of the alkoxycarbonyl group include a methoxycarbonyl group, an ethoxycarbonyl group, and the like. A hydrogen atom, a methyl group, a methoxy group, a methoxycarbonyl group, a cyano group, a fluorine atom, and a chlorine atom are preferable. A hydrogen atom, a methyl group, a methoxycarbonyl group, a fluorine atom, and a chlorine atom are more preferable. A hydrogen atom and a methyl group are particularly preferable.

Y denotes a single bond or *—COO—**, *—CONH—**, or *—O—**, preferably a single bond, *—COO—**, and *—CONH—**, more preferably a single bond and *—COO—**, and particularly preferably *—COO—**. “*” denotes a site at which linkage to ═C(R¹)— occurs, and “**” denotes a site at linkage to L occurs.

L denotes a divalent linking group. Specific examples thereof include substituted or unsubstituted alkylene groups, substituted or unsubstituted arylene groups, substituted or unsubstituted alkylene groups having a linking group (e.g., ether, ester, amide, etc.) incorporated therein, and substituted or unsubstituted arylene groups having a linking group incorporated therein, preferably substituted or unsubstituted alkylene groups, substituted or unsubstituted arylene groups, and alkylene groups having a linking group incorporated therein, more preferably unsubstituted alkylene groups, unsubstituted arylene groups, and alkylene groups having an ether or ester linking group incorporated therein, and particularly preferably unsubstituted alkylene groups and alkylene groups having an ether or ester linking group incorporated therein. Examples of the substituent include halogen, a hydroxy group, a mercapto group, a carboxyl group, epoxy groups, alkyl groups, aryl groups, and the like. These substituents may be further substituted.

“n” denotes 0 or 1. When a plurality of X's exist, the plurality of X's may be the same or different from each other. “n” is preferably 0.

R¹⁰ has the same meaning as defined in general formula (A), and is preferably a substituted or unsubstituted alkyl group or an unsubstituted aryl group, and more preferably an unsubstituted alkyl group or an unsubstituted aryl group.

X has the same meaning as defined in general formula (A), and is preferably a halogen atom, a hydroxy group, or an unsubstituted alkoxy group, more preferably a chlorine atom, a hydroxy group, or an unsubstituted alkoxy group having one to six carbon atoms, even more preferably a hydroxy group or an alkoxy group having one to three carbon atoms, and particularly preferably a methoxy group.

Two or more types of compounds represented by general formulas (A) and (B) may be used in combination. Specific examples of the compounds represented by general formulas (A) and (B) will be given below, but the present invention is not limited thereto.

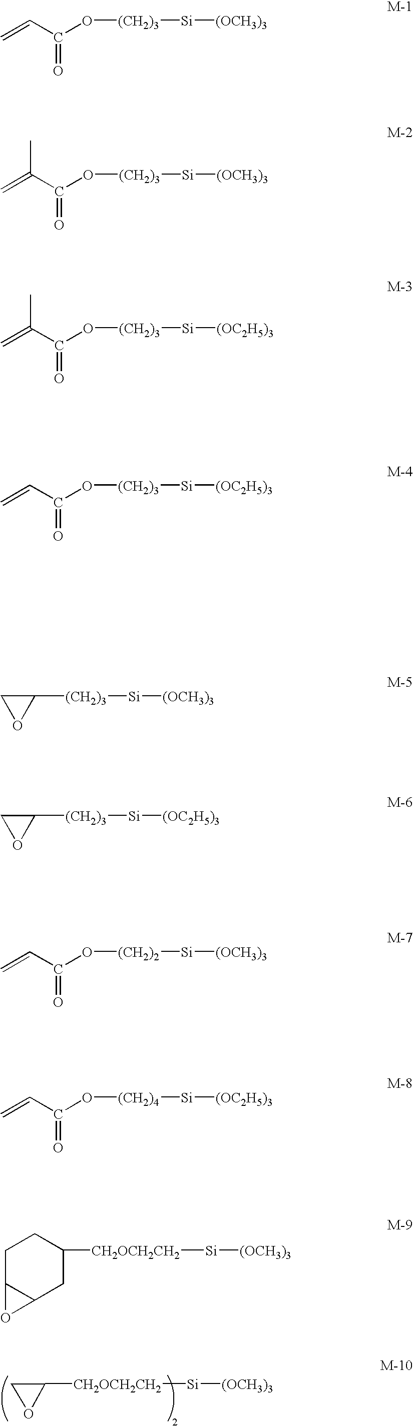

Among them, (M-1), (M-2), and (M-5) are particularly preferable.

The hydrolysate and/or partial condensate of the organosilane compound are typically produced by treating the organosilane compound in the presence of a catalyst. Examples of the catalyst include: inorganic acids, such as hydrochloric acid, sulfuric acid, nitric acid, and the like; organic acids, such as oxalic acid, acetic acid, formic acid, methane sulfonic acid, toluene sulfonic acid, and the like; inorganic bases, such as sodium hydroxide, potassium hydroxide, ammonia, and the like; organic bases, such as triethylamine, pyridine, and the like; metal alkoxides, such as triisopropoxy aluminum, tetrabutoxy zirconium, and the like; metal chelate compounds containing, as a central metal, a metal, such as Zr, Ti, Al, or the like; and the like. In the present invention, the use of metal chelate compounds and acid catalysts, such as inorganic acids and organic acids, are preferable. Preferable inorganic acids are hydrochloric acid and sulfuric acid, and preferable organic acids are those having an acid dissociation constant (pKa value (25° C.)) of 4.5 or less in water. Hydrochloric acid, sulfuric acid, and organic acids having an acid dissociation constant of 3.0 or less in water are more preferable. Hydrochloric acid, sulfuric acid, and organic acids having an acid dissociation constant of 2.5 or less in water are particularly preferable. Organic acids having an acid dissociation constant of 2.5 or less in water are even more preferable. Specifically, methane sulfonic acid, oxalic acid, phthalic acid, and malonic acid are even more preferable. Oxalic acid is particularly preferable.

The metal chelate compound is not particularly limited, and any metal chelate compound can be used as appropriate as long as the compound has, as a central metal, a metal selected from Zr, Ti, and Al, and also has, as ligands, an alcohol represented by the general formula R³OH (where R³ denotes an alkyl group having one to ten carbon atoms) and a compound represented by the general formula R⁴COCH₂COR⁵ (where R⁴ denotes an alkyl group having one to ten carbon atoms, and R⁵ denotes an alkyl group having one to ten carbon atoms or an alkoxy group having one to ten carbon atoms). If the above condition is satisfied, two or more types of metal chelate compounds may be used in combination. The metal chelate compound for use in the present invention is preferably selected from the group consisting of compounds represented by the general formulas Zr(OR³)ₚ₁(R⁴COCHCOR⁵)ₚ₂, Ti(OR³)_{q1}(R⁴COCHCOR⁵)_{q2}, and Al(OR³)ᵣ₁(R⁴COCHCOR⁵)r₂, and has a function of accelerating a condensation reaction of the hydrolysate and/or partial condensate of the organosilane compound.

In the metal chelate compound, R³ and R⁴ may be the same or different from each other, and each denote an alkyl group having one to ten carbon atoms, such as, specifically, an ethyl group, an n-propyl group, an i-propyl group, an n-butyl group, a sec-butyl group, a t-butyl group, an n-pentyl group, a phenyl group, or the like. R⁵ denotes an alkyl group having one to ten carbon atoms as defined above, or an alkoxy group having one to ten carbon atoms, such as a methoxy group, an ethoxy group, an n-propoxy group, an i-propoxy group, an n-butoxy group, a sec-butoxy group, a t-butoxy group, or the like. Also, in the metal chelate compound, p1, p2, q1, q2, r1, and r2 denote integers which satisfy p1+p2=4, q1+q2=4, and r1+r2=3.

Specific examples of these metal chelate compounds include: zirconium chelate compounds, such as tri-n-butoxyethyl acetoacetate zirconium, di-n-butoxybis(ethylacetoacetate)zirconium, n-butoxytris(ethylacetoacetate)zirconium, tetrakis(n-propylacetoacetate)zirconium, tetrakis(acetylacetoacetate)zirconium, tetrakis(ethylacetoacetate)zirconium, and the like; titanium chelate compounds, such as diisopropoxy bis(ethylacetoacetate)titanium, diisopropoxy bis(acetylacetate)titanium, diisopropoxy bis(acetylacetone)titanium, and the like; aluminum chelate compounds, such as diisopropoxy ethylacetoacetate aluminum, diisopropoxy acetylacetonato aluminum, isopropoxybis(ethylacetoacetate)aluminum, isopropoxybis(acetylacetonato)aluminum, tris(ethylacetoacetate)aluminum, tris(acetylacetonato)aluminum, monoacetylacetonato bis(ethylacetoacetate)aluminum, and the like; and the like.

Among these metal chelate compounds, tri-n-butoxyethyl acetoacetate zirconium, diisopropoxybis(acetylacetonato)titanium, diisopropoxy ethylacetoacetate aluminum, and tris(ethylacetoacetate)aluminum are preferable. These metal chelate compounds can be used singly or in combination of two or more. Also, partial hydrolysates of these metal chelate compounds can be used.

Also, in the present invention, the curable composition preferably further contains a P-diketone compound and/or a β-ketoester compound. A further description will be given below.

The present invention uses a β-diketone and/or β-ketoester compound represented by the general formula R⁴COCH₂COR⁵, which acts as an agent for enhancing the stability of the curable composition used in the present invention. Here, R⁴ denotes an alkyl group having one to ten carbon atoms, and R⁵ denotes an alkyl group having one to ten carbon atoms or an alkoxy group having one to ten carbon atoms. That is, it. is considered that the β-diketone or β-ketoester compound binds to a metal atom in the metal chelate compound (zirconium, titanium, and/or aluminum compounds) to suppress the function of the metal chelate compound that accelerates a condensation reaction of a hydrolysate of the organosilane compound and/or a partial condensate thereof, thereby enhancing the stability in preservation of a resultant composition. R⁴ and R⁵ constituting the β-diketone compound and the β-ketoester compound are similar to R⁴ and R⁵ constituting the metal chelate compound.

Specific examples of the β-diketone compound and/or β-ketoester compound include acetylacetone, methyl acetoacetate, ethyl acetoacetate, n-propyl acetoacetate, i-propyl acetoacetate, n-butyl acetoacetate, sec-butyl acetoacetate, tert-butyl acetoacetate, 2,4-hexane-dione, 2,4-heptane-dione, 3,5-heptane-dione, 2,4-octane-dione, 2,4-nonane-dione and 5-methyl-hexane-dione. Among these, ethyl acetoacetate and acetylacetone are preferred, and acetylacetone is more preferred. One of these β-diketone compounds and/or β-ketoester compounds may be used alone or two or more thereof may be used as a mixture. In the present invention, the β-diketone compound and/or β-ketoester compound is preferably used in an amount of 2 mol or more, more preferably from 3 to 20 mol, per mol of the metal chelate compound. If the amount added is less than 2 mol, the composition obtained may have poor storage stability and this is not preferred.

The blended amount of the organosilane compound is preferably in an amount of 0.1 to 50% by mass, more preferably 0.5 to 20% by mass, and most preferably 1 to 10% by mass, with respect to the total solid content of the low refractive index layer.

The organosilane compound may be directly added to curable compositions (coating liquids for anti-glare layer, low refractive index layer, and the like), but it is preferable that the organosilane compound be previously treated in the presence of a catalyst to prepare at least either a hydrolysate of the organosilane compound or a partial condensate thereof, and the resultant reaction solution (sol liquid) is used to prepare the curable composition. In the present invention, preferably, a composition containing either a hydrolysate of the organosilane compound or a partial condensate thereof and a metal chelate compound is first prepared, at least either the β-diketone compound and/or the β-ketoester compound is added thereto to obtain a liquid, and the liquid is causes to be contained in a coating liquid for at least one layer, i.e., the anti-glare layer or the low refractive index layer, and is applied.

The amount of a sol component of organosilane that is used with respect to the fluorinated polymer in the low refractive index layer is preferably 5 to 100% by mass, more preferably 5 to 40% by mass, even more preferably 8 to 35% by mass, and particularly preferably 10 to 30% by mass. When the use amount is within the above range, the effect of the present invention is readily achieved, the refractive index is appropriate, and in addition, the shape and surface state of the film are satisfactory.

An inorganic filler other than the above-mentioned inorganic microparticles can be added to the curable composition in an amount so as not to adversely affect the desired effect of the present invention. The details of the inorganic filler will be described below. (Other substances contained in curable composition for low refractive index layer) The curable composition is produced by adding, as necessary, various additives and a radical polymerization initiator or a cationic polymerization initiator described later to the above-described components: (A) a fluorinated polymer; (B) an inorganic microparticle; and (C) an organosilane compound, and further by dissolving them in an appropriate solvent. In this case, the solid content concentration is selected as appropriate, depending on the purpose of use, and is generally about 0.01 to 60% by mass, preferably 0.5 to 50% by mass, and particularly preferably about 1% to 20% by mass.

From the viewpoint of, for example, the interface adhesion ability between the low refractive index layer and an underlying layer in direct contact therewith, a small amount of curing agent, such as a polyfunctional (meth)acrylate compound, a polyfunctional epoxy compound, a polyisocyanate compound, aminoplast, polybasic acid or anhydride thereof, or the like, may be added. When they are added, the amount thereof is preferably 30% by mass or less, more preferably 20% by mass or less, and particularly preferably 10% by mass or less, with respect to the total solid content of the coating of the low refractive index layer.

Also, in order to provide a property, such as a stain-proof property, a waterproof property, a chemical resistant property, a slippery property, or the like, a stain-proofing agent, a lubricant, or the like, such as a known silicone-based compound or fluorine-based compound or the like, may be added as appropriate. When these additives are added, the added amount thereof is preferably 0.01 to 20% by mass, more preferably 0.05 to 10% by mass, and particularly preferably 0.1 to 5% by mass, with respect to the total solid content of the low refractive index layer.

Preferable examples of the silicone-based compound include those containing a plurality of dimethyl silyloxy units as repeating units and having a substituent group at a chain terminal and/or at a side chain. The compound containing dimethyl silyloxy as a repeating unit may contain a structural unit other than dimethyl silyloxy in its chain. The same or different substituent groups may be contained. A plurality of substituent groups are preferably contained. Preferable examples of the substituent group include an acryloyl group, a methacryloyl group, a vinyl group, an aryl group, a cinnamoyl group, an epoxy group, an oxetanyl group, a hydroxy group, a carbinol group, a fluoroalkyl group, a polyoxyalkylene group, a carboxyl group, an amino group, and the like. The molecular weight is not particularly limited, but is preferably 100,000 or less, particularly preferably 50,000 or less, and most preferably 3,000 to 30,000. The amount of silicon atoms contained in the silicone-based compound is not particularly limited, but is preferably 18.0% by mass or more, particularly preferably 25.0 to 37.8% by mass, and most preferably 30.0 to 37.0% by mass. Preferable examples of the silicone-based compound include, but are not limited to, X-22-174DX, X-22-2426, X-22-160AS, X-22-164B, X22-164C, X-22-170DX, X-22-176-D, and X-22-1821 (trade names; manufactured by Shin-etsu Chemical Co., Ltd.), FM-0725, FM-7725, FM-4421, FM-5521, FM6621, and FM-1121 (trade names; manufactured by CHISSO CORPORATION)), and DMS-U22, RMS-033, RMS-083, UMS-182, DMS-H21, DMS-H31, HMS-301, FMS121, FMS123, FMS131, FMS141, and FMS221(trade names; manufactured by Gelest), and the like.

The fluorine-based compound is preferably a compound having a fluoroalkyl group. The fluoroalkyl group preferably has one to twenty carbon atoms, more preferably one to ten carbon atoms, and may have a straight-chain structure (e.g., —CF₂CF₃, —CH₂(CF₂)₄H, —CH₂(CF₂)₈CF₃, —CH₂CH₂(CF₂)₄H, etc.), a branched structure (e.g., —CH(CF₃)₂, —CH₂CF(CF₃)₂, —CH(CH₃)CF₂CF₃, —CH(CH₃)(CF₂)₅CF₂H, etc.), or an alicyclic structure (preferably a 5- or 6-membered ring; e.g., a perfluorocyclohexyl group, a perfluorocyclopentyl group, or an alkyl group substituted therewith), or may have an ether linkage (e.g., —CH₂OCH₂CF₂CF₃, —CH₂CH₂OCH₂C₄F₈H, —CH₂CH₂OCH₂CH₂C₈F₁₇, —CH₂CH₂OCF₂CF₂OCF₂CH₂H, etc.). A plurality of fluoroalkyl groups may be contained in the same molecule.

Further, the fluorine-based compound preferably contains a substituent group which contributes to bonding or compatibility with respect to the coating of the low refractive index layer. The substituent groups may be same or different from each other. A plurality of substituent groups are preferably contained. Preferable examples of the substituent group include an acryloyl group, a methacryloyl group, a vinyl group, an aryl group, a cinnamoyl group, an epoxy group, oxetanyl group, a hydroxy group, a polyoxyalkylene group, a carboxyl group, an amino group, and the like. The fluorine-based compound may be a polymer or oligomer with a compound containing no fluorine atom, and the molecular weight thereof is not particularly limited. The amount of fluorine atoms contained in the fluorine-based compound is not particularly limited, but is preferably 20% by mass or more, particularly preferably 30 to 70% by mass, and most preferably 40 to 70% by mass. Preferable examples of the fluorine-based compound include, but are not limited to, R-2020, M-2020, R-3833, and M-3833 (trade names; manufactured by Daikin Industries, Ltd.) and MEGAFACE F-171, F-172, F-179A, DEFENSA MCF-300 (trade names; manufactured by Dainippon Ink & Chemicals, Inc.), and the like.

In order to provide a property, such as a dust-proofing property, an antistatic property, or the like, a dust-proofing agent, an antistatic agent, or the like, such as a known cation surfactant or polyoxyalkylene-based compound or the like, may be added as appropriate. The dust-proofing agent and the antistatic agent may have their structural units contained in the above-described silicone-based compound or fluorine-based compound as part of their functions. When they are added as additives, the added amount is preferably 0.01 to 20% by mass, more preferably 0.05 to 10% by mass, and particularly preferably 0.1 to 5% by mass, with respect to the total solid content of the low refractive index layer. Preferable examples of the compound include, but are not limited to, MEGAFACE F-150 (trade name; manufactured by Dainippon Ink & Chemicals, Inc.), SH-3748 (trade name; manufactured by Dow Corning Toray Co., Ltd.), and the like.

[Solvent for Low Refractive Index Layer]

As for the solvent used in the coating composition for forming the low refractive index layer of the present invention, various solvents selected, for example, from the standpoint that the solvent can dissolve or disperse each component, readily provides a uniform surface state in the coating step and the drying step, can ensure liquid storability or has an appropriate saturated vapor pressure, may be used. In view of drying load, a solvent having a boiling point of 100° C. or less at room temperature under atmospheric pressure is preferably used as the main component, while a small amount of a solvent having a boiling point of 100° C. or more is contained for adjusting the drying speed.

Examples of the solvent having a boiling point of 100° C. or less include hydrocarbons such as hexane (boiling point: 68.7° C.), heptane (98.4° C.), cyclohexane (80.7° C.) and benzene (80. 1° C.); halogenated hydrocarbons such as dichloromethane (39.8° C.), chloroform (61.2° C.), carbon tetrachloride (76.8° C.), 1,2-dichloroethane (83.5° C.) and trichloroethylene (87.2° C.); ethers such as diethyl ether (34.6° C.), diisopropyl ether (68.5° C.), dipropyl ether (90.5° C.) and tetrahydrofliran (66° C.); esters such as ethyl formate (54.2° C.), methyl acetate (57.8° C.), ethyl acetate (77. 1° C.) and isopropyl acetate (89° C.); ketones such as acetone (56. 1° C.) and 2-butanone (same as methyl ethyl ketone, 79.6° C.); alcohols such as methanol (64.5° C.), ethanol (78.3° C.), 2-propanol (82.4° C.) and 1-propanol (97.2° C.); cyano compounds such as acetonitrile (81.6° C.) and propionitrile (97.4° C.); and carbon disulfide (46.2° C.). Among these, ketones and esters are preferred, and ketones are more preferred. Out of ketones, 2-butanone is preferred.

Examples of the solvent having a boiling point of 100° C. or more include octane (125.7° C.), toluene (110.6° C.), xylene (138° C.), tetrachloroethylene (121.2° C.), chlorobenzene (131.7° C.), dioxane (101.3° C.), dibutyl ether (142.4° C.), isobutyl acetate (118° C.), cyclohexanone (155.7° C.), 2-methyl-4-pentanone (same as MIBK, 115.9° C.), 1-butanol (117.7° C.), N,N-dimethylformamide (153° C.), N,N-dimethylacetamide (166° C.) and dimethyl sulfoxide (189° C.). Among these, cyclohexanone and 2-methyl-4-pentanone are preferred.

The low refractive index layer by a sol-gel method (embodiment 2) is described.

With respect to the material for the low refractive index layer, various sol-gel materials can be used. As for such a sol-gel material, a metal alcoholate (an alcoholate of silane, titanium, aluminum, zirconium or the like), an organoalkoxy metal compound, and a hydrolysate thereof may be used. In particular, an alkoxysilane, an arganoalkoxysilane and a hydrolysate thereof are preferred. Examples thereof include a tetraalkoxysilane (e.g., tetramethoxysilane, tetraethoxysilane), an alkyltrialkoxysilane (e.g., methyltrimethoxysilane, ethyltrimethoxysilane), an aryltrialkoxysilane (e.g., phenyltrimethoxysilane), a dialkyldialkoxysilane and a diaryldialkoxysilane. In addition, an alkoxysilane having various functional groups (e.g., vinyltrialkoxysilane, methylvinylalkoxysilane, γ-glycidyloxypropyltrialkoxysilane, γ-glycidyloxypropylmethyldialkoxysilane, β-(3,4-epoxydicyclohexyl)ethyltrialkoxysilane, γ-methacryloyloxypropyltrialkoxysilane, γ-aminopropyltrialkoxysilane, γ-mercaptopropyltrialkoxysilane, γ-chloropropyltrialkoxysilane), and a perfluoroalkyl group-containing compound (e.g., (heptadecafluoro-1,1,2,2-tetradecyl)triethoxysilane, 3,3,3-trifluoropropyltrimethoxysilane) are also preferably used. In particular, a fluorine-containing silane compound is preferred from the standpoint of reducing the refractive index of the layer and imparting water-repellent-oil-repellent property. (3) Binder

The binder polymer is preferably a polymer having a saturated hydrocarbon or a polyether as the main chain, more preferably a polymer having a saturated hydrocarbon as the main chain. The binder polymer is preferably crosslinked. The polymer having a saturated hydrocarbon as the main chain is preferably obtained by a polymerization reaction of an ethylenically unsaturated monomer. In order to obtain a crosslinked binder polymer, a monomer having two or more ethylenically unsaturated groups is preferably used. Examples of the monomer having two or more ethylenically unsaturated groups include an ester of polyhydric alcohol and (meth)acrylic acid (e.g., ethylene glycol di(meth)acrylate, 1,4-dichlorohexane diacrylate, pentaerythritol tetra(meth)acrylate), pentaerythritol tri(meth)acrylate, trimethylolpropane tri(meth)acrylate, trimethylolethane tri(meth)acrylate, dipentaerythritol tetra(meth)acrylate, dipentaerythritol penta(meth)acrylate, pentaerythritol hexa(meth)acrylate, 1,2,3-cyclohexane tetramethacrylate, polyurethane polyacrylate, polyester polyacrylate), a vinylbenzene and its derivative (e.g., 1,4-divinylbenzene, 2-acryloylethyl 4-vinylbenzoate, 1,4-divinylcyclohexanone), a vinylsulfone (e.g., divinyl-sulfone), an acrylamide (e.g., methylenebisacrylamide) and a methacrylamide. The polymer having a polyether as the main chain is preferably synthesized by a ring-opening polymerization reaction of a polyfunctional epoxy compound.

The crosslinked structure may be introduced into the binder polymer by using a crosslinking functional group-containing monomer in place of or in addition to the monomer having two or more ethylenically unsaturated groups, and reacting the crosslinking group.

Examples of the crosslinking functional group include an isocyanate group, an epoxy group, an aziridine group, an oxazoline group, an aldehyde group, a carbonyl group, a hydrazine group, a carboxyl group, a methylol group and an active methylene group. In addition, a vinylsulfonic acid, an acid anhydride, a cyanoacrylate derivative, a melamine, an etherified methylol, an ester and a urethane may also be utilized as the monomer for introducing the crosslinked structure. A functional group which exhibits a crosslinking property as a result of decomposition reaction, such as block isocyanate group, may also be used. In the present invention, the crosslinking group is not limited to the above-described compounds and may be a functional group which exhibits reactivity as a result of decomposition. The polymerization initiator for use in the polymerization reaction and crosslinking reaction of the binder polymer may be a thermal polymerization initiator or a photopolymerization initiator, but a photopolymerization initiator is preferred. Examples of the photopolymerization initiator include acetophenones, benzoins, benzophenones, phosphine oxides, ketals, anthraquinones, thioxanthones, azo compounds, peroxides, 2,3-dialkyldione compounds, disulfide compounds, fluoroamine compounds and aromatic sulfoniums. Examples of the acetophenones include 2,2-diethoxyacetophenone, p-dimethylacetophenone, 1-hydroxydimethyl phenyl ketone, 1-hydroxycyclohexyl phenyl ketone, 2-methyl-4-methylthio-2-morpholinopropiophenone and 2-benzyl-2-dimethylamino-1-(4-morpholinophenyl)-butanone. Examples of the benzoins include benzoin methyl ether, benzoin ethyl ether and benzoin isopropyl ether. Examples of the benzophenones include benzophenone, 2,4-dichlorobenzophenone, 4,4-dichlorobenzophenone and p-chlorobenzophenone. Examples of the phosphine oxides include 2,4,6-trimethylbenzoyldiphenylphosphine oxide.

The binder polymer is preferably formed by adding the monomer to the coating solution for the low refractive index layer, and causing a polymerization reaction (if desired, further a crosslinking reaction) simultaneously with the coating of the low refractive index layer or after the coating. In the coating solution for the low refractive index, a small amount of a polymer (e.g., polyvinyl alcohol, polyoxyethylene, polymethyl methacrylate, polymethyl acrylate, diacetyl cellulose, triacetyl cellulose, nitrocellulose, polyester, alkyd resin) may be added.

<Transparent Support>

While there is no particular limitation as to the acyl group in the cellulose acylate for the support according to the present invention, the use of an acetyl, propionyl or butyryl group is preferred and an acetyl group is, among others, preferred. The acyl groups preferably have a substitution degree of from 2.7 to 3.0 and more preferably from 2.8 to 2.95. In the case of cellulose acetate in which all of the acyl groups are acetyl groups, its acetyl substitution degree is preferably from 2.7 to 2.95 and more preferably from 2.8 to 2.95. It is also preferable to use cellulose acetate having an acetyl substitution degree of from 2.50 to 2.86 as described in JP-A-2001-356214, or cellulose acetate having an acetyl substitution degree of from 2.75 to 2.86 as described in JP-A-2001-226495. In the case of too low an acetyl substitution degree, tension of transportation at the time of casting presents a problem in which a film is likely to have a retardation value exceeding a desired value and varying across its plane. The acyl group in the 6-position preferably has a substitution degree of 0.9 or more. A substitution degree of less than 0.9 is likely to give a varying retardation value across the plane of a film and across its thickness. The acyl substitution degree as herein referred to is the value calculated in accordance with ASTM D817.

The present invention preferably employs cellulose acetate having an acetylation degree of 59.0 to 61.9%.

The acetylation degree means the amount of combined acetic acid per unit mass of cellulose. It is obtained by the measurement and calculation of an acetylation degree as defined by ASTM D-817-91 (a testing method for cellulose acetate, etc.).

Cellulose acylate preferably has a particle size-average polymerization degree (DP) of 250 or more and more preferably 290 or more.

The cellulose acylate employed by the present invention preferably has a narrow molecular weight distribution, Mw/Mn (Mw: mass-average molecular weight; Mn: number-average molecular weight), as determined by gel-permeation chromatography. A specific value of Mw/Mn is preferably in the range from 1.0 to 1.7, more preferably from 1.3 to 1.65 and most preferably from 1.4 to 1.6.

It is possible to use for the present invention cellulose acetate produced by the method of synthesis according to [Synthesis Example 1] described in Paragraphs [0043] and [0044] of the specification in JP-A-Hei-11-5851, [Synthesis Example 2] described in Paragraphs [0048] and [0049] thereof or [Synthesis Example 3] described in Paragraphs [0051] and [0052].

Description will now be described of the hydrophobizing agent according to the present invention.

A hydrophobic compound having at least one hydrogen-bonding and hydrogen-donating group is preferred as a hydrophobizing agent in view of a trade-off between a reduction in plasticity and water content and the prevention of bleed- out.

An amino, acylamino, alkoxycarbonylamino, aryloxycarbonylamino, sulfonylamino, hydroxyl, mercapto or carboxyl group is preferred as a hydrogen-bonding and hydrogen-donating group according to the present invention, and a functional group, such as a hydroxyl, acylamino or sulfonylamino group, is, among others, preferred.

The hydrophobizing agent according to the present invention preferably has a molecular weight of from 250 to 2,000. Its boiling point is preferably 260° C. or above. Its boiling point can be measured by using a commercially available measuring instrument (for example, TG/DTA100 of Seiko Instruments, Inc.).

A compound represented by general formula (I) or (II) below is particularly suitable for use as the hydrophobizing agent by the present invention for realizing a lower water content without bringing about any reduction in elastic modulus.

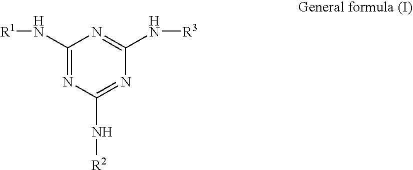

In the formula, R¹, R² and R³ each stand for an alkyl, alkenyl, aromatic ring or heterocyclic group independently of one another.

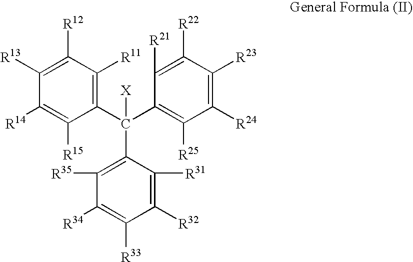

In the formula, X stands for a substituted or unsubstituted amine, acylamino, alkoxycarbonylamino, aryloxycarbonylamino, sulfonylamino, hydroxyl, mercapto or carboxyl group.

R^{11 , R}¹², R¹³, R¹⁴, R¹⁵ R²¹, R²², R²³, R²⁴, R²⁵, R³¹, R³², R³³, R³⁴ and R³⁵ each stand for a hydrogen atom or a substituent group.

The compounds represented by general formula (I) will now be described in detail.

While R¹, R² and R³ each stand for an alkyl, alkenyl, aromatic ring or heterocyclic group independently of one another, an aromatic or heterocyclic ring is preferred. The aromatic ring for which each of R¹, R² and R³ stands is preferably phenyl or naphthyl and more preferably phenyl. R¹, R² and R³ may each have a substituent group in the aromatic or heterocyclic ring. Examples of the substituent groups are a halogen atom, a hydroxyl group, a cyano group, a nitro group, a carboxyl group, an alkyl group, an alkenyl group, an aryl group, an alkoxy group, an alkenyloxy group, an aryloxy group, an acyloxy group, an alkoxycarbonyl group, an alkenyloxycarbonyl group, an aryloxycarbonyl group, a sulfamoyl group, an alkyl-substituted sulfamoyl group, an alkenyl-substituted sulfamoyl group, an aryl-substituted sulfamoyl group, a sulfoneamide group, a carbamoyl group, an alkyl-substituted carbamoyl group, an alkenyl-substituted carbamoyl group, an aryl-substituted carbamoyl group, an amide group, an alkylthio group, an alkenylthio group, an arylthio group and an acyl group.

When R¹, R² and R³ each stand for a heterocyclic group, the heterocyclic rings preferably have an aromatic nature. The heterocyclic ring having an aromatic nature is generally an unsaturated heterocyclic ring and is preferably a heterocyclic ring having the maximum double bonds. The heterocyclic ring is preferably a five-, six- or seven-membered ring, more preferably a five- or six-membered ring and most preferably a six-membered ring. The hetero atoms of the heterocyclic ring are preferably nitrogen, sulfur or oxygen, and more preferably nitrogen. A pyridine ring (2-pyridyl or 4-pyridyl as a heterocyclic group) is, among others, preferred as a heterocyclic ring having an aromatic nature. The heterocyclic group may or may not have a substituent. Examples of the substituents of the heterocyclic group are equal to those of the substituents as listed above. The substituents may or may not be replaced by the substituents as listed above.

The following are preferred examples of the compounds represented by general formula (I) according to the present invention, though the present invention is not limited by these specific examples.

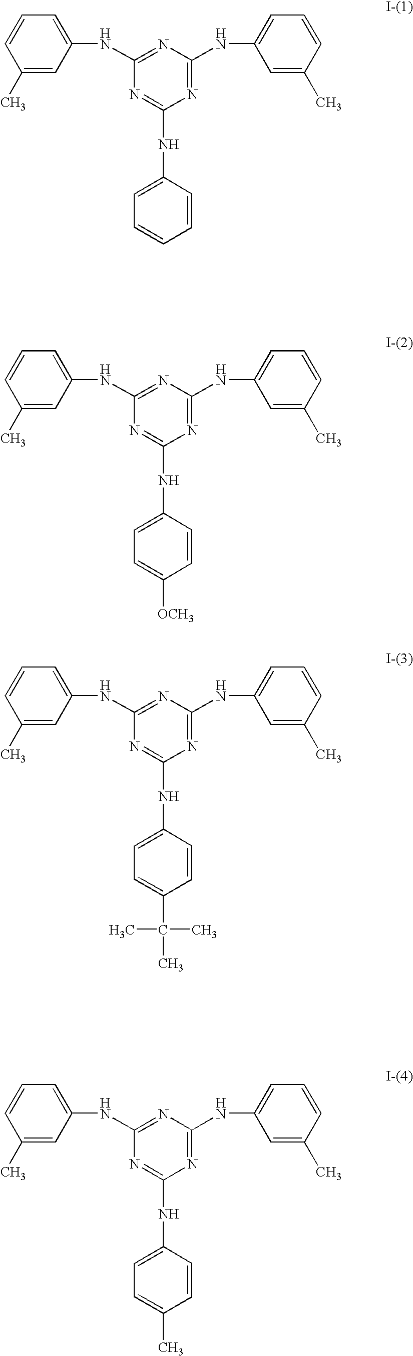

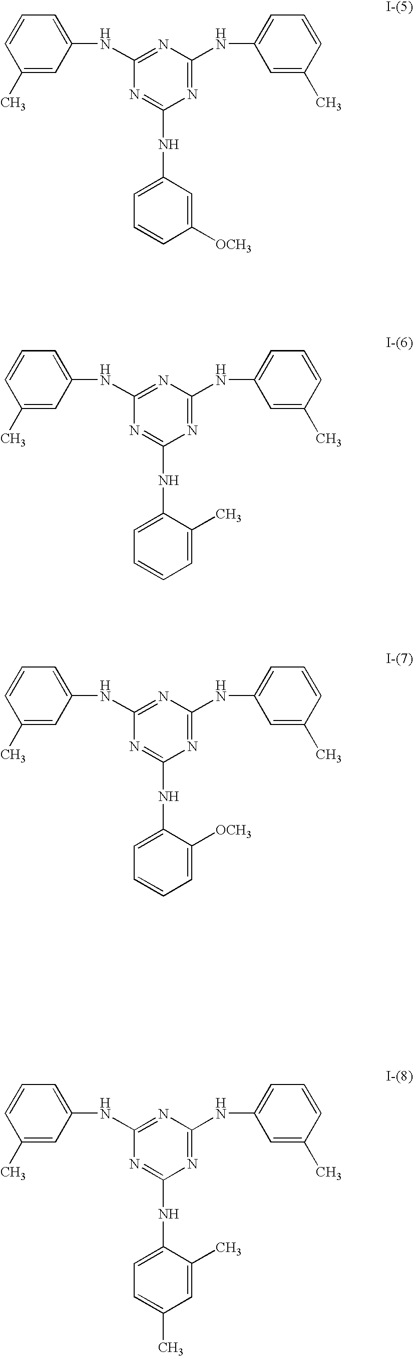

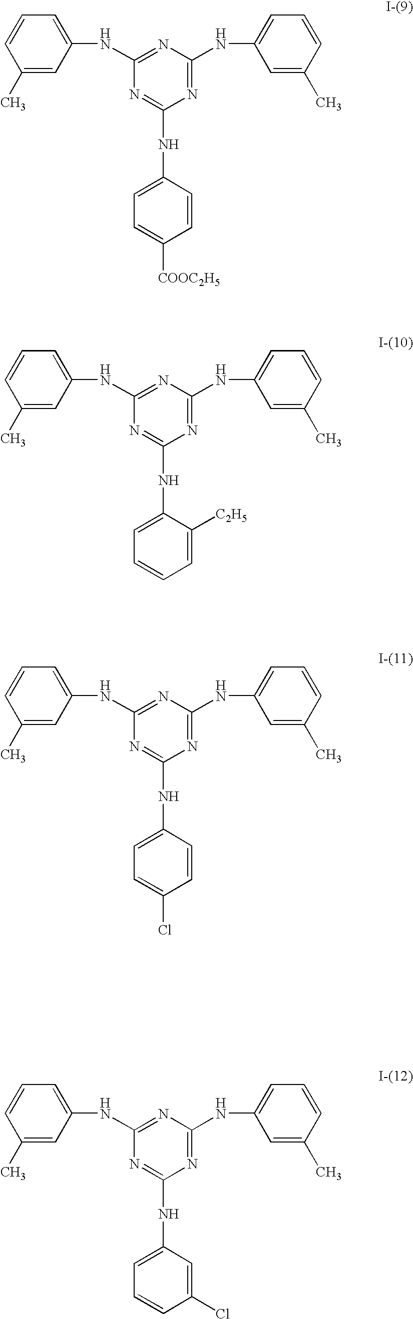

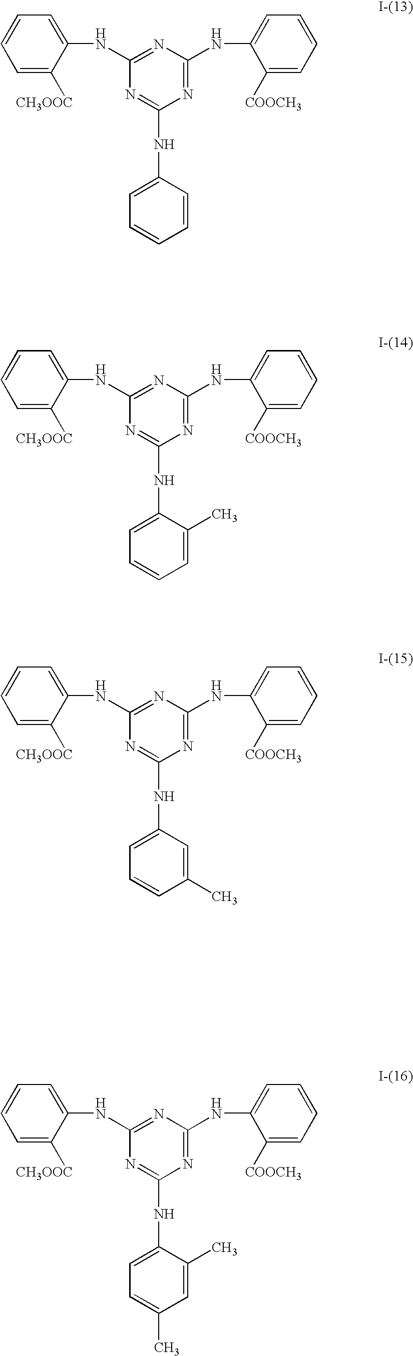

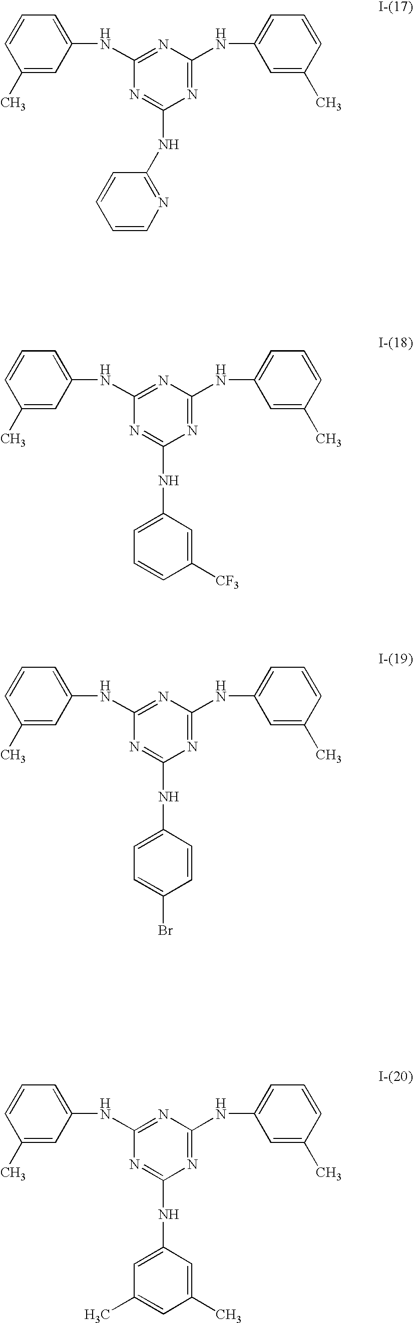

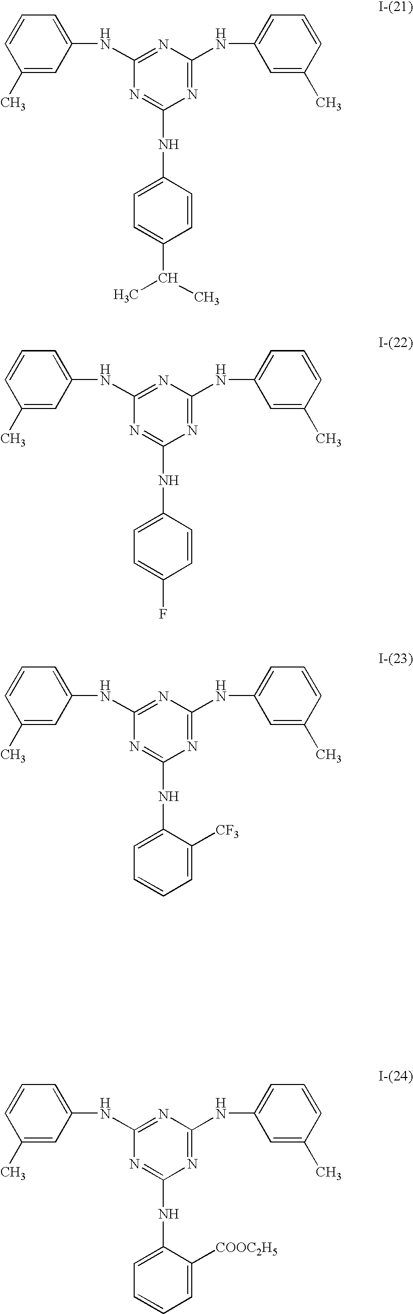

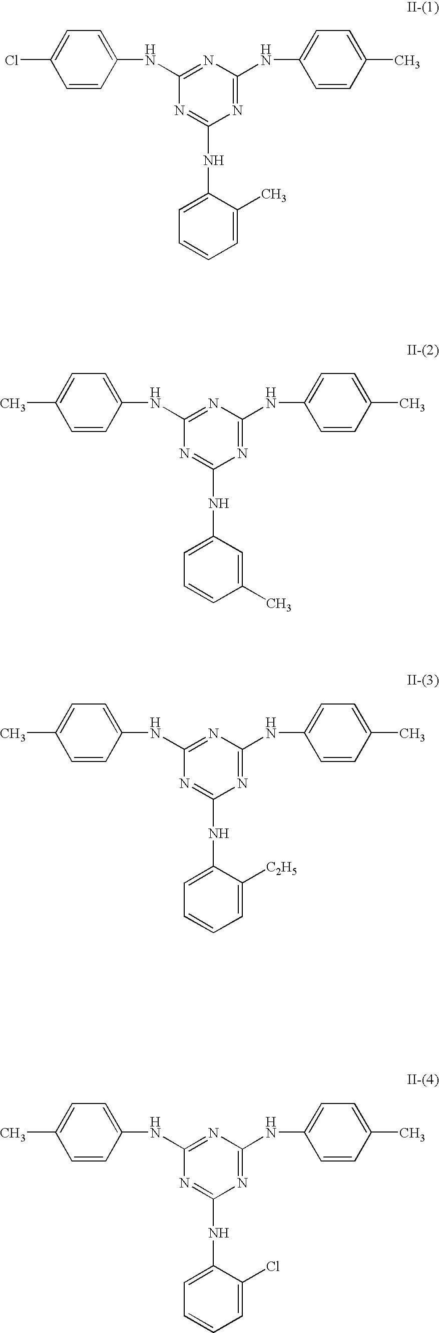

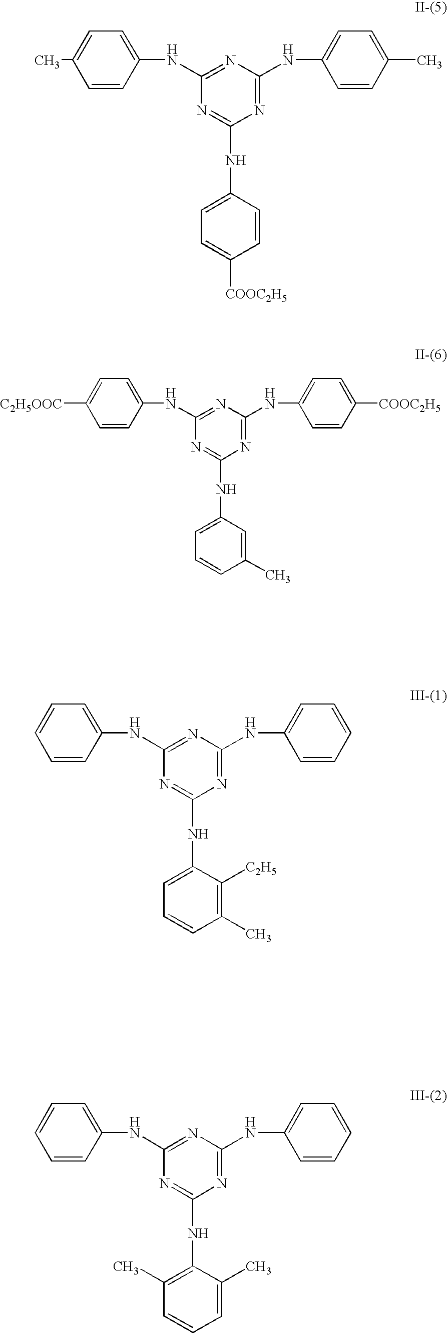

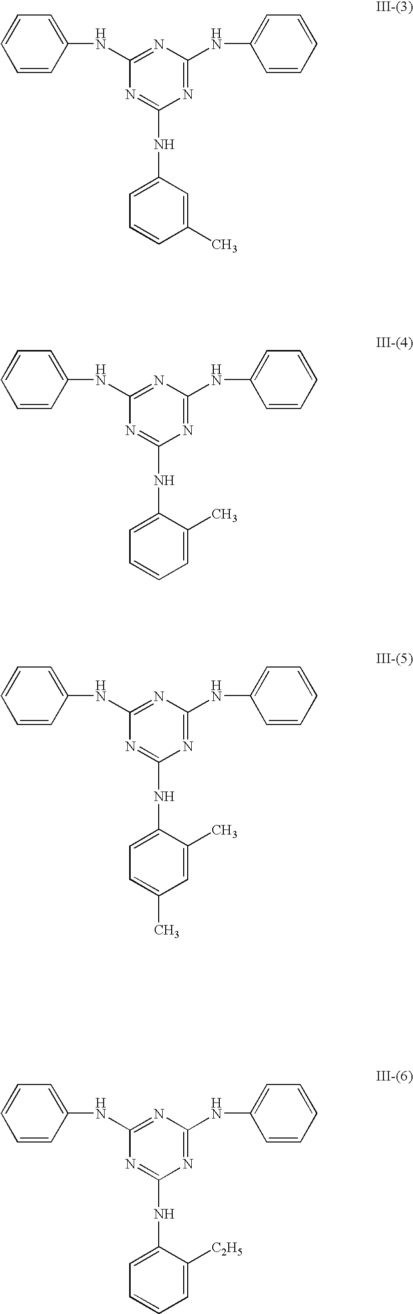

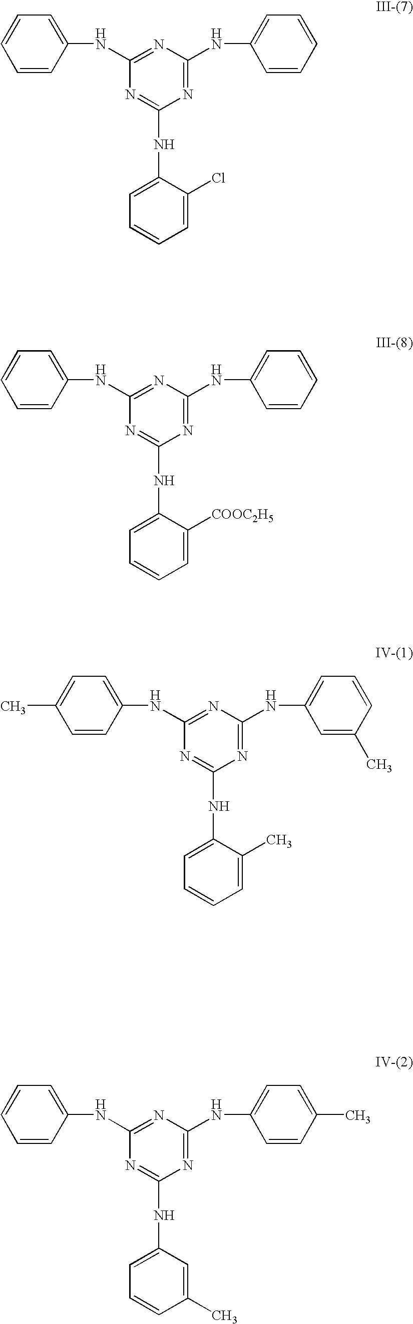

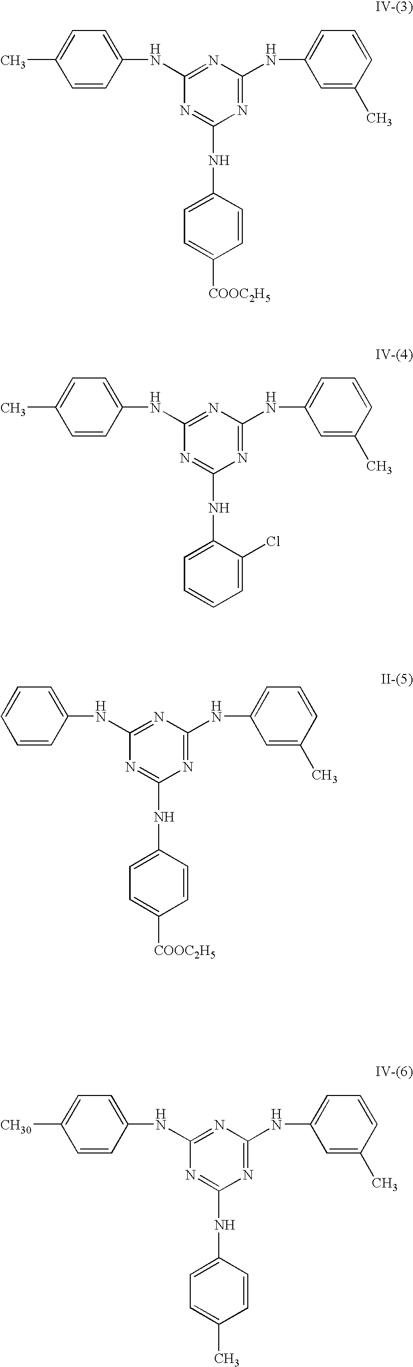

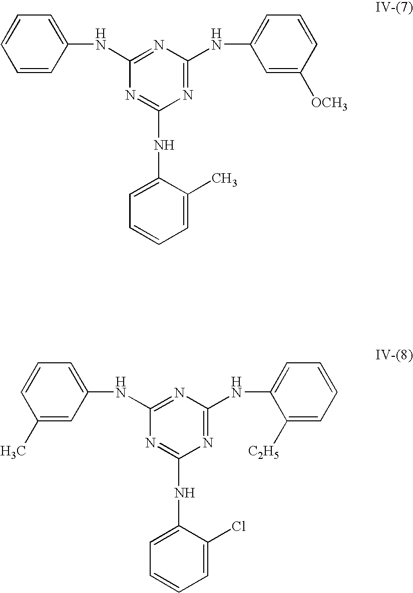

The compounds represented by general formula (II) will now be described in detail.

X stands for a substituted or unsubstituted amine, acylamino, alkoxycarbonylamino, aryloxycarbonylamino, sulfonylamino, hydroxyl, mercapto or carboxyl group, more preferably an amino or hydroxyl group and most preferably a hydroxyl group.

R¹¹, R¹², R¹³, R¹⁴, R¹⁵, R²¹, R²², R²³, R²⁴, R²⁵, R³¹, R³², R³³, R³⁴ and R³⁵ and each stand for a hydrogen atom or a substituent group, and any of the following substituents T can be employed as the substituent.

Examples of the substituents T are an alkyl group (preferably having 1 to 20 carbon atoms, such as methyl, ethyl, isopropyl, tert-butyl, n-octyl, n-decyl, n-hexadecyl, cyclopropyl, cyclopentyl or cyclohexyl), an alkenyl group (preferably having 2 to 20 carbon atoms, such as vinyl, allyl, 2-butenyl or 3-pentenyl), an alkynyl group (preferably having 2 to 20 carbon atoms, such as propargyl or 3-pentynyl), an aryl group (preferably having 6 to 30 carbon atoms, such as phenyl, p-methylphenyl or naphtyhl), a substituted or unsubstituted amino group (preferably having 0 to 20 carbon atoms, such as amino, methylamino, dimethylamino, diethylamino or dibenzylamino), an alkoxy group (preferably having 1 to 20 carbon atoms, such as methoxy, ethoxy or butoxy), an aryloxy group (preferably having 6 to 20 carbon atoms, such as phenyloxy or 2-naphthyloxy), an acyl group (preferably having 1 to 20 carbon atoms, such as acetyl, benzoyl, formyl or pivaloyl), an alkoxycarbonyl group (preferably having 2 to 20 carbon atoms, such as methoxycarbonyl or ethoxycarbonyl), an aryloxycarbonyl group (preferably having 7 to 20 carbon atoms, such as phenyloxycarbonyl), an acyloxy group (preferably having 2 to 20 carbon atoms, such as acetoxy or benzoyloxy), an acylamino group (preferably having 2 to 20 carbon atoms, such as acetylamino or benzoylamino), an alkoxycarbonylamino group (preferably having 2 to 20 carbon atoms, such as methoxycarbonylamino), an aryloxycarbonylamino group (preferably having 7 to 20 carbon atoms, such as phenyloxycarbonylamino), a sulfonylamino group (preferably having 1 to 20 carbon atoms, such as methanesulfonylamino or benzenesulfonylamino), a sulfamoyl group (preferably having 0 to 20 carbon atoms, such as sulfamoyl, methylsulfamoyl, dimethylsulfamoyl or phenylsulfamoyl), a carbamoyl group (preferably having 1 to 20 carbon atoms, such as carbamoyl, methylcarbamoyl, diethylcarbamoyl or phenylcarbamoyl), an alkylthio group (preferably having 1 to 20 carbon atoms, such as methylthio or ethylthio), an arylthio group (preferably having 6 to 20 carbon atoms, such as phenylthio), a sulfonyl group (preferably having 1 to 20 carbon atoms, such as mesyl or tosyl), a sulfinyl group (preferably having 1 to 20 carbon atoms, such as methanesulfinyl or benzenesulfinyl), an ureido group (preferably having 1 to 20 carbon atoms, such as ureido, methylureido or phenylureido), a phosphoric amide group (preferably having 1 to 20 carbon atoms, such as diethylphosphoric or phenylphosphoric amide), a hydroxyl group, a mercapto group, a halogen atom (such as a fluorine, chlorine, bromine or iodine atom), a cyano group, a sulfo group, a carboxyl group, a nitro group, a hydroxamic acid group, a sulfino group, a hydrazine group, an imino group, a heterocyclic group (preferably having 1 to 30 carbon atoms, and including, for example, a nitrogen, oxygen or sulfur atom as a heterocyclic atom, such as imidazolyl, pyridyl, quinolyl, furyl, piperidyl, morpholino, benzoxazolyl, benzimidazolyl or benzothiazolyl) and a silyl group (preferably having 3 to 40 carbon atoms, such as trimethylsilyl or triphenylsilyl). An alkyl, aryl, substituted or unsubstituted amino, alkoxy or aryloxy group is, among others, preferable and an alkyl, aryl or alkoxy group is more preferable.

These substituent groups may or may not be replaced by substituent groups T. If there are two or more substituent groups, they may be the same or different. They may be linked together to form a ring, if possible.

The compounds represented by general formula (II) will now be described in detail based on specific examples, though the present invention is not limited at all by the following examples.

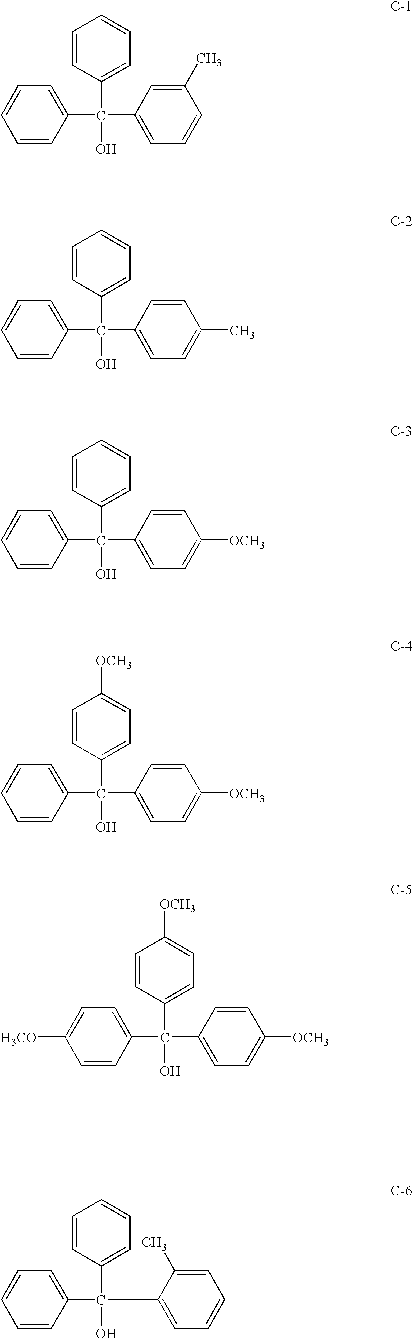

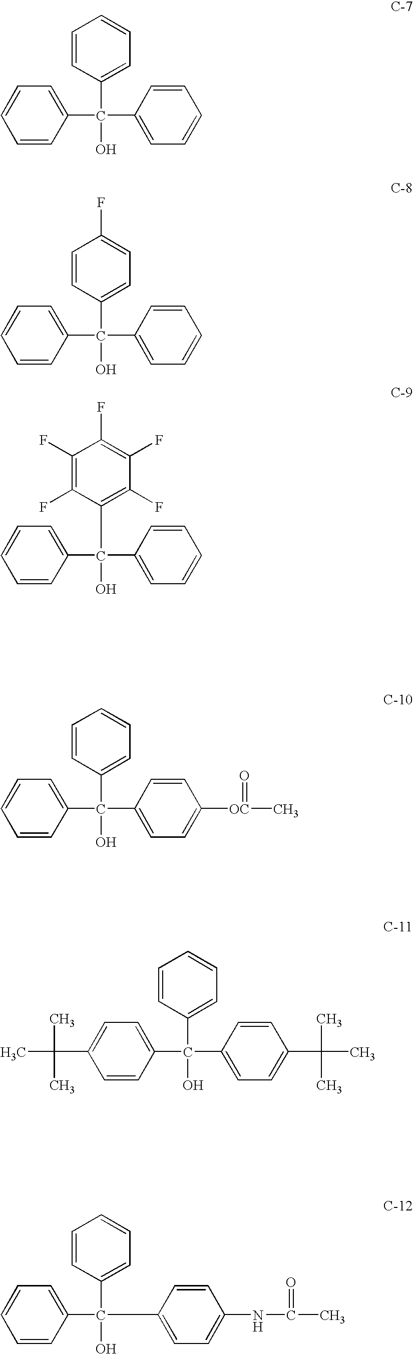

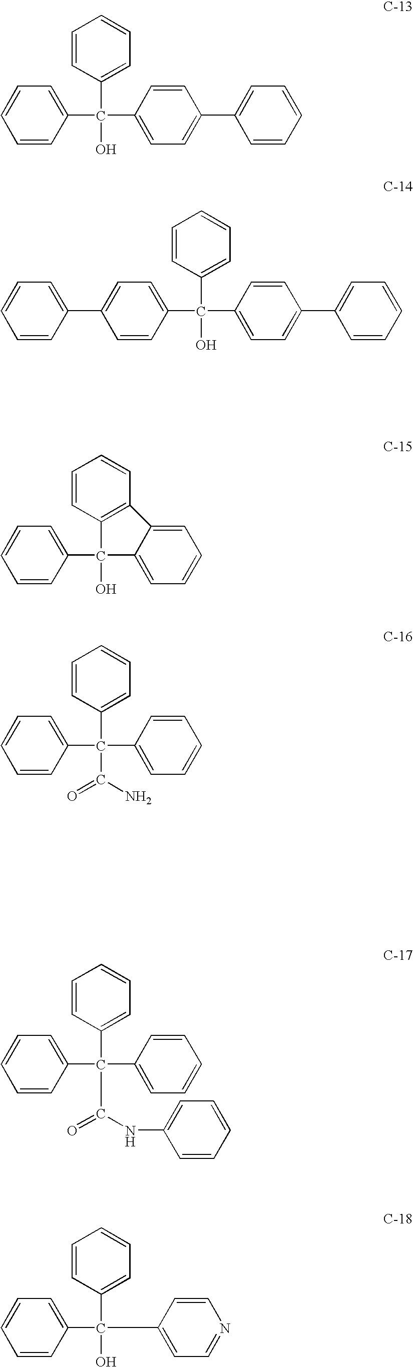

The compounds represented by general formula (I) or (II) may be used independently or as a mixture of two or more compounds. The use in combination of compounds represented by general formula (I) or (II) is also preferable for the purpose of the present invention. The hydrophobizing agent according to the present invention is used in the amount of from 0.01 to 30 parts by mass and preferably from 0.5 to 20 parts by mass against 100 parts by mass of cellulose acylate. The use of the above compounds in those ranges makes it possible to lower the water content of the film without lowering its elastic modulus substantially.

The hydrophobizing agent according to the present invention may be added to a cellulose acylate solution (dope) after being dissolved in an organic solvent, such as alcohol, methylene chloride or dioxolan, or directly into the dope composition.

The cellulose acylate film according to the present invention preferably contains an ultraviolet absorber beside the hydrophobizing agent.

Compounds such as oxybenzophenone, benzotriazole, a salicyclic ester, benzophenone, a cyanoacrylate and a complex nickel salt can be mentioned as examples of the ultraviolet absorbers which can be employed for the purpose of the present invention, though a benzotriazole compound is preferred for less likelihood of coloring. It is also suitable to use any ultraviolet absorber as mentioned in JP-A-Hei-10-182621 or JP-A-Hei-8-337574, or any high-molecular ultraviolet absorber as mentioned in JP-A-Hei-6-148430. When the cellulose acylate film according to the present invention is used as a protective film for a polarizing plate, it is desirable to use an ultraviolet absorber having a high power of absorbing ultraviolet rays having a wavelength of 370 nm or below to prevent any deterioration of a polarizer or liquid crystal, and not absorbing much visible light having a wavelength of 400 nm or above to ensure a good liquid crystal display.

Specific examples of benzotriazole ultraviolet absorbers which are useful for the purpose of the present invention are 2-(2′-hydroxy-5′-methylphenyl)benzotriazole, 2-(2′-hydroxy-3′,5′-di-tert-butylphenyl)benzotriazole, 2-(2′-hydroxy-3′-tert-butyl-5′-methylphenyl)benzotriazole, 2- (2′-hydroxy-3′,5′-di-tert-butylphenyl)-5-chlorobenzotri-azole, 2-(2′-hydroxy-3′-(3″,4″,5″,6″-tetrahydro-phthal-imidomethyl)-5-′-methylphenyl)benzotriazole, 2,2-methylenebis(4-(1,1,3,3-tetramethylbutyl)-6-(2H-benzo-triazole-2-yl)phenol), 2-(2′-hydroxy-3′-tert-butyl-5′-methyl-phenyl)-5-chlorobenzotriazole, 2-(2H-benzotriazole-2-yl)-6-(straight and side chain dodecyl)-4-methylphenol and a mixture of octyl-3-[3-tert-butyl-4-hydroxy-5-(chloro-2H-benzotriazole-2-yl)phenyl]propionate and 2-ethylhexyl-3-[3-tert-butyl-4-hydroxy-5-(5-chloro-2H-benzotriazole-2-yl)-phenyl]propionate, though these are not intended for limiting the compounds. It is also suitable to use a commercially available product, TINUVIN 109, TINUVIN 171 or TINUVIN 326, all of Ciba Specialty Chemicals.

The cellulose acylate film according to the present invention preferably contains a low-molecuar compound having a molecular weight of from 100 to 2,000 in order to have a lower water content without having a lower elastic modulus. The mass-average (log P) of the octanol-water partition coefficient of the low-molecular compound, as defined by the following equation, is preferable from 4 to 12, more preferably from 5 to 11 and most preferably from 6 to 10.
log P=[Σ(Mi×Pi)]/ΣMi
where Mi is the mass of the i-th low-molecular compound relative to the total amount of the low-molecular compounds which are added, and Pi is the value of log P of the i-th low-molecular compound.

The mass proportion of the low-molecular compound having a molecular weight of from 100 to 2,000 relative to the cellulose acylate in the cellulose acylate film according to the present invention is preferably from 5 to 35%, more preferably.from 10 to 30% and most preferably from 15 to 25%

[Manufacture of a Cellulose Acylate Film]

The cellulose acylate film of the present invention can be manufactured by a solvent casting method. The solvent casting method employs a solution (dope) prepared by dissolving cellulose acylate in an organic solvent for manufacturing a film.

The organic solvent preferably contains a solvent selected from among ethers having 3 to 12 carbon atoms, ketones having 3 to 12 carbon atoms, esters having 3 to 12 carbon atoms and halogenated hydrocarbons having 1 to 6 carbon atoms. The ethers, ketones and esters may or may not have a cyclic structure, and methylene chloride is a typical halogenated hydrocarbon.

A mixture of two or more kinds of organic solvents can also be employed.

The cellulose acylate solution can be prepared by a common method including treatment at a temperature of 0° C. or above (normal or elevated) or by a cooling and melting method.

The cellulose acylate solution (dope) prepared by any of various melting methods can be employed to make a cellulose acylate film by the solvent casting method. It is desirable to add a retardation improver to the dope.

The dope is cast onto a drum or band and the solvent is evaporated, whereby a film is formed. The dope preferably has its concentration adjusted to have a solid content of 18 to 35% before it is cast. The drum or band preferably has a mirror surface. The dope is preferably cast onto the drum or band having a surface temperature of 10° C. or below.

A drying method employed by the solvent casting method is described in U.S. Pat. Nos. 2,336,310, 2,367,603, 2,492,078, 2,492,977, 2,492,978, 2,607,704, 2,739,069 and 2,739,070, British Patents Nos. 640,731 and 736,892, JP-B-Sho-45-4554, JP-B-Sho-49-5614, JP-A-Sho-60-176834, JP-A-Sho-60-203430 and JP-A-Sho-62-115035. The drying on the band or drum can be performed by blowing air or an inert gas, such as nitrogen.

It is also possible to peel the film off the drum or band and dry it with hot air having a temperature varied progressively from 100° C. to 160° C. to thereby evaporate the residual solvent. The above method is described in JP-B-Hei-5-17844.

It is also possible to cast two or more layers to form a film by using a method as described in, for example, JP-A- Sho-61-158414, JP-A-Hei-1-122419 or JP-A-Hei-11-198285.

The cellulose acylate solution according to the present invention can be cast at the same time with another functional layer, for example, an adhesive, dye, antistatic, anti-halation, ultraviolet absorbing or polarizing layer.

The cellulose acylate film may contain a deterioration inhibitor, for example, an oxidation inhibitor, a peroxide decomposer, a radical inhibitor, a metal deactivator, an acid scavenger or an amine. The deterioration inhibitors are described in JP-A-Hei-3-199201, J?-A-Hei-5-1907073, JP-A- Hei-5-194789, JP-A-Hei-5-271471 and JP-A-Hei-6-107854. Preferred examples of deterioration inhibitors are butylated hydroxytoluene (BHT) and tribenzylamine (TBA).

The cellulose acylate film according to the present invention preferably contains micro-particles of e.g. an inorganic compound having an average particle diameter of 100 to 500 nm as a matting agent for preventing squeaking and creasing.

[Thickness of the Cellulose Acylate Film]

The cellulose acylate film according to the present invention preferably has a thickness of less than 80 μm, more preferably from 10 to 60 μm and most preferably from 10 to 40 μm. In the case of the film thickness of not less than 80 μm, it is insufficiently thin for application to a liquid crystal display. Further, if the film thickness is too thin, it is likely to present trouble such as breaking or creasing during its handling.

[Elastic Modulus of the Cellulose Acylate Film]

The elastic modulus of a cellulose acylate film may be determined by applying the procedure of JIS K7127 to a sample allowed to stand in an environment having a temperature of 25° C. and a relative humidity of 60% for 24 hours. A testing machine such as a TENSILON of A & D Inc. can be employed.

The cellulose acylate film of the present invention has an elastic modulus of 400 kgf/mm² (3.9×10³ N/mm²) or more either across its width or along its length at 25° C. and a relative humidity of 60%. It is preferably from 450 kgf/mm² (4.4×10³ N/mm²) to 600 kgf/mm² (5.9×10³ N/mm²). If it exceeds 600 kgf/mm², the film lowers its workability.

[Crystallinity of the Cellulose Acylate Film]

The film is preferably dried at a high temperature immediately after its peeling off the band or drum so that its crystallization may be promoted. Its drying temperature is preferably from 80° C. to 200° C., more preferably from 100° C. to 180° C. and most preferably from 120° C. to 160° C. For the purpose of the present invention, crystallinity is the sum of the values of diffraction peak strength as detected by X-ray diffraction analysis minus the values of diffraction strength at a Bragg angle 2θ of 14°.

The cellulose acylate film of the present invention preferably has a crystallinity of from 3,000 to 15,000, more preferably from 4,000 to 12,000 and most preferably from 5,000 to 9,000. If its crystallinity is too high, the film becomes brittle and has a high level of haze.

[Water Content of the Cellulose Acylate Film]

The water content of a cellulose acylate film can be estimated by determining its equilibrium water content at a given temperature and humidity. Its equilibrium water content can be determined by allowing a sample to stand at the given temperature and humidity for 24 hours so that its water content may reach an equilibrium, measuring its water content by the Karl Fischer's method and dividing its water content (g) by the mass (g) of the sample.

The cellulose acylate film of the present invention preferably has a water content of 2.9% by mass or less, more preferably 2.6% by mass or less and most preferably 2.3% by mass or less at 25° C. and a relative humidity of 80%. If its water content exceeds 2.9% by mass, it brings about a serious reduction in the degree of polarization when it is used as a protective film for a polarizing plate.

[Moisture Permeability]

The moisture permeability of a film is measured in accordance with the method as specified by JIS Z0208 and calculated as the amount (g) of water vaporizing per m² of area in 24 hours. The moisture permeability of a film is its property related closely to the durability of a polarizing plate and its lowering improves the durability of the polarizing plate. The cellulose acylate film according to the present invention preferably has a moisture permeability of from 20 to 200 g/m² per 24 hours in an environment having a temperature of 25° C. and a relative humidity of 90%. It is more preferably from 40 to 180 g/m² per 24 hours and still more preferably from 60 to 160 g/m² per 24 hours. If it is lower than 20 g/m² per 24 hours, the film fails to be satisfactorily dried when used for a polarizing plate, and gives a polarizing plate of low durability. If it exceeds 200 g/m² per 24 hours, the permeation of too much water through the film results in a polarizing plate of low durability.

The moisture permeability of the film can be lowered by reducing its adsorption of water and the rate of diffusion of water in the film. The hydrophobizing agent in the film according to the present invention is particularly desirable, since it can reduce its adsorption of water without allowing the diffusion of water at a higher rate therein. An increase in the crystallinity of the cellulose acylate film is also desirable, since it can reduce its adsorption of water without allowing the diffusion of water at a higher rate therein.

Moreover, the moisture permeability of a cellulose acylate film can be lowered by stretching cellulose acylate in the direction of its transportation and/or along its width during the manufacture of a film and thereby densifying the orientation of its molecular chains. Its stretching may be uniaxial or biaxial.

While biaxial stretching may be simultaneous or successive, successive biaxial stretching is preferred for continuous manufacture, and a film formed by casting a dope is peeled off a band or drum and is stretched transversely (or longitudinally) and then longitudinally (or transversely). A transverse stretching method is described in, for example, JP-A-Sho-62-115035, JP-A-Hei-4-152125, JP-A-Hei-4-2842 11, JP-A-Hei-4-2983 10 or JP-A-Hei-11-48271. The stretching ratio of the film (the ratio of its length increased by stretching to its original length) is preferably in the range of from 1 to 50%, more preferably from 5 to 40% and most preferably from 10 to 35%.

[Hygroscopic Expansion Coefficient]

The hygroscopic expansion coefficient of a sample indicates a change which occurs to its length from a change in relative humidity at a constant temperature.

The cellulose acylate film preferably has a hygroscopic expansion coefficient of 30×10⁻⁵/% RH or less, more preferably 15×10⁻⁵/% RH or less and most preferably 10×10⁻⁵/% RH or less. While a still lower hygroscopic expansion coefficient is desirable, its value is usually 1.0×10⁻⁵/% RH or larger to avoid any casing trim-like rise in permeability in a test for the durability of a polarizing plate.

A method of determining the hygroscopic expansion coefficient of a cellulose acylate film will now be explained. A specimen having a width of 5 mm and a length of 20 mm is cut out from a cellulose acylate film, is fixed at one end and is suspended in an atmosphere having a temperature of 25° C. and a relative humidity of 20% (R0). A weight of 0.5 g is suspended from the other end thereof and the specimen is left to stand for 10 minutes and has its length (L0) measured. Then, its length (L1) is measured in the atmosphere having its relative humidity raised to 80% (R1), while its temperature is kept at 25° C. Its hygroscopic expansion coefficient is calculated by the following formula. The measurement is made for 10 samples of each material and the average of the results is adopted.
Hygroscopic expansion coefficient [/% RH]={(L1−L0)/L0}/(R1−R0)

In order to reduce any dimensional change caused by moisture absorption as stated above, it is desirable to reduce the amount of the residual solvent in a polymer film as formed and thereby any free volume therein.

A common method of reducing any residual solvent is a long time of drying at a high temperature, but a long time of drying has the drawback of resulting in low productivity. Accordingly, the amount of the residual solvent in a cellulose acylate film is preferably in the range of from 0.01 to 1% by mass, more preferably from 0.02 to 0.07% by mass and most preferably from 0.03 to 0.05% by mass.

The control of the amount of the residual solvent as stated above enables the manufacture of a polarizing plate having an optical compensating power at a low cost with high productivity.

The amount of the residual solvent is determined by dissolving a given amount of sample in chloroform and employing a gas chromatograph (GC18A of Shimadzu Corporation).

As another method of reducing any dimensional change caused by moisture absorption as stated above, it is desirable to add a compound having a hydrophobic group. Any material having a hydrophobic group can be used if it is a material having a hydrophobic group, such as an alkyl or phenyl group, in its molecule, but the hydrophobizing agents according to the present invention as represented by general formulas (I) or (II) are particularly preferable because of their remarkable hydrophobizing effects.

The amount of the compound having a hydrophobic group is preferably in the range of from 0.01 to 30%, and more preferably from 0.1 to 20%, by mass of the solution (dope) which is prepared.

[Retardation of a Film]

The values of retardation, Re and Rth, of a film are defined by formulas (I) and (II):
Re=(nx−ny)×d (I)
Rth={(nx+ny)/2−nz}×d (II)

In formulas (I) and (II), nx is the refractive index of the film in the direction of a slow axis in its plane (i.e. in the direction in which it shows the maximum refractive index) and ny is the refractive index thereof in the direction of a fast axis (i.e. in the direction in which it shows the minimum refractive index).

In formula (II), nz is the refractive index of the film across its thickness. In formulas (I) and (II), d is the thickness of the film as expressed in nm.

The cellulose acylate film according to the present invention may be used as a protective film for a polarizing plate, and is particularly suitable for use as a retardation film corresponding to any of various modes of liquid crystal display.

When the cellulose acylate film according to the present invention is used as a retardation film, its preferred optical characteristics depend on the mode of liquid crystal display which is selected.

A film for the OCB mode preferably has a Re value of from 10 to 100 and more preferably from 20 to 70. Its Rth value is preferably from 50 to 300 and more preferably from 100 to 250.

A film for the VA mode preferably has a Re value of from 20 to 100 and more preferably from 30 to 70. Its Rth value is preferably from 50 to 250 and more preferably from 80 to 180.

A film for the TN mode preferably has a Re value of from 0 to 50 and more preferably from 2 to 30. Its Rth value is preferably from 10 to 200 and more preferably from 30to 150.

A cellulose acylate film having the retardation values as stated above can be coated with an optically anisotropic layer and used as an optical compensating film for the OCB and TN modes.

The cellulose acylate film preferably has a birefringence index (Δn:nx−ny) in the range of 0.00 to 0.002 μm. The support and opposite films preferably have a birefringence index across their thickness {(nx+ny)/2−nz} in the range of 0.00 to 0.04.

[Photoelasticity]

The cellulose acylate according to the present invention preferably has a photoelectric coefficient of 60×10⁻⁸ cm²/N or less and more preferably 20×10⁻⁸ cm²/N. The photoelastic coefficient can be determined by an ellipsometer.

[Glass Transition Temperature]

The cellulose acetate according to the present invention preferably has a glass transition temperature of 120° C. or above and more preferably 140° C. or above. The glass transition temperature is determined as the average of the temperature at which the baseline begins to shift as a result of the glass transition of the film when measurement is made at a heating rate of 10° C. per minute by using a differential scanning calorimeter (DSC), and the temperature at which the baseline returns to its initial position.

[Surface Treatment of the Cellulose Acylate Film]

The cellulose acylate film is preferably subjected to surface treatment. A specific method thereof is corona or glow discharge, flame, acid, alkali or ultraviolet irradiation treatment. It is also preferable to form an undercoat layer as described in JP-A-Hei-7-333433.

When the cellulose acylate film is used as a transparent protective film for a polarizing plate, its acid or alkali treatment, or its saponification is particularly preferable to ensure its adhesion to a polarizer.

The cellulose acylate film preferably has a surface energy of 55 mN/m or higher and more preferably from 60 to 75 mN/m. The surface energy of a solid can be determined by a contact angle method, a heat of wetting method or an adsorption method as described in “Fundamentals and Application of Wetting” (published by Realize Co., Dec. 10, 1989). The contact angle method is preferred for the cellulose acylate film of the present invention.

<Formation Method and the Like of Optical Functional Film>

In the present invention, the layers constituting the optical functional film each is preferably produced by a coating method. In the case of forming the layer by coating, each layer may be produced by a dip coating method, an air knife coating method, a curtain coating method, a roller coating method, a wire bar coating method, a gravure coating method, a microgravure coating method, an extrusion coating method (see, for example, U.S. Pat. No. 2,681,294) or a dye coating method (see, for example, JP-A-2003-20097, JP-A-2003-211052, JP-A-2003-236434, JP-A-2003-260400 and JP-A-2003-260402). Two or more layers may be coated simultaneously. The simultaneous coating method is described in U.S. Pat. Nos. 2,761,791, 2,941,898, 3,508,947 and 3,526,528, and Yuji Harasaki, Coating Kogaku (Coating Engineering), page 253, Asakura Shoten (1973). Among these, preferred are a wire bar coating method, a gravure coating method, a microgravure coating method and a die coating method, more preferred are a microgravure coating method and a die coating method, and most preferred is a die coating method.

The microgravure coating method is a coating method characterized in that a gravure roll having a diameter of about 10 to 100 mm, preferably from about 20 to 50 mm, and having a gravure pattern stamped on the entire circumference is rotated under the support in the direction reverse to the support-transporting direction and at the same time, an extra coating solution is scraped off from the surface of the gravure roll by a doctor blade, whereby a constant amount of the coating solution is transferred to and coated on the support.

In the microgravure coating method, the number of lines in the gravure pattern stamped on the gravure roll is preferably from 50 to 800 lines/inch, more preferably from 100 to 300 lines/inch. The depth of the gravure pattern is preferably from 1 to 600 μm, more preferably from 5 to 200 μm. The rotation number of the gravure roll is preferably from 3 to 800 rpm, more preferably from 5 to 200 rpm. The support transportation speed is preferably from 0.5 to 100 m/min, more preferably from 1 to 50 m/min.

In the die coating method, a coating solution fed in the bead form from a slot die having formed in the inside thereof a pocket is coated on a continuously running web supported by a backup roller, whereby a coating film is formed on the web. Coating to a wet film thickness of tens of μm or less can be performed with good precision by adjusting the distance between the end of the slot die and the web, on the upstream side and the downstream side of the slot member with respect to the wet travelling direction. The die coater which is preferably used particularly for a region having a small wet coated amount (20 ml/m² or less) as in the light-diffusing layer or low refractive index layer of the present invention, is described below.

<Constitution of Die Coater>

FIG. 2 is a cross-sectional view of a coater using a slot die according to the present invention. A coater 10 applies a coating liquid 14 from a slot die 13 in the form of a bead 14a onto a continuously moving web W supported by a backup roll 11, thereby forming a coating film 14b on the web W.

A pocket 15 and a slot 16 are formed in the slot die 13. The pocket 15 has a cross section formed by curved and straight lines, which may be, for example, a substantially circular form as illustrated in FIG. 2 or a semi-circular form. The pocket 15 is a coating liquid reservoir having a cross-sectional shape elongated in a width direction of the slot die 13, and an effective elongated length thereof is typically equal to or slightly longer than a width of coating. The coating liquid 14 is supplied into the pocket 15 from a side surface of the slot die 13 or from the center of the surface that is opposite to a slot opening portion 16a. Also, the pocket 15 is provided with a stopper for preventing leakage of the coating liquid 14.

The slot 16 is a flow passage of the coating liquid 14 from the pocket 15 to the web W, and has, similar to the pocket 15, a cross-sectional shape elongated in the width direction of the slot die 13, and the opening portion 16a disposed on the web side is typically adjusted in width by using a width regulating plate or the like (not shown), so as to have a width substantially equal to the width of coating. The angle made between the slot tip of the slot 16 and a tangent line in the web moving direction of the backup roll 11 is preferably from 30° to 90°.

A tip lip 17 of the slot die 13 at which the opening portion 16a of the slot 16 is disposed is formed in a tapered shape, and the tip is a flat portion 18 which is called “land”. A portion of the land 18 upstream in the traveling direction of the web W with respect to the slot 16 is referred to as an “upstream-side lip land 18a”, and a downstream portion of the land 18 is referred to as a “downstream-side lip land 18b”.

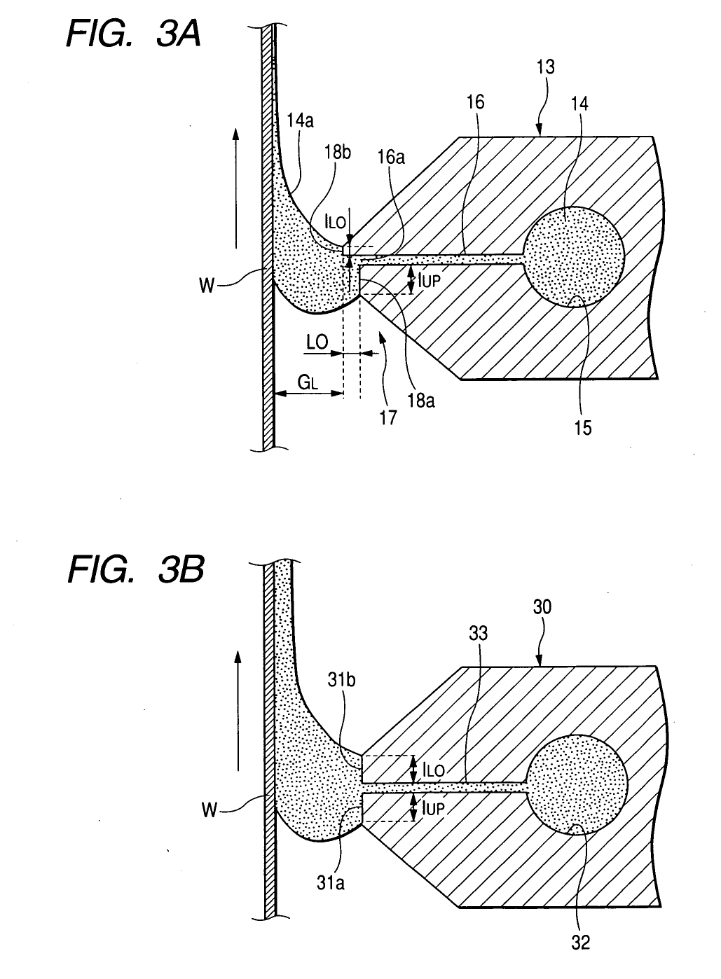

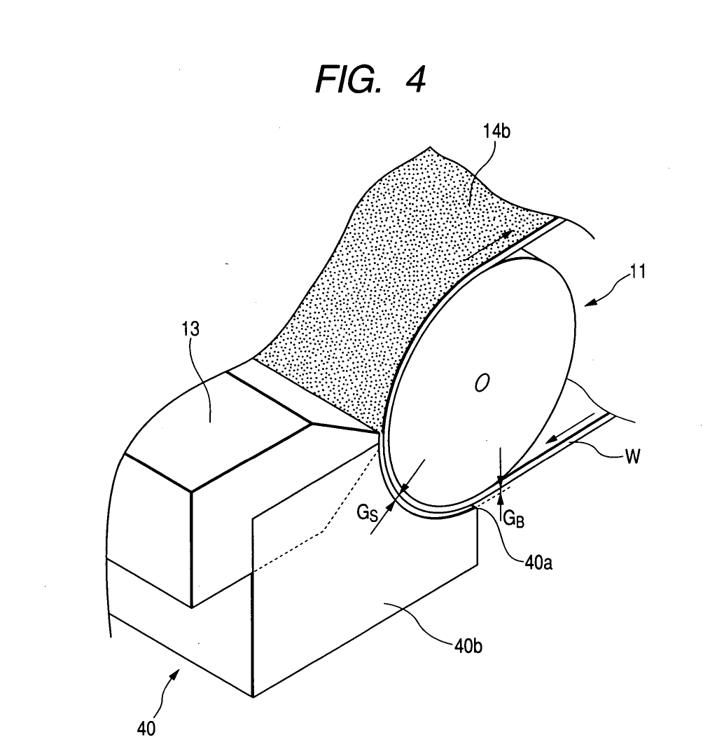

FIG. 3 illustrates a cross-sectional shape of the slot die 13 in comparison with that of a conventional one, and in the figure, (A) illustrates the slot die 13 of the present invention, and (B) illustrates a conventional slot die 30. In the conventional slot die 30, an upstream-side lip land 31a and a downstream-side lip land 31b are at the same distance from a web. Note that reference numerals 32 and 33 denote a pocket and a slot, respectively. On the other hand, in the slot die 13 of the present invention, the length ILO of the downstream-side lip land is designed to be short, whereby it is possible to apply a wetting film having a thickness of 20 μm or less with high precision.

A land length Iᵤₚ of the upstream-side lip land 18a is not particularly limited, but preferably in the range from 500 μm to 1 mm. The land length I_{LO} of the downstream-side lip land 18b is from 30 μm to 100 μm, preferably 30 μm to 80 μm, and more preferably 30 μm to 60 μm. In the case where the land length I_{LO} of the downstream-side lip is less than 30 μm, the edge of the tip lip or the land can be readily broken, likely leading to occurrence of a streak on the coating film. As a result, it is not possible to carry out the application. Also, it is made difficult to set the position of the wetting line on the downstream side, causing a problem that the coating liquid is likely to be spread on the downstream side. The spreading of the coating liquid on the downstream side means occurrence of a nonuniform wettirig line, which is conventionally known to lead to a problem that a defect, such as a streak or the like, occurs on a coating surface. On the other hand, in the case where the length I_{LO} of the downstream-side lip is greater than 100 μm, a bead itself cannot be formed, and therefore, it is not possible to apply a thin layer.

Further, an overbite shape is formed such that the downstream-side lip land 18b is positioned closer to the web W than the upstream-side lip land 18a, and therefore, it is possible to reduce the degree of decompression and thereby to form a bead suitable for applying a thin film. The difference between a distance from the downstream-side lip land 18b to the web W and a distance from the upstream-side lip land 18a to the web W (hereinafter, referred to as an “overbite length LO”) is preferably 30 μm to 120 μm, more preferably 30 μm to 100 μm, and most preferably 30 μm to 80 μm. When the slot die 13 has an overbite shape, a gap GL between the tip lip 17 and the web W refers to a gap between the downstream-side lip land 18b and the web W.

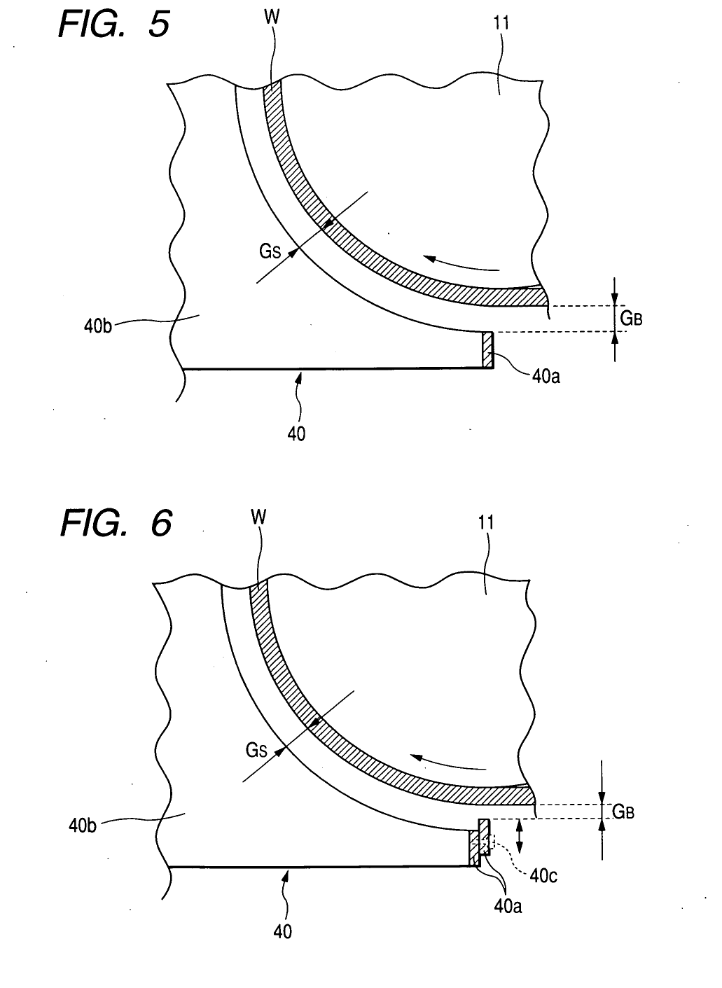

FIG. 4 is a perspective view illustrating a slot die and its peripheral portion in an applying step according to the present invention. A decompression chamber 40 is provided out of contact with the web W and on a side opposite to the traveling direction of the web W so that a sufficient decompression adjustment can be performed with respect to the bead 14a. The decompression chamber 40 includes a back plate 40a and a side plate 40b which are provided for holding the operating efficiency thereof, and gaps G_{B} and G_{S} are present between the back plate 40a and the web W and between the side plate 40b and the web W, respectively. FIGS. 5 and 6 are cross-sectional views illustrating the decompression chamber 40 and the web W which are close to each other. The side plate and the back plate may be integrated with the chamber as illustrated in FIG. 5 or may be attached to the chamber by a screw 40c or the like so that the gap can be changed as appropriate, as illustrated in FIG. 6. In any structure, the actual spaces between the back plate 40a and the web W and between the side plate 40b and the web W are defined as gaps G_{B} and G_{S}, respectively. In the case where the decompression chamber 40 is provided below the web W and the slot die 13 as illustrated in FIG. 4, a gap G_{B} between the back plate 40a of the decompression chamber 40 and the web W denotes a gap between the top end of the back plate 40a and the web W.

The gap G_{B} between the back plate 40a and the web W is preferably greater than a gap G_{L} between the tip lip 17 of the slot die 13 and the web W, so that variations in degree of decompression in the vicinity of the bead, which are caused by the eccentricity of the backup roll 11, can be suppressed. For example, when the gap GL between the tip lip 17 of the slot die 13 and the web W is 30 μm to 100 μm, the gap G_{B} between the back plate 40a and the web W is preferably 100 μm to 500 μm.

(Materials and Precision)

The longer the length in the web moving direction of the tip lip on the web traveling direction side, the more significant the disadvantage for formation of the bead. If this length varies between any points in the width direction of the slot die, the bead is rendered unstable even by slight disturbance. Therefore, the variation range of the length in the width direction of the slot die is preferably within 20 μm.

Also, if a material, such as stainless steel or the like, is used as the material for the tip lip of the slot die, the material sags at the stage of die processing, so that even if the length of the slot die tip lip in the moving direction is in the range from 30 to 100 μm, the precision of the tip lip is not satisfied. Accordingly, in order to ensure high processing precision, it is essential to use a superhard material as disclosed by Japanese Patent No. 2817053. Specifically, at least the tip lip of the slot die is preferably composed of a superhard alloy obtained by binding carbide crystal having an average particle size of 5 μm or less. Examples of the superhard alloy include those obtained by binding crystal particles of carbide, such as tungsten carbide or the like (hereinafter, referred to as “WC”), with a binding metal, such as cobalt or the like. Examples of the binding metal further include titanium, tantalum, niobium, and mixed metals thereof The average particle size of the WC crystals is more preferably 3 μm or less.

In order to realize high precision application, the length of the web traveling direction side land of the tip lip and variations in the gap from the web in the width direction of the slot die are important factors. It is desirable to achieve the straightness in a range in which a combination of the two factors, i.e., the variation range of the gap, can be suppressed to some extent. Preferably, the straightness between the tip lip and the backup roll is achieved such that the variation range of the gap in the width direction of the slot die is 5 [m or less.

(Application Speed)

The precision of the backup roll and the tip lip is achieved as described above, and therefore, the coating method preferably used in the present invention provides a highly stable film thickness at the time of high-speed coating. Further, the coating method of the present invention is of a pre-measurement type, and therefore, it is easy to ensure the stable film thickness even at the time of high-speed coating. The coating method of the present invention can apply a low amount of coating liquid for the anti-reflection film of the present invention at high speed to achieve a satisfactorily stable film thickness. Although the coating can be carried out by other coating methods, a dip coating method inevitably vibrates the coating liquid in a liquid tank, readily causing stepwise irregularities. A reverse roll coating method easily causes stepwise irregularities due to the eccentricity or deflection of a roll involved in the coating. Also, these coating methods are of a post-measurement type, and therefore, it is difficult to ensure a stable film thickness. It is preferable to carry out coating at 25 m/min or more in terms of productivity to use the production method of the present invention.

(Wet Coating Amount)

When the anti-glare layer is formed, it is preferable to apply the coating liquid onto a base film directly or via another layer to a wet coating thickness ranging from 6 to 30 μm, more preferably from 3 to 20 μm, from the viewpoint of prevention of uneven drying. Also, when the low refractive index layer is formed, it is preferable to apply a coating composition onto the anti-glare layer directly or via another layer to a wet coating thickness ranging from 1 to 10 μm, more preferably from 2 to 5 μm.

(Drying)

The anti-glare layer and the low refractive index layer are applied onto the base film directly or via another layer, and thereafter, they are transferred in the form of a web to a zone heated for drying a solvent. In this case, it is preferable that the temperature in the drying zone be 25° C. to 140° C., the temperature in the first half of the drying zone is relatively low, and the temperature in the second half is relatively high. However, the temperature is preferably less than or equal to a temperature at which a component(s) other than a solvent contained in a coating composition for each layer starts volatilization. For example, some commercially-available photoradical generators used in combination with ultraviolet curable resin volatilize by about several tens of percent within several minutes in warm air of 120° C. Also, some monofunctional and bifunctional acrylate monomers start volatilization in warm air of 100° C. In such a case, the temperature at which a component(s) other than a solvent contained in a coating composition for each layer starts volatilization or a temperature less than that is preferable as described above.

Also, in order to prevent uneven drying, after applying the coating composition for each layer onto the base film, the drying air is preferably blown onto the coating film surface at a speed in the range of 0.1 to 2 m/sec when the solid content concentration of the coating composition is I to 50%.

Also, it is preferable that after the coating composition for each layer is applied onto the base film, the difference in temperature in the drying zone between the base film and a transfer roll in contact with a surface of the base material which is opposite to the coated surface of the base film, be 0° C. to 20° C., because it is possible to prevent uneven drying from occurring due to uneven heat transfer on the transfer roll.

(Curing)

After the solvent drying zone, the web is passed through a zone for curing each coating film by means of ionizing radiation and/or heat, to cure the coating film. For example, if the coating film is ultraviolet curable, an ultraviolet lamp is preferably used to irradiate each layer with ultraviolet at an irradiation does of 10 mJ/cm² to 1000 mJ/cm². At this time, the distribution of the irradiation dose from end to end of the web in the width direction of the web is preferably 50 to 100%, more preferably 80 to 100%, with respect to the maximum irradiation dose in the center. When it is necessary to purge nitrogen gas or the like to reduce the oxygen concentration for the purpose of accelerating surface curing, the oxygen concentration is preferably 0.01% to 5%, and the oxygen concentration in the width direction distribution is preferably 2% or less.

Also, in the case where the curing rate (100—residual functional group content) of the anti-glare layer is a value less than 100%, when the low refractive index layer of the present invention is provided thereon and is cured by means of ionizing radiation and/or heat, the curing rate of the anti-glare layer located therebelow is preferably increased before providing the low refractive index layer, improving the adhesion ability between the anti-glare layer and the low refractive index layer.

The thus-formed optical functional film of the present invention preferably has the following characteristic values.

(Surface Shape)

The optical functional film is preferably designed to have a surface irregularity shape such that the centerline average roughness Ra is from 0.08 to 0.30 μm, the 10-point average roughness Rz is 10 times or less of Ra, the average peak-to-trough distance Sm is from 1 to 100 μm, the standard deviation of the protrusion height from the deepest portion of irregularities is 0.5 μm or less, the standard deviation of the average peak-to-trough distance Sm based on the centerline is 20 μm or less, and the plane at a tilt angle of 0 to 5° occupies 10% or more, because satisfactory antiglare property and visually uniform matted feeling are achieved. If the Ra is less than 0.08, a sufficiently high antiglare property may not be obtained, whereas if it exceeds 0.30, there arises a problem such as glaring or whitening of the surface when outside light is reflected.

(Sliding Property)

The optical functional film comprising the cellulose acylate support according to the present invention preferably has low static and dynamic friction coefficients, since its small thickness is likely to cause phenomena affecting its sliding property, such as squeaking and creasing, in a process from hardening after coating to winding.

Squeaking is likely to occur if a sample film has a high degree of smoothness on its inner and outer surfaces or a high static friction coefficient therebetween when it is wound. Creasing often occurs if a sample film has difficulty in the sliding of its surfaces when it is heat treated, since its expansion and contraction occur in a non-uniform way, form winding creases on the film and thereby lower its surface smoothness.

The outermost surface of the coating on the film of the present invention preferably has a dynamic friction coefficient of 0.15 or less, more preferably from 0.04 to 0.12 and still more preferably from 0.05 to 0.08.

(Optical Characteristics)

Also, when the color tint of reflected light under a C light source has a* value of −2 to 2 and b* value of −3 to 3 in the CIE 1976 L*a*b* color space and the ratio of minimum reflectance to maximum reflectance in the range of 380 to 780 nm is from 0.5 to 0.99, the reflected light gives a neutral color tint and this is preferred. Furthermore, the b* value of transmitted light under a C light source is preferably adjusted to 0 to 3, because yellow tinting of white display when the optical functional film is applied to a display device, is decreased.

Also, in the optical characteristics of the optical functional film of the present invention, the internal haze attributed to internal scattering (hereinafter referred to as an “internal haze”) is preferably from 5 to 20%, more preferably from 5 to 15%. If the internal haze is less than 5%, the combination of usable materials is limited to render-the adjustment of the antiglare property and other characteristic values difficult, and the cost rises, whereas if the internal haze exceeds 20%, the dark room contrast is greatly worsened. Also, the haze attributed to surface scattering (hereinafter referred to as “surface haze”) is preferably from 1 to 10%, more preferably from 2 to 7%, and the transmitted image clarity at a width of 0.5 mm is preferably from 5 to 30%, because both sufficiently high antiglare property and improvement of image blurring and reduction in the dark room contrast can be satisfied. If the surface haze is less than 1%, the antiglare property is insufficient, whereas if it exceeds 10%, there arises a problem such as whitening of the surface when outside light is reflected. Furthermore, the mirror reflectance is preferably 2.5% or less and the transmittance is preferably 90% or more, because the reflection of outside light can be suppressed and the visibility is enhanced.

The optical functional film of the present invention produced in this way may be used as a surface film of various known display materials by attaching it with a known pressure-sensitive adhesive, or a polarizing plate prepared by using the optical functional film may be used in a liquid display device. In this case, the optical functional film is disposed on the outermost surface of the display, for example, by providing an adhesive layer on one surface. The optical functional film of the present invention is preferably used for at least one sheet out of two protective films sandwiching a polarizing film of a polarizing plate from both sides.

By arranging the optical functional film of the present invention to serve also as a protective film, the production cost of the polarizing plate can be reduced. Furthermore, by using the film of the present invention as an outermost surface layer, a polarizing plate prevented from the projection of outside light or the like and assured of excellent properties such as scratch resistance and antifouling property can be obtained.

At the time of producing a polarizing plate by using the optical functional film of the present invention for one of two surface protective films of the polarizing film, the surface of the transparent support opposite the side having an antireflection structure, that is, the surface on the side laminated with the polarizing film, is preferably hydrophilized to improve the adhesive property on the surface for the adhesion.

[Saponification Treatment]

(1) Method by Dipping in Alkali Solution

This is a technique of dipping the optical functional film in an alkali solution under appropriate conditions to saponify all the surface having reactivity with an alkali on the entire surface of the film. This method requires no particular equipment and is preferred in view of cost. The alkali solution is preferably an aqueous sodium hydroxide solution. The concentration is preferably from 0.5 to 3 mol/liter, more preferably from 1 to 2 mol/liter. The liquid temperature of the alkali solution is preferably from 30 to 75° C., more preferably from 40 to 60° C.

The combination of the saponification conditions is preferably a combination of relatively mild conditions but may be selected according to the material or construction of the optical functional film or the objective contact angle.

The film after dipping in an alkali solution is preferably well washed with water or dipped in a dilute acid to neutralize the alkali component so as to prevent the alkali component from remaining in the film.

By the saponification treatment, the surface of the transparent support opposite the surface having a light-diffusing layer or an antireflection layer is hydrophilized. The protective film for the polarizing plate is used by bonding the polarizing film to the hydrophilized surface of the transparent support.

The hydrophilized surface is effective for improving the adhesive property to the adhesive layer mainly comprising a polyvinyl alcohol.

In the saponification treatment, the contact angle with water on the surface of the transparent support opposite the surface having an optical functional layer is preferably lower in view of adhesive property to the polarizing film, but, on the other hand, according to the dipping method, the region from the surface having an optical functional layer to the inside is damaged at the same time and therefore, it is important to select minimum necessary reaction conditions. As the index for the damage of each layer by an alkali, particularly in the case where the transparent support is triacetyl cellulose, the contact angle with water of the transparent support surface on the opposite side is preferably from 10 to 50°, more preferably from 30 to 50°, still more preferably from 40 to 50°. If the contact angle exceeds 50°, there arises a problem in the adhesive property to the polarizing film and this is not preferred, whereas if the contact angle is less than 10°, the antireflection film is significantly damaged and the physical strength is disadvantageously impaired.

(2) Method by Coating with Alkali Solution

In order to avoid the damage of each film in the dipping method, an alkali solution coating method of coating an alkali solution only on the surface opposite the surface having an optical functional layer under appropriate conditions, and subjecting the film to heating, water washing and drying, is preferably used. In this case, the “coating” means to contact an alkali solution only with the surface to be saponified and includes spraying and contact with a belt or the like impregnated with the solution, in addition to the coating. This method requires equipment and a step for coating the alkali solution and therefore, is inferior to the dipping method of (1) in view of the cost. However, since the alkali solution comes into contact only with the surface to be saponified, the film may have a layer using a material weak to an alkali solution on the opposite surface. For example, the vapor deposition film or sol-gel film is subject to various effects such as corrosion, dissolution and separation by the alkali solution and is not preferably provided in the case of dipping method, but in this coating method, such a film does not contact with the solution and therefore, can be used without problem.

The saponification methods (1) and (2) either can be performed after unrolling a roll-form support and forming respective layers and therefore, may be included in a series of operations by adding the treatment after the production step of the light-scattering film or antireflection film. Similarly, by continuously performing the step of laminating the film to a polarizing plate comprising the unrolled support, a polarizing plate can be produced with higher efficiency than in the case of performing the same operation in the sheet-fed manner.

(3) Method of Performing Saponification by Protecting Optical Functional Layer with Laminate Film

Similarly to (2) above, when the light-diffusing layer and/or the low refractive index layer is insufficient in the resistance against an alkali solution, a method of laminating a laminate film on the surface where a final layer is formed after the formation of the final layer, dipping it in an alkali solution to hydrophilize only the triacetyl cellulose surface opposite the surface where the final layer is formed, and then separating the laminate film, may also be employed. Also in this method, a hydrophilizing treatment enough as a protective film of a polarizing plate can be applied only to the surface of the triacetyl cellulose film opposite the surface where the final layer is formed, without damaging the light-diffusing layer or the low refractive index layer. As compared with the method (2), this method is advantageous in that an apparatus for coating a special alkali solution is not necessary, though the laminate film remains as a waste.

(4) Method by Dipping in Alkali Solution After Formation Up to Light-Diffusing Layer

In the case where the layers up to the light-diffusing layer have resistance against an alkali solution but the low refractive index layer is insufficient in the resistance against an alkali solution, a method of forming the layers up to the light-diffusing layer, then dipping the film in an alkali solution to hydrophilize both surfaces, and thereafter forming the low refractive index layer on the light-diffusing layer, may be employed. The production process becomes cumbersome, but particularly when the low refractive index layer has a hydrophilic group, such as fluorine-containing sol-gel film, the interlayer adhesion between the light-diffusing layer and the low refractive index layer is advantageously enhanced.

(5) Method of Forming Optical Functional Layer on Previously Saponified Triacetyl Cellulose Film

After previously saponifying a triacetyl cellulose film, for example, by dipping it in an alkali solution, an optical functional layer may be formed on either one surface directly or through another layer. In the case of performing the saponification by dipping the film in an alkali solution, the interlayer adhesion between the light-diffusion layer or other layer and the triacetyl cellulose surface hydrophilized by the saponification is sometimes worsened. Such a problem can be solved by applying, after saponification, a treatment such as corona discharge or glow discharge only to the surface where the light-diffusing layer or other layer is formed, thereby removing the hydrophilized surface, and then forming the antiglare layer or other layer. Also, when the antiglare layer or other layer has a hydrophilic group, good interlayer adhesion may be obtained.

The polarizing plate using the optical functional film of the present invention, and the liquid crystal display device using the polarizing plate are described below.

[Polarizing Plate]

The polarizing plate of the present invention preferably has the optical functional film of the present invention, for example, the light-scattering film or antireflection film, as at least one protective film of the polarizing film (protective film for polarizing plate). In the protective film for polarizing plate, the contact angle with water on the surface of the transparent support opposite the side having the optical functional layer, that is, the surface on the side laminated with the polarizing film, is preferably from 10 to 50°.

By virtue of using the optical functional film of the present invention as the protective film for polarizing plate, a polarizing plate excellent in the physical strength and light resistance having a light-scattering function or an antireflection function can be produced, and great reduction in the cost and thinning of the display device can be realized.

Also, when the polarizing plate is produced by using the optical functional film of the present invention as one protective film for polarizing plate and using an optical compensation film having optically anisotropic property, which is described later, as another protective film of the polarizing film, a polarizing plate capable of providing a liquid crystal display improved in the visibility or contrast in a bright room and assured of remarkably widened view angle in the vertical and horizontal directions can be produced.

[Optical Compensation Film]

By providing the polarizing plate with an optical compensation film (a retardation layer), it is possible to improve viewing angle characteristics of a liquid crystal display screen.

As the optical compensation film, a known film can be used, but it is preferable, in terms of widening the viewing angle, to use an optical compensation film characterized by including an optically anisotropic layer composed of a compound having a discotic structural unit, in which the angle made between the discotic compound and a transparent support varies depending on a distance from the transparent support.

The angle is preferably increased with an increase in the distance from the transparent support-side surface of the optically anisotropic layer composed of the discotic compound.

When the optical compensation film is used as a protection film of the polarizing film, a surface of the optical compensation film which is to be bonded to the polarizing film is preferably subjected to saponification treatment which is preferably carried out in teh above-described manner.

[Polarizing Film]

As the polarizing film, a known polarizing film, or a polarizing film cut out from a long polarizing film having an absorption axis neither parallel nor vertical to a longitudinal direction may be used. The long polarizing film having an absorption axis neither parallel nor vertical to the longitudinal direction is produced with the following method.

Specifically, a polarizing film is obtained by holding opposite ends of a polymer film which is continuously fed, with a holding means, and drawing it by providing tension thereto, in accordance with a drawing method in which the film is drawn by a factor of 1.1 to 20.0 at least in a film width direction, the difference in moving speed in the longitudinal direction between a holding device at opposite film ends is within 3%, and the film traveling direction is bent, with the opposite film ends being held, so that an angle made between the film traveling direction at the end of the step for holding the opposite film ends and the substantial film drawing direction is tilted by 20 to 70°. Particularly, the angle inclined by 45° is preferable from the viewpoint of productivity.

The method for drawing a polymer film is described in detail in paragraphs 0020 to 0030 of Japanese Unexamined Patent Publication No. 2002-86554.

<Liquid Crystal Display Device>

The optical functional film of the present invention can be applied to an image display device such as liquid crystal display device (LCD), plasma display panel (PDP), electroluminescence display (ELD) and cathode ray tube display device (CRT). The optical functional film of the present invention has a transparent support and therefore, this is used by bonding the transparent support side to the image display surface of an image display device.

In the case of using the optical functional film of the present invention as one surface protective film of the polarizing film, the film can be preferably used for a transmissive, reflective or semi-transmissive liquid crystal display device in a mode such as twisted nematic (TN) mode, super twisted nematic (STN) mode, vertical alignment (VA) mode, in-plane switching (EPS) mode or optically compensated bend cell (OCB) mode. Particularly, the optical functional film can be preferably used for a mode such as VA, EPS and OCB in the case of usage such as large-size liquid crystal television, and may also be preferably used for a mode such as TN and STN in the case of usage in a medium or small display device with low definition. As for usage such as large-size liquid crystal television, the optical functional film can be preferably used particularly for a display device where the display screen has a 20-inch diagonal size or more and the definition is XGA or less (in a display device with an aspect ratio of 3:4, 1,024×768 or less). The optical functional film of the present invention has substantially no internal haze and is not preferred in the case of placing importance on the glaring, because the glaring exceeds the permissible level when the orthogonal size is 20 inches and the definition is more than XGA (in a display device with an aspect ratio of 3:4, 1,024×768 or less). Also, since the degree of glaring has relationship with the pixel size and the surface irregularity shape of the antiglare film on the surface, the optical functional film of the present invention can be preferably used for the definition of UXGA (in a display device with an aspect ratio of 3:4, 1,600×1,200) or less when the size of the display device is 30 inches, and for the definition of QXGA (in a display device with an aspect ratio of 3:4, 2,048×1,536) or less when the size is 40 inches.

A liquid crystal cell of the VA mode include: (1) a liquid crystal cell of the VA mode in a narrow sense (described in Japanese Unexamined Patent Publication No. H02-176625) in which rod-like liquid crystal molecules are substantially vertically aligned in the absence of applied voltage, and are substantially horizontally aligned in the presence of applied voltage; (2) a liquid crystal cell (of the MVA mode) in which the VA mode is modified to be multi-domain type so as to enlarge a viewing angle (described in SID97, Digest of Tech. Papers (proceedings), 28(1997), 845); (3) a liquid crystal cell of a mode (n-ASM mode) in which rod-like liquid crystalline molecules are substantially vertically aligned in the absence of applied voltage, and are in twisted multi-domain alignment in the presence of applied voltage (described in Digest of tech. Papers 58-59 (1998), Liquid crystal forum of Japan; and (4) a liquid crystal cell of SURVAIVAL mode (presented at LCD international 98).

The liquid crystal cell of the OCB mode is a liquid crystal display device using a liquid crystal cell of bend alignment mode in which rod-like liquid crystalline molecules are substantially reversely (symmetrically) aligned in upper and lower parts of the liquid crystal cell, and is disclosed in U.S. Pat. Nos. 4,583,825 and 5,410,422. Since the rod-like liquid crystal molecules are symmetrically aligned in upper and lower parts of the liquid crystal cell, the liquid crystal cell of the bend alignment mode has a self-optical compensatory function. Accordingly, this liquid crystal mode is referred to as OCB (Optically Compensatory Bend) liquid crystal mode. The liquid crystal display device of the bend alignment mode has an advantage of quick response speed.

In a liquid crystal cell of the ECB mode, rod-like liquid crystalline molecules are substantially horizontally aligned in the absence of applied voltage, and the liquid crystal cell of this mode is most widely used as a color TFT liquid crystal display device, and is described in a number of publications, e.g., “EL, PDP, and LCD displays”, published by Toray Research Center, Inc. (2001).

### EXAMPLES

The present invention is described below in greater detail by referring to Examples, but the present invention is not limited thereto. Unless otherwise indicated, the “parts” and “%” are on the mass basis.

### Example 1

(Preparation of Cellulose Acetate Film 1)

### Cellulose acetate solution A having the following composition was prepared.

Composition of Cellulose Acetate Solution A

| | | |
|---|---|---|
| Cellulose acetate having an acetylation degree | 100 | parts by mass |
| of 60.9% | | |
| Triphenyl phosphate (plasticizer) | 7.8 | parts by mass |
| Biphenyldiphenyl phosphate (plasticizer) | 3.9 | parts by mass |
| Methylene chloride (first solvent) | 300 | parts by mass |
| Methanol (second solvent) | 54 | parts by mass |
| 1-Butanol (third solvent) | 11 | parts by mass |

The cellulose acetate solution A was thoroughly stirred and left standing at room temperature (25° C.) for 3 hours, and the resulting gel-like solution was cooled at −70° C. for 6 hours and then stirred under heating at 50° C. to obtain a completely dissolved dope.

The dope obtained was filtered through a filer paper having an absolute filtration accuracy of 0.01 mm (#63, produced by Toyo Roshi Kaisha, Ltd.), then filtered through a filter paper having an absolute filtration accuracy of 0.025 mm (FH025, produced by Poul K.K.), and defoamed to prepare a dope.

(Solution Casting Method)

The cellulose acetate solution A was cast by using a band casting machine, and the process of forming a cellulose acylate film from the cellulose acylate solution was performed.

As for the metal support (casting band), a band comprising a stainless steel and having a width of 2 m and a length of 56 m (area: 112 m²) was used. The dope cast was dried at an air velocity of 0.5 m/s or less for 1 second immediately after casting and thereafter dried at an air velocity of 15 m/s. The temperature of the drying air was 50° C.

The residual solvent amount of the film stripped from the casting band was 230 mass %, and the film temperature was −6° C. The average drying speed in the time period from casting to stripping was 744 mass %/min. Also, the gelling temperature of the dope at the stripping was about 10° C. The film was dried for 1 minute when the film surface temperature became 40° C. on the metal support, and dried with a drying air at 120° C. after stripping.

The film thickness is varied to 40 μm, 30 μm, 20 μm, 60 μm, 70 μm, 80 μm and 90 μm as shown in Table 2 by controlling the amount of the dope cast in the above-described method to produce respective cellulose acylate films 1.

(Synthesis of Perfluoroolefin Copolymer (1))

Perfluoroolefin Copolymer (1):

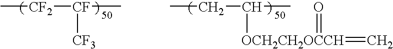

### (50:50 is the ratio by mol)

Ethyl acetate (40 ml), 14.7 g of hydroxyethyl vinyl ether and 0.55 g of dilauryol peroxide were charged into a stainless steel-made autoclave with a stirrer having an internal volume of 100 ml, and the system was evacuated and purged with a nitrogen gas. Furthermore, 25 g of hexafluoropropylene (HFP) was introduced into the autoclave and the system was heated to 65° C. The pressure when the temperature in the autoclave reached 65° was 0.53 MPa (5.4 kg/cm²). The reaction was continued for 8 hours while keeping the temperature and when the pressure reached 0.31 MPa (3.2 kg/cm²), the heating was stopped and the system was allowed to cool. At the time where the inner temperature dropped to room temperature, the unreacted monomer was expelled and after opening the autoclave, the reaction solution was taken out. The reaction solution obtained was poured in a large excess of hexane and the precipitated polymer was taken out by removing the solvent by means of decantation. This polymer was dissolved in a small amount of ethyl acetate, and reprecipitation from hexane was performed twice to completely remove the residual monomer. After drying, 28 g of polymer was obtained. Subsequently, 20 g of this polymer was dissolved in 100 ml of N,N-dimethylacetamide, and 11.4 g of acrylic acid chloride was added thereto under ice cooling, followed by stirring at room temperature for 10 hours. After adding ethyl acetate, the reaction solution was washed with water, and the organic layer was extracted and then concentrated. The obtained polymer was reprecipitated with hexane to obtain 19 g of Perfluoroolefin Copolymer (1). The refractive index of the obtained polymer was 1.421.

(Preparation of Organosilane Compound A Solution)

In a reactor equipped with a stirrer and a reflux condenser, 120 parts of methyl ethyl ketone, 100 parts of acryloyloxypropyltrimethoxysilane (KBM-5103, produced by Shin-Etsu Chemical Co., Ltd.) and 3 parts of diusopropoxyaluminum ethylacetate were added and mixed. Furthermore, 30 parts of ion exchanged water was added thereto, and the resulting mixture was reacted at 60° C. for 4 hours and then cooled to room temperature to obtain Organosilane Compound A Solution. The mass average molecular weight was 1,600, and a component having a molecular weight of 1,000 to 20,000 was occupying 100% in the oligomer or greater components. Also, the analysis by gas chromatography revealed that the raw material acryloyloxypropyltrimethoxysilane was not remaining at all.

(Preparation of Alumina Liquid Dispersion AL-1)

30.0 Parts by mass of a commercially available alumina, AKP-G015 (produced by Sumitomo Chemical Co., Ltd.) and 6.0 parts by mass of Aronix M5300 (produced by Toagosei Chemical Industry Co., Ltd.) were added to 64.0 parts by mass of methyl isobutyl ketone and well kneaded to obtain a slurry, and the slurry was dispersed in a sand grinder for 12 hours by using zirconia beads of 1 mmφ to prepare.Liquid Dispersion AL-1 having an alumina concentration of 30%. The average particle diameter of this alumina dispersion was 0.10 μm.

(Preparation of Resin Particles J-1)

A reaction vessel having a stirrer and a reflux condenser was charged with 600 parts by mass of water and 0.7 part by mass of polyvinyl alcohol and 2.7 parts by mass of sodium dodecylbenzenesulfonate were dissolved therein. Then, a mixed solution containing 96.0 parts by mass of methyl methacrylate, 8.0 parts by mass of ethylene glycol dimethacrylate and 2.0 parts by mass of benzoyl peroxide was added therein under stirring. The mixed solution was homogenized by 15 minutes of dispersion by a homogenizer operated at a rotating speed of 6,000 rpm. Then, the stirring of the solution was continued for four hours at 75° C., while nitrogen gas was blown thereinto. Then, the product was lightly dewatered by centrifuigal separation, and was washed with water and dried. There were obtained crosslinked methyl methacrylate resin particles (J-1) having an average particle diameter of 4.1 μm and a refractive index of 1.50.

(Preparation of Resin Particles J-2 to J-4)

Resin particles having different degrees of crosslinking were prepared by changing a kind or amount (parts by mass) of the principal monomer for the binder, and a kind or amount (parts by mass) of the crosslinking monomer had been employed on preparing resin particles J-1.

The monomers, the amounts thereof and the properties of the particles which were prepared are shown in Table 1.

TABLE 1

| | J-1 | J-2 | J-3 | J-4 |
|---|---|---|---|---|
| Methyl methacrylate | 96 | 75 | 30 | 63 |
| Divinylbenzene | — | | 90 | |
| Ethylene glycol dimethacrylate | 8 | 50 | | |
| Pentaerythritol tetracrylate | — | | | 150 |
| Average particle diameter (μm) | 1.6 | 1.7 | 1.7 | 1.6 |
| Compressive strength (N/mm²) | 31 | 37 | 46 | 55 |
| Crosslinking monomer content | 8 | 40 | 75 | 70 |
| (mass %) | | | | |

In Table 1, each value of compressive strength is a value (N/mm²) in which the value obtained as an S10 strength in accordance with the formula shown before from a testing force for a displacement of 10% as applied to an individual particle by using a Micro Compression Testing Machine, MCT-W201, of Shimadzu Corporation at 25° C. and a relative humidity of 65% with a testing indenter FLAT20, a test load of 19.6 mN (2 gf), a loading rate of 0.7105 mN/sec. and a displacement fill scale of 5 μm, is further multiplied by 9.8.

(Preparation of Resin Particles F-1 and F-2)

Resin particles F-1 having a flat shape were prepared by repeating Synthesis 1 of irregularly shaped particles (with a monomer to seed weight ratio of 4.0) in [Example 1] of JP-A-2000-38455. The particles had an average maximum diameter (DI) of 3.0 μm, an average thickness (T₁) of 1.3 μm and a T₁/D₁ ratio of 0.43.

Resin particles F-2 having a flat shape were prepared by repeating Synthesis 2 of resin particles (with a monomer to seed weight ratio of 4.0) in [Example 2] of the same prior art literature. The particles had an average maximum diameter (D1) of 2.6 μm, an average thickness (T1) of 1.6 sum and a T1/D1 ratio of 0.62.

(Preparation of Coating Solution A for Antistatic Layer)

A commercially available transparent coating material for antistatic layer, “PELTRON C-4456S-7” (produced by Nippon Pelnox Corporation, containing ATO, solid content concentration: 45%) was used as Coating Solution A for Antistatic Layer. The average particle diameter of the ATO fine particle was 0.15 μm. The refractive index of the coating film formed from this coating solution was 1.60.

(Preparation of Coating Solution B for Antistatic Layer)

6.0 Parts by mass of Dispersant (B-1) having an anionic group and a methacryloyl group and 7 parts by mass of methyl isobutyl ketone were added to 20 parts by mass of a commercially available electrically conducting fine particle ATO (antimony-doped tin oxide T-1, produced by Mitsubishi Materials Corp., specific surface area: 80 m²/g), followed by stirring.

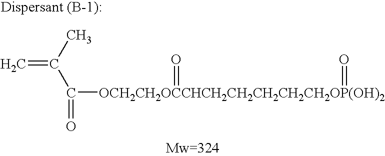

The ATO particle in the solution above was dispersed with use of a media dispersing machine (using zirconia beads having a diameter of 0.1 mm). The average particle diameter of the ATO fine particle was 0.09 μm.

Subsequently, 6 parts by mass of a mixture of dipentaerythritol pentaacrylate and dipentaerythritol hexaacrylate (DPHA, produced by Nippon Kayaku Co., Ltd.) and 0.8 parts by mass of a polymerization initiator (Irgacure 907,. produced by Ciba Specialty Chemicals) were added to 100 parts by mass of the ATO liquid dispersion obtained above, followed by stirring. In this way, Coating Solution B for Antistatic Layer was prepared. The refractive index of the coating film formed from this coating solution was 1.63.

(Preparation of Coating Solution (I) for Light-Diffusing Layer)

50 Parts by mass of a commercially available ultraviolet-curable resin (PETA, produced by Nippon Kayaku Co., Ltd., refractive index: 1.52), 2.5 parts by mass of a photopolymerization initiator (Irgacure 184, trade name, produced by Ciba Specialty Chemicals), 2 parts by mass of a crosslinked acryl-styrene particle having an average particle diameter of 3.5 μm (produced by Soken Kagaku K.K., refractive index: 1.55) as the first light-transparent particle, 3 parts of a crosslinked polystyrene particle having an average particle size of 3.5 μm (produced by Soken Kagaku K.K., refractive index: 1.60) as the second light-transparent particle, 6.19 parts by mass of an organosilane compound (KBM-5103, produced by Shin-Etsu Chemical Co., Ltd.) and 0.05 parts by mass of the above-described fluorine-based surface improving agent FP-149 were added were well mixed with 50 parts by mass of a solvent (toluene) and 6.6 parts by mass of cyclohexanone, and the resulting mixed solution was filtered through a polypropylene-made filter having a pore size of 30 μm to prepare Coating Solution (I) for Light-Diffusing Layer. The refractive index of the coating film formed from this coating solution was 1.52.

Incidentally, in Coating Solution (I) for Light-Diffusing Layer, the surface tension of the coating material was 25 mnN/m.

(Preparation of Coating Solution (II) for Light-Diffusing Layer)

25.6 Parts by mass of a mixture of dipentaerythritol pentaacrylate and dipentaerythritol hexaacrylate (DPHA, produced by Nippon Kayaku Co., Ltd.) was diluted with 46.3 parts by mass of methyl isobutyl ketone. Furthermore, 1.3 parts by mass of a polymerization initiator (Irgacure 184, produced by Ciba Specialty Chemicals) was added and mixed, followed by stirring. Subsequently, 0.04 parts by mass of the fluorine-based surface modifier FP-149, 5.2 parts by mass of a silane coupling agent (KBM-5103, produced by Shin-Etsu Chemical Co., Ltd.) and 0.50 parts by mass of a cellulose acetate butyrate (CAB-531-1, produced by Eastman Chemical) were added thereto, and the solute was completely dissolved by the stirring in an air disper for 120 minutes. The refractive index of the coating film obtained by coating this solution and UV-curing it was 1.520.

Finally, 21.0 parts by mass of a 30% methyl isobutyl ketone liquid dispersion of a crosslinked poly(acryl-styrene) particle (copolymerization compositional ratio=50/50, refractive index: 1.536) having an average particle diameter 3.5 μm, prepared by the dispersion in a polytron dispersing machine at 10,000 rpm for 20 minutes, was added to the solution obtained above, followed by stirring in an air disper for 10 minutes.

The resulting mixed solution was filtered through a polypropylene-made filter having a pore size of 30 μm to prepare Coating Solution (II) for Light-Diff-using Layer.

(Preparation of Coating Solution (III) for Light-Diffusing Layer)

85.0 Parts by mass of a mixture of dipentaerythritol pentaacrylate and dipentaerythritol hexaacrylate (DPHA, produced by Nippon Kayaku Co., Ltd.), 28.0 parts by mass of an organosilane compound (KBM-5103, produced by Shin-Etsu Chemical Co., Ltd.), 60.0 parts by mass of methyl isobutyl ketone and 17.0 parts by mass of methyl ethyl ketone were added to 285.0 parts by mass of a transparent high refractive index hard coat material containing a zirconium oxide fine particle (DESOLITE Z7404, produced by JSR Corp.), followed by stirring. The refractive index of the coating film obtained by coating this solution and UV-curing it was 1.61. Also, the average particle diameter of the zirconium oxide fine particle as a dispersion was measured and found to be 0.07 μm.

Furthermore, 35.0 parts by mass of a 30% methyl isobutyl ketone liquid dispersion of a crosslinked PMMA particle (MXS-300, produced by Soken Kagaku K.K., refractive index: 1.49), prepared by the dispersion in a polytron dispersing machine at 10,000 rpm and strongly classified to an average particle diameter of 3.0 μm, and 90.0 parts by mass of a 30% methyl ethyl ketone liquid dispersion of a silica particle having an average particle diameter of 1.5 μm (SEAHOSTA KE-P150, produced by Nippon Shokubai Co., Ltd., refractive index: 1.46), prepared by the dispersion in a polytron dispersing machine at 10,000 rpm, were added to the solution prepared above, followed by stirring.

The resulting solution was filtered through a polypropylene-made filter having a pore size of 30 μm to prepare Coating Solution (III) for Light-Diffusing Layer. The refractive index of the coating film formed from this coating solution was 1.61.

Incidentally, the surface tension of Coating Solution (In) for Light-Diffusing Layer was 27 mN/m.

(Preparation of Coating Solution (IV) for Light-Diffusing Layer)

Coating Solution (IV) for Light-Diffusing Layer was prepared in the same manner as Coating Solution (I) for Light-Diffusing Layer except that in Coating Solution (I) for Light-Diffusing Layer, the ultraviolet-curable resin (PETA, produced by Nippon Kayaku Co., Ltd.) was decreased from 50 parts by mass to 30 parts by mass and 20 parts by mass of a caprolactone-added ultraviolet-curable resin (DPCA-20, produced by Nippon Kayaku Co., Ltd.) was added. The refractive index of the coating film formed from this coating solution was 1.51.

(Preparation of Coating Solution (V) for Light-Diffusing Layer)

Coating Solution (V) for Light-Diffusing Layer was prepared in the same manner as Coating Solution (II) for Light-Diffusing Layer except that in Coating Solution (II) for Light-Diffusing Layer, the mixture of dipentaerythritol pentaacrylate and dipentaerythritol hexaacrylate (DPHA, produced by Nippon Kayaku Co., Ltd.) was decreased from 25.6 parts by mass to 15.4 parts by mass and instead, 10.2 parts by mass of a caprolactone-added ultraviolet-curable resin (DPCA-30, produced by Nippon Kayaku Co., Ltd.) was added. The refractive index of the coating film formed from this coating solution was 1.51.

(Preparation of Coating Solution (VI) for Light-Diffusing Layer)

Coating Solution (VI) for Light-Diffusing Layer was prepared in the same.manner as Coating Solution (V) for Light-Diffusing Layer except that in Coating Solution (V) for Light-Diffusing Layer, the ultraviolet-curable resin DPCA-30 was replaced by the same parts by mass of EO-added ultraviolet-curable resin, BISCOTE 360 (produced by Osaka Yuki Kagaku). The refractive index of the coating film formed from this coating solution was 1.51.

(Preparation of Coating Solution (VII) for Light-Diffusing Layer)

Coating Solution (VII) for Light-Diffusing Layer was prepared in the same manner as Coating Solution (II) for Light-Diffusing Layer except that in Coating Solution (II) for Light-Diffusing Layer, the mixture of dipentaerythritol pentaacrylate and dipentaerythritol hexaacrylate (DPHA, produced by Nippon Kayaku Co., Ltd.) was decreased from 25.6 parts by mass to 13.6 parts by mass, the methyl isobutyl ketone was decreased from 46.3 parts by mass to 8.3 parts by mass, and instead, 50.0 parts by mass of Alumina Liquid Dispersion AL-1 (alumina: 30 mass %) was added. The refractive index of the coating film formed from this coating solution was 1.64.

(Preparation of Coating Solution (VIII) for Light-Diffusing Layer)

Coating Solution (VIII) for Light-Diff-using Layer was prepared in the same manner as Coating Solution (II) for Light-Diff-using Layer except that in Coating Solution (II) for Light-Diffusing Layer, the mixture of dipentaerythritol pentaacrylate and dipentaerythritol hexaacrylate (DPHA, produced by Nippon Kayaku Co., Ltd.) was decreased from 25.6 parts by mass to 9.6 parts by mass, the methyl isobutyl ketone was decreased from 46.3 parts by mass to 12.3 parts by mass, and instead, 50.0 parts by mass of the above-described transparent coating material for antistatic layer, “PELTRON C-4456S-7” (produced by Nippon Pelnox Corporation, containing ATO, solid content concentration: 45%) was added. The refractive index of the coating film formed from this coating solution was 1.59.

(Preparation of Coating Solution (IX) for Light-Diffusing Layer)

Coating Solution (IX) for Light-Diffusing Layer was prepared in the same manner as Coating Solution (II) for Light-Diffusing Layer except that in Coating Solution (II) for Light-Diffusing Layer, the mixture of dipentaerythritol pentaacrylate and dipentaerythritol hexaacrylate (DPHA, produced by Nippon Kayaku Co., Ltd.) was decreased from 25.6 parts by mass to 13.6 parts by mass, the methyl isobutyl ketone was decreased from 46.3 parts by mass to zero, and instead, 75.0 parts by mass of a liquid dispersion containing 20% of ATO, which is an intermediate produced above in Preparation of Coating Solution B for Antistatic Layer (an ATO liquid dispersion containing the dispersant but before the addition of additives such as polyfunctional acrylate), was added. The refractive index of the coating film formed from this coating solution was 1.63.

(Preparation of a Coating Solution (X) for a Light Diffusing Layer)

A coating solution (X) for a light diffusing layer was prepared by repeating the method of preparing the coating solution (II) for a light diffusing layer as described above, but replacing the 30% methyl-isobutyl-ketone dispersion of crosslinked poly(acryl-styrene) particles having an average diameter of 3.5 μm (and a copolymerization ratio of 50/50 and a refractive index of 1.536) with an equivalent amount of an equally concentrated dispersion of resin particles J-1.

(Preparation of a Coating Solution (XI) for a Light Diffusing Layer)

A coating solution (XI) for a light diffusing layer was prepared by repeating the method of preparing the coating solution (X) for a light diffusing layer as described above, but replacing resin particles J-1 with resin particles J-2.

(Preparation of a Coating Solution (XII) for a Light Diffusing Layer)

A coating solution (XII) for a light diff-using layer was prepared by repeating the method of preparing the coating solution (X) for a light diffusing layer as described above, but replacing resin particles J-1 with resin particles J-3.

(Preparation of a Coating Solution (XIII) for a Light Diffusing Layer)

A coating solution (XIII) for a light diffusing layer was prepared by repeating the method of preparing the coating solution (X) for a light diffusing layer as described above, but replacing resin particles J-1 with resin particles J-4.

(Preparation of a Coating Solution (XIV) for a Light Diffusing Layer)

A coating solution (XIV) for a light diffusing layer was prepared by repeating the method of preparing the coating solution (X) for a light diffusing layer as described above, but replacing resin particles J-1 with resin particles F-1.

(Preparation of a Coating Solution (XV) for a Light Diffusing Layer)

A coating solution (XV) for a light diffusing layer was prepared by repeating the method of preparing the coating solution (X) for a light diffusing layer as described above, but replacing resin particles J-1 with resin particles F-2.

(Preparation of Coating Material (a) for Low Refractive Index Layer)

1.3 Parts by mass of an MEK liquid dispersion of silica fine particle (MEK-ST-L, produced by Nissan Chemicals Industries, Ltd., average particle diameter: 45 nm, solid content concentration: 30%) differing in the particle diameter from MEK-ST, 0.6 parts by mass of Organosilane Compound A Solution, 5.0 parts by mass of methyl ethyl ketone and 0.6 parts by mass of cyclohexanone were added to 13.0 parts by mass of a thermal crosslinking fluorine-containing polymer having a refractive index of 1.42 and containing polysiloxane and a hydroxyl group (JN7228A, produced by JSR Corp., solid content concentration: 6%), followed by stirring. The resulting solution was filtered through a polypropylene-made filter having a pore size of 1 μm to prepare Coating Material (a) for Low Refractive Index Layer. The refractive index of the coating film formed from this coating material was 1.42, and the contact angle with water was 96°.

(Preparation of Coating Material (b) for Low Refractive Index Layer)

0.6 Parts by mass of an MEK liquid dispersion of silica fine particle (MEK-ST, produced by Nissan Chemicals Industries, Ltd., average particle diameter: 15 nm, solid content concentration: 30%), 0.8 parts by mass of an MEK liquid dispersion of silica fine particle (MEK-ST-L, produced by Nissan Chemicals Industries, Ltd., average particle diameter: 45 nm, solid content concentration: 30%), 0.4 parts by mass of Organosilane Compound A Solution, 3.0 parts by mass of methyl ethyl ketone and 0.6 parts by mass of cyclohexanone were added to 15.0 parts by mass of the above-described fluorine-containing polymer (JN7228A, produced by JSR Corp., solid content concentration: 6%), followed by stirring. The resulting solution was filtered through a polypropylene-made filter having a pore size of 1 μm to prepare Coating Material (b) for Low Refractive Index Layer. The refractive index of the coating film formed from this coating material was 1.42.

(Preparation of Coating Material (c) for Low Refractive Index Layer)

1.95 Parts by mass of an MEK liquid dispersion of hollow silica fine particle (refractive index: 1.31, average particle diameter: 60nm, solid content concentration: 20%), 0.6 parts by mass of Organosilane Compound A Solution, 4.35 parts by mass of methyl ethyl ketone and 0.6 parts by mass of cyclohexanone were added to 13.0 parts by mass of the above-described fluorine-containing polymer (JN7228A, produced by JSR Corp., solid content concentration: 6%), followed by stirring. The resulting solution was filtered through a polypropylene-made filter having a pore size of 1 μm to prepare Coating Material (c) for Low Refractive Index Layer. The refractive index of the coating film formed from this coating material was 1.40.

(Preparation of Coating Material (d) for Low Refractive Index Layer)

Tetramethoxysilane (1 mol) and 2 mol of 0.1N hydrochloric acid were added to a mixed solvent of isopropyl alcohoumethyl ethyl ketone (1/1 by mass), and the resulting solution was stirred at room temperature for 2 hours, thereby effecting a hydrolysis reaction, to prepare a tetramethoxysilane hydrolysate solution.

Subsequently, 9.0 parts by mass of the tetramethoxysilane hydrolysate, 1.0 parts by mass of pentaerythritol triacrylate and 0.5 parts by mass of a polymerization initiator (Irgacure 907, produced by Ciba Specialty Chemicals) were added to isopropyl alcohol/methyl ethyl ketone (1/1 by mass) to give a solid content concentration of 4.5 mass %, followed by stirring. The resulting solution was filtered through a polypropylene-made filter having a pore size of 1 μm to prepare Coating Material (d) for Low Refractive Index Layer. The refractive index of the coating film formed from this coating material was 1.45.

(Preparation of Coating Material (e) for Low Refractive Index Layer)

0.15 Parts by mass of a polysiloxane compound having an acryloyl group (X-22-164C, produced by Shin-Etsu Chemical Co., Ltd.), 0.23 parts by mass of a photo-polymerization initiator (Irgacure 907, produced by Ciba Specialty Chemicals), 81.8 parts by mass of methyl ethyl ketone and 2.8 parts by mass of cyclohexanone were added to 15.0 parts by mass of a solution of Perfluoroolefin Copolymer (1) (solid content concentration: 30%), followed by stirring. The resulting solution was filtered through a polypropylene-made filter having a pore size of 1 pm to prepare Coating Material (e) for Low Refractive Index Layer. The refractive index of the coating film formed from this coating material was 1.43.

(Preparation of Coating Material (f) for Low Refractive Index Layer)

4.5 Parts by mass of an MEK liquid dispersion of silica fine particle (MEK-ST-L, produced by Nissan Chemicals Industries, Ltd., average particle diameter: 45 nm, solid content concentration: 30%), 0.15 parts by mass of a polysiloxane compound having an acryloyl group (X-22-164C, produced by Shin-Etsu Chemical Co., Ltd.), 0.23 parts by mass of a photopolymerization initiator (Irgacure 907, produced by Ciba Specialty Chemicals), 2.0 parts by mass of Organosilane Compound A Solution, 81.2 parts by mass of methyl ethyl ketone and 2.8 parts by mass of cyclohexanone were added to 10.5 parts by mass of a solution of Perfluoroolefin Copolymer (1) (solid content concentration: 30%), followed by stirring. The resulting solution was filtered through a polypropylene-made filter having a pore size of 1 μm to prepare Coating Material (f) for Low Refractive Index Layer. The refractive index of the coating film formed from this coating material was 1.44.

(Preparation of Coating Material (g) for Low Refractive Index Layer)

6.75 Parts by mass of an MEK liquid dispersion of hollow silica fine particle (refractive index: 1.31, average particle diameter: 60 nm, solid content concentration: 20%), 0.15 parts by mass of a polysiloxane compound having an acryloyl group (X-22-164C, produced by Shin-Etsu Chemical Co., Ltd.), 0.23 parts by mass of a photopolymerization initiator (Irgacure 907, produced by Ciba Specialty Chemicals), 2.0 parts by mass of Organosilane Compound A Solution, 81.2 parts by mass of methyl ethyl ketone and 2.8 parts by mass of cyclohexanone were added to 10.5 parts by mass of a solution of Perfluoroolefin Copolymer (1) (solid content concentration: 30%), followed by stirring. The resulting solution was filtered through a polypropylene-made filter having a pore size of 1 Am to prepare Coating Material (g) for Low Refractive Index Layer. The refractive index of the coating film formed from this coating material was 1.41.

(Preparation of Coating Material (h) for Low Refractive Index Layer)

0.45 Parts by mass of a mixture of dipentaerythritol pentaacrylate and dipentaerythritol hexaacrylate (DPHA, produced by Nippon Kayaku Co., Ltd.), 0.15 parts by mass of a polysiloxane compound having an acryloyl group (X-22-164C, produced by Shin-Etsu Chemical Co., Ltd.), 0.23 parts by mass of a photopolymerization initiator (Irgacure 907, produced by Ciba Specialty Chemicals), 81.2 parts by mass of methyl ethyl ketone and 2.8 parts by mass of cyclohexanone were added to 13.5 parts by mass of a solution of Perfluoroolefin Copolymer (1) (solid content concentration: 30%), followed by stirring. The resulting solution was filtered through a polypropylene-made filter having a pore size of 1 [m to prepare Coating Material (h) for Low Refractive Index Layer. The refractive index of the coating film formed from this coating material was 1.44.

(Preparation of a Coating Material (i) for a Low Refractive Index Layer)

A coating material was prepared by adding 0.15 part by mass of a reactive polysiloxane compound (X-22-160AS of Shin-Etsu Chemical Co., Ltd.) to 100 parts by mass of a solution of the coating material (a) prepared as described above and stirring them together. A coating film formed from this coating material had a refractive index of 1.42 and a contact angle of 105° with water.

(Preparation of a Coating Material (j) for a Low Refractive Index Layer)

A coating material was prepared by adding 0.15 part by mass of a reactive polysiloxane compound (X-22-170DX of Shin-Etsu Chemical Co., Ltd.) to 100 parts by mass of a solution of the coating material (a) prepared as described above and stirring them together. A coating film formed from this coating material had a refractive index of 1.42 and a contact angle of 103° with water.

(Preparation of Optical Functional Film Samples 101 to 137: Forming of respective Coating Layers, Saponification Treatment)

(1) Coating of Antistatic Layer

A cellulose triacylate film in the roll form having a film thickness shown in Table 2 was unrolled, and Coating Solution A for Antistatic Layer was coated thereon by the die coating method using an apparatus having a constitution described below under the following conditions and dried at 30° C. for 1.5 seconds and at 90° C. for 20 seconds. The coating layer obtained was then cured under irradiation of ultraviolet rays at an irradiation dose of 90 mJ/cm² by using an air-cooled metal halide lamp of 160 W/cm (manufactured by I-Graphics K.K.) in nitrogen purging to form an antistatic layer having a coating thickness shown in Table 2. The resulting film was taken up.

Basic Conditions:

In the slot die 13 used, the upstream lip land length I_{UP} was 0.5 mm, the downstream lip land length I_{LO} was 50 μm, the opening length of the slot 16 in the web running direction was 150 μm, and the length of the slot 16 was 50 mm. The gap between the upstream lip land 18a and the web W was made 50 μm longer than the gap between the downstream lip land 18b and the web W (hereinafter referred to as an “overbite length of 50 μm”), and the gap G_{L} between the downstream lip land 18b and the web W was set to 50 μm. Also, the gap G_{S} between the side plate 40b of the low-pressure chamber 40 and the web W and the gap G_{B} between the back plate 40a and the web W both were set to 200 μm. The coating speed was 40 m/min, and the amount of the coating solution was adjusted according to the liquid physical properties of each coating solution and the desired coating thickness. Incidentally, the coating width was 1,300 mm and the effective width was 1,280 mm.

(2) Coating of Light-Diffusing Layer

The sample having provided thereon an antistatic layer prepared above or a cellulose acylate film in a roll form having a thickness which is variously changed, was unrolled, and a light-diffusing layer was formed thereon to have a coating thickness shown in Table 2 under the same drying and ultraviolet irradiation conditions as in Coating of Antistatic Layer. The resulting film was taken up.

(3) Coating of Low Refractive Index Layer

The cellulose acylate film in a roll form after coating the coating solution for light-diffusing layer was unrolled, and the coating solution for low refractive index layer prepared above was coated under the above-described basic conditions and then dried at 120° C. for 150 seconds further at 140° C. for 8 minutes. Thereafter, ultraviolet rays at an irradiation dose of 300 mJ/cm² were irradiated thereon by using an air-cooled metal halide lamp of 240 W/cm (manufactured by I-Graphics K.K.) in an atmosphere adjusted to an oxygen concentration of 0.1% by nitrogen purging, to form a low refractive index layer having a thickness of 100 nm. The resulting film was taken up. Incidentally, Coating Solution d for Low Refractive Index Layer was further dried at 140° C. for 20 minutes after drying at 120° C. for 150 seconds.

(4) Saponification Treatment of Antireflection Film

After the film formation of the low refractive index layer, the sample was subjected to the following treatment.

An aqueous 1.5 mouliter sodium hydroxide solution was prepared and kept at 55° C. Separately, an aqueous 0.01 mol/liter dilute sulfuric acid solution was prepared and kept at 35° C. The produced antireflection film was dipped in the aqueous sodium hydroxide solution for 2 minutes and then dipped in water to thoroughly wash out the aqueous sodium hydroxide solution. Subsequently, the film was dipped in the aqueous dilute sulfuric acid solution for 1 minute and then dipped in water to thoroughly wash out the aqueous dilute sulfuric acid solution. Finally, the sample was thoroughly dried at 120° C. Incidentally, as for the sample where Coating Solution d for Low Refractive Index Layer was coated, the saponification treatment was applied only to the surface opposite the side coated with the coating solution.

In this way, a saponified optical functional film samples 101 to 137 were produced.

The combination of layers stacked by coating, the thickness of the support, and the thickness of each layer coated are shown in Table 2. As for the order of coating, the layers (e.g., antistatic layer) from left to right in Table 2 were stacked by coating in this order with respect to the support.

TABLE 2

| | Thickness | Antistatic | | Light-Diffusing | | Low Refractive | |
|---|---|---|---|---|---|---|---|
| | of | Layer | | Layer | | Index Layer | |
| | Support | Coating | Thickness | Coating | Thickness | Coating | Thickness |
| Sample No. | (μm) | Solution | (μm) | Solution | (μm) | Solution | (μm) |
| 101 Invention | 40 | A | 1.1 | I | 3.7 | a | 0.09 |
| 102 Invention | 40 | B | 1.1 | I | 3.7 | a | 0.09 |
| 103 Invention | 40 | B | 1.1 | II | 3.7 | a | 0.09 |
| 104 Invention | 40 | B | 1.1 | VII | 3.7 | a | 0.09 |
| 105 Invention | 40 | none | none | I | 4.6 | a | 0.09 |
| 106 Invention | 40 | none | none | II | 4.6 | a | 0.09 |
| 107 Invention | 40 | none | none | III | 4.6 | a | 0.09 |
| 108 Invention | 40 | none | none | IV | 4.6 | a | 0.09 |
| 109 Invention | 40 | none | none | V | 4.6 | a | 0.09 |
| 110 Invention | 40 | none | none | VI | 4.6 | a | 0.09 |
| 111 Invention | 40 | none | none | VII | 4.6 | a | 0.09 |
| 112 Invention | 40 | none | none | VIII | 4.6 | a | 0.09 |
| 113 Invention | 40 | none | none | IX | 4.6 | a | 0.09 |
| 114 Invention | 40 | none | none | II | 4.6 | b | 0.09 |
| 115 Invention | 40 | none | none | II | 4.6 | c | 0.09 |
| 116 Invention | 40 | none | none | II | 4.6 | d | 0.09 |
| 117 Invention | 40 | none | none | II | 4.6 | e | 0.09 |
| 118 Invention | 40 | none | none | II | 4.6 | f | 0.09 |
| 119 Invention | 40 | none | none | II | 4.6 | g | 0.09 |
| 120 Invention | 40 | none | none | II | 4.6 | h | 0.09 |
| 121 Invention | 40 | none | none | I | 4.6 | b | 0.09 |
| 122 Invention | 40 | none | none | I | 4.6 | c | 0.09 |
| 123 Invention | 40 | none | none | I | 4.6 | g | 0.09 |
| 124 Invention | 30 | none | none | II | 4.6 | a | 0.09 |
| 125 Invention | 20 | none | none | II | 4.6 | a | 0.09 |
| 126 Invention | 40 | none | none | II | 3.9 | a | 0.09 |
| 127 Invention | 40 | none | none | II | 3.2 | a | 0.09 |
| 128 Invention | 60 | none | none | II | 4.6 | a | 0.09 |
| 129 Invention | 70 | none | none | II | 4.6 | a | 0.09 |
| 130 Comparative | 80 | none | none | II | 4.6 | a | 0.09 |
| Example | | | | | | | |
| 131 Comparative | 40 | none | none | II | 5.5 | a | 0.09 |
| Example | | | | | | | |
| 132 Comparative | 40 | none | none | II | 6.4 | a | 0.09 |
| Example | | | | | | | |
| 133 Comparative | 80 | none | none | II | 6.4 | a | 0.09 |
| Example | | | | | | | |
| 134 Comparative | 40 | none | none | II | 8.0 | a | 0.09 |
| Example | | | | | | | |
| 135 Comparative | 40 | B | 1.1 | II | 4.6 | a | 0.09 |
| Example | | | | | | | |
| 136 Comparative | 80 | none | none | IX | 6.4 | a | 0.09 |
| Example | | | | | | | |
| 137 Comparative | 90 | none | none | II | 6.4 | a | 0.09 |
| Example | | | | | | | |

(Evaluation of Optical Function Film)

The obtained film was evaluated on the following items. The results are shown in Table 4.

(1) Average Reflectance

The back surface of the film was roughened with sand paper and then treated with black ink to eliminate the back surface reflection and in this state, the spectral specular reflectance on the front surface side was measured at an incident angle of 5° in the wavelength region of 380 to 780 nm by using a spectrophotometer (manufactured by JASCO Corporation). The result is shown by the arithmetic mean value of specular reflectances at 450 to 650 nm.

(2) Haze Value

The haze value of the film sample was measured according to JIS-K7136.

(3) Antiglare Property

A bare fluorescent lamp (8,000 cd/m²) without louver was projected on the functional layer-coated side of the film sample from an angle of 45°, and the degree of blurring of the reflected image observed from the direction of −45° was evaluated according to the following criteria.
⊚: The contour of the fluorescent lamp was not recognized at all.
◯: The contour of the fluorescent lamp was slightly recognized.
Δ: The periphery of the fluorescent lamp was blurred in white, but the contour could be recognized.
ΔX: The periphery of the fluorescent lamp was very slightly blurred in white.
X: The periphery of the fluorescent lamp was not blurred at all, and the contour was clearly recognized.
   (4) Pencil Hardness

As the index for scratch resistance, the evaluation of pensile hardness described in JIS K 5400 was performed. The film sample after coating layers was subjected to moisture conditioning at a temperature of 25° C. and a humidity of 60% RH for 2 hours, and a scratch test of the coated layer was performed under a load of 0.5 kg by using a 3H pencil for test prescribed in JIS S 6006. The hardness was evaluated according to the following criteria.
◯: Scratches were not observed at all in the evaluation of n=5.
◯-Δ: One scratch in the evaluation of n=5.
Δ: Two scratches in the evaluation of n=5.
X: Three or more scratches in the evaluation of n=5.
   (5) Curl Value

The sample was cut into a size of 30 cm in the coating roll transporting direction and 20 cm in the coating width direction and left standing on a horizontal work table in an environment of 25° C. and 20% RH for 24 hours by facing up the side having the optical functional layer. Thereafter, the distance by which the sample was lifted from the horizontal work table was measured at four corners by means of a ruler, and the average thereof was determined.

(6) Surface Resistivity

The sample was left standing for 1 hour under the conditions of (25° C./60% RH), and the surface resistivity on the side having the low refractive index layer was measured under the same conditions by using a superinsulating resistance/microammeter, TR8601 (manufactured by Advantest Corp.).

The evaluation results are shown in Table 3.

TABLE 3

| | Spec- | | | | | |
|---|---|---|---|---|---|---|
| | ular | | | Pen- | | |
| | Reflec- | | | cil | | Surface |
| | tance | Haze | Antiglare | Hard- | Curl | Resistivity |
| Sample No. | (%) | (%) | Property | ness | (cm) | (Ω/square) |
| 101 Invention | 2.0 | 44 | ◯ | ◯-Δ | 2.3 | 4.4 × 10⁸ |
| 102 Invention | 2.0 | 45 | ◯ | ◯-Δ | 2.3 | 3.1 × 10⁸ |
| 103 Invention | 2.1 | 27 | ◯ | ◯-Δ | 2.4 | 4.3 × 10⁸ |
| 104 Invention | 1.9 | 25 | ◯ | ◯ | 1.3 | 5.0 × 10⁸ |
| 105 Invention | 1.9 | 44 | ◯ | Δ | 2.3 | 2.3 × 10¹⁴ |
| 106 Invention | 1.9 | 26 | ◯ | Δ | 2.4 | 6.3 × 10¹⁴ |
| 107 Invention | 1.9 | 50 | ΔX | ◯ | 1.5 | 3.5 × 10¹⁴ |
| 108 Invention | 1.9 | 45 | ◯ | Δ | 1.6 | 6.7 × 10¹⁴ |
| 109 Invention | 1.9 | 25 | ◯ | Δ | 1.6 | 4.2 × 10¹⁴ |
| 110 Invention | 1.9 | 26 | ◯ | Δ | 1.5 | 2.8 × 10¹⁴ |
| 111 Invention | 1.9 | 25 | ◯ | ◯ | 1.5 | 1.7 × 10¹⁴ |
| 112 Invention | 1.9 | 25 | ◯ | ◯ | 1.4 | 2.5 × 10⁹ |
| 113 Invention | 1.9 | 25 | ◯ | ◯ | 1.4 | 1.3 × 10⁹ |
| 114 Invention | 2.0 | 26 | ◯ | Δ | 2.3 | 3.3 × 10¹⁴ |
| 115 Invention | 2.0 | 26 | ◯ | Δ | 2.4 | 2.2 × 10¹⁴ |
| 116 Invention | 2.0 | 25 | ◯ | Δ | 2.3 | 2.6 × 10¹⁴ |
| 117 Invention | 2.0 | 26 | ◯ | Δ | 2.4 | 3.7 × 10¹⁴ |
| 118 Invention | 2.0 | 25 | ◯ | Δ | 2.2 | 4.2 × 10¹⁴ |
| 119 Invention | 2.0 | 26 | ◯ | Δ | 2.3 | 5.5 × 10¹⁴ |
| 120 Invention | 2.0 | 26 | ◯ | Δ | 2.4 | 2.8 × 10¹⁴ |
| 121 Invention | 1.9 | 44 | ◯ | Δ | 2.3 | 6.7 × 10¹⁴ |
| 122 Invention | 1.9 | 45 | ◯ | Δ | 2.2 | 2.2 × 10¹⁴ |
| 123 Invention | 1.9 | 44 | ◯ | Δ | 2.4 | 4.2 × 10¹⁴ |
| 124 Invention | 2.0 | 26 | ◯ | Δ | 2.8 | 7.2 × 10¹⁴ |
| 125 Invention | 2.0 | 26 | ◯ | Δ | 3.0 | 2.6 × 10¹⁴ |
| 126 Invention | 2.0 | 25 | ◯ | Δ | 1.5 | 2.0 × 10¹⁴ |
| 127 Invention | 2.0 | 26 | Δ | Δ | 1.2 | 4.2 × 10¹⁴ |
| 128 Invention | 2.0 | 24 | ◯ | Δ | 1.7 | 6.7 × 10¹⁴ |
| 129 Invention | 2.0 | 25 | ◯ | Δ | 1.6 | 3.3 × 10¹⁴ |
| 130 Comparative | 2.0 | 26 | ◯ | ◯-Δ | 1.5 | 2.8 × 10¹⁴ |
| Example | | | | | | |
| 131 Comparative | 2.0 | 26 | ◯ | Δ | 4.6 | 2.2 × 10¹⁴ |
| Example | | | | | | |
| 132 Comparative | 2.0 | 25 | ◯ | Δ | 6.8 | 4.2 × 10¹⁴ |
| Example | | | | | | |
| 133 Comparative | 2.0 | 25 | ◯ | ◯ | 2.0 | 2.4 × 10¹⁴ |
| Example | | | | | | |
| 134 Comparative | 2.0 | 26 | ◯ | Δ | 9.1 | 3.9 × 10¹⁴ |
| Example | | | | | | |
| 135 Comparative | 2.0 | 26 | ◯ | ◯-Δ | 4.4 | 3.1 × 10⁹ |
| Example | | | | | | |
| 136 Comparative | 2.0 | 26 | ◯ | ◯ | 1.9 | 4.3 × 10¹⁰ |
| Example | | | | | | |
| 137 Comparative | 2.0 | 26 | ◯ | ◯ | 2.0 | 4.5 × 10¹⁴ |
| Example | | | | | | |

As seen from Tables 2 and 3, in the thin support sample of 40 μm (No. 132), the curl is increased as compared with the conventional thick support sample (No. 133: 80 μm). As for the thin support, in samples (Nos. 101 to 129) of the present invention where the total thickness of coated layers is reduced to 5 μm or less, the curl becomes small and these are preferred. In samples (No. 107 and Nos. 111 to 113) where an inorganic fine particle is incorporated into the light-diffusing layer or in samples (Nos. 108 to 110) using a polyfunctional acrylate-based compound having added thereto alkylene oxides, the curl is more reduced and these are preferred. Moreover, in samples (Nos. 112 and 113) where the inorganic fine particle incorporated into the light-diffusing layer is an electrically conducting inorganic fine particle, the surface resistivity is also decreased and these are more preferred. Also, in samples (No. 107 and Nos. 111 to 113) where an inorganic fine particle is incorporated into the light-diffusing layer, the pencil hardness becomes high.

In comparative samples (Nos. 130, 133, 135 and 137) having a large support thickness, the curl value is small and the pencil hardness is high, but when thinning of various optical functional film supports is advanced in the future, the problems of high cost and insufficient thinning still remain due to the large thickness.

### Example 2

(Preparation of Hydrophobizing Agent-Containing Cellulose Acetate Film)

(Formation of a Cellulose Acetate Film 2a)

The materials as listed below were placed in a mixing tank and dissolved by stirring under heat to prepare a cellulose acetate solution B.

<Composition of Cellulose Acetate Solution B>

| | |
|---|---|
| Cellulose acetate having an acetylation degree of | 50 parts by mass |
| 61.2% | |
| Cellulose acetate having an acetylation degree of | 50 parts by mass |
| 60.6% | |
| Triphenyl phosphate (hydrophobizing agent 1) | 7.8 parts by mass |
| Biphenyl diphenyl phosphate (hydrophobizing agent 2) | 3.9 parts by mass |
| Methylene chloride (a first solvent) | 280 parts by mass |
| Methanol (a second solvent) | 54 parts by mass |
| 1-butanol | 11 parts by mass |

The materials as listed below were placed in another mixing tank and
dissolved by stirring under heat to prepare an additive solution C1.
<Composition of Additive Solution C1>

| | |
|---|---|
| Methylene Chloride | 80 parts by mass |
| Methanol | 20 parts by mass |
| Ultraviolet absorber (A) | 2 parts by mass |
| Ultraviolet absorber (B) | 4 parts by mass |

Ultraviolet absorber A

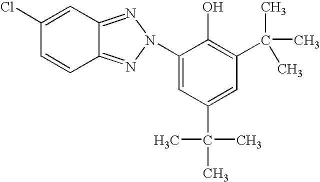

Ultraviolet absorber B

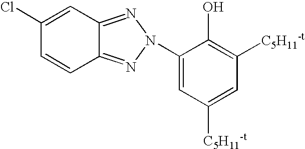

A dope was prepared by adding 40 parts by mass of additive solution C1 to 474 parts by mass of cellulose acetate solution B and stirring them thoroughly. The dope was cast onto a drum cooled to 0° C. through a casting port. A film formed thereon was peeled off when it had a solvent content of 70% by mass, and at both edges across its width, it was fixed by pin tenters (pin tenters as shown in FIG. 3 in JP-A-Hei-4-1009) and was dried at 115° C. until its solvent content was lowered to 5% by mass, while their spacing was so maintained as to keep a transverse stretch ratio of 4% (in the direction normal to the machine direction) (Drying Step 1). Then, it was conveyed through between rolls in a heat treating apparatus and thereby dried at 140° C. to give a cellulose acetate film 2a having a thickness of 80 μm.

(Formation of Cellulose Acetate Films 2b to 2j)

Cellulose acetate films 2b to 2j were each formed by employing the film thickness, the hydrophobizing agents and the amounts thereof as shown in Table 4 and otherwise repeating the method as described above for forming the cellulose acetate film 2a.

Hydrophobizing Agent (a)

TABLE 4

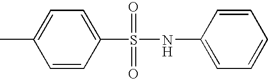

| | | | | | Mass | | Film |
|---|---|---|---|---|---|---|---|
| Film Sample | Hydrophobizin agent 1 | | Hydrophobizing agent 2 | | aveage | | thickness |
| No. | Kind | Amount* | Kind | Amount* | log P | Remarks | (μm) |
| Cellulose | Triphenyl | 7.8 | Biphenyldiphenyl | 3.9 | 5.0 | Comparative | 80 |
| acetate film 2a | phosphate | | phosphate | | | Example | |
| Cellulose | ″ | 7.8 | ″ | 3.9 | 5.0 | For | 70 |
| acetate film 2b | | | | | | Invention | |
| Cellulose | ″ | 7.8 | ″ | 3.9 | 5.0 | For | 40 |
| acetate film 2c | | | | | | Invention | |
| Cellulose | Hydrophobizing | 12 | — | — | 3.1 | Comparative | 80 |
| acetate film 2d | agent (a) | | | | | Example | |
| Cellulose | ″ | 12 | — | — | 3.1 | For | 70 |
| acetate film 2e | | | | | | Invention | |
| Cellulose | ″ | 12 | — | — | 3.1 | For | 40 |
| acetate film 2f | | | | | | Invention | |
| Cellulose | I-2 | 5.8 | C-7 | 5.9 | 6.3 | Comparative | 80 |
| acetate film 2g | | | | | | Example | |
| Cellulose | ″ | ″ | ″ | ″ | 6.3 | For | 40 |
| acetate film 2h | | | | | | Invention | |
| Cellulose | I-11 | 7.0 | C-10 | 4.7 | 7.1 | Comparative | 80 |
| acetate film 2i | | | | | | Example | |
| Cellulose | ″ | ″ | ″ | ″ | 7.1 | For | 40 |
| acetate film 2~ | | | | | | Invention | |

*Each amount is expressed by the percentage by mass of cellulose acetate.

(Determination of Water Content and Moisture Permeability of Cellulose Acetate Films)

Each of the cellulose acetate films 2a to 2j formed as described had its water content and moisture permeability determined by the methods as described below. The results are shown in Table 5.

(7) Determination of Water Content

After each film was left to stand in an environment having a temperature of 25° C. and a relative humidity of 80% for 24 hours, its equilibrium water content was determined by a Karl Fischer water content measuring apparatus, AQ-2000, of Hiranuma Sangyo Co., Ltd.

(8) Determination of Moisture Permeability

Each sample had its moisture permeability determined in accordance with the method as specified by JIS Z0208, but in an environment having a temperature of 25° C. and a relative humidity of 90%.

(Saponification Treatment)

Each of the cellulose acetate films 2a to 2j was dipped in a 1.5 N aqueous solution of sodium hydroxide and left to stand at 55° C. for two minutes. It was washed in a water washing tank at room temperature and neutralized with 0.1 N sulfuric acid at 30° C. It was washed in the water washing tank at room temperature again and dried by hot air having a temperature of 100C. Thus, cellulose acetate films 2a to 2j had its surface saponified. Moreover, a Fuji Film WV film was saponified under the same conditions to form a test specimen as stated below.

(Preparation of Polarizing Plates 1A to 1J)

A polarizer was made by having iodine adsorbed to a stretched polyvinyl alcohol film and the saponified cellulose acetate film 2a was bonded to one side of the polarizer with a polyvinyl alcohol-based adhesive. They were so arranged that the transmission axis of the polarizer and the slow axis of the cellulose acetate film might be parallel to each other.

The WV film saponified in Example 3 was bonded to the opposite side of the polarizer with a polyvinyl alcohol-based adhesive. Thus, a polarizing plate 1A was made.

Polarizing plates 1B to 1J were made by employing cellulose acetate films as shown in Table 5.

(9) Determination of Variation with Time of Polarization Degree of Polarizing Plate

Each of the polarizing plates made as described was bonded to a sheet of glass so that the WV film might face the glass, and its parallel and cross transmittances were determined by a Shimadzu UV2200 spectrophotometer and its polarization degree was calculated in accordance with formula below. Each polarizing plate had its parallel and cross transmittances determined again after it had been left to stand at 60° C. and a relative humidity of 95% for 1,000 hours, and its polarization degree was calculated and compared with its initial value. The results are shown in Table 5.

$$Polarization degree ( \% ) = 100 \times \sqrt{\frac{\begin{matrix}parallel transmittance - \\ cross transmittance\end{matrix}}{\begin{matrix}parallel transmittance + \\ cross transmittance\end{matrix}}}$$

It is obvious from the results shown in Table 5 that when the polarizing plates according to the present invention are compared with one another, the use (the polarizing plates 1H and 1J) of the cellulose acetate films comprising the preferred hydrophobizing agents according to the present invention makes it possible to produce polarizing plates having a higher level of durability, since the water content and the level of moisture permeability of the cellulose acetate films is small and as a result the cellulose acetate films have a small variation in the degree of polarization with humidity.

TABLE 5

| | | Water content | Moisture | | |
|---|---|---|---|---|---|
| | | at 25° C. and | permeability at 25° C. | Polarization degree | |
| Polarizing | Protective film on | 80% RH | and 90% RH | (initial - after | |
| plate | the air side | (mass %) | (g/m² · 24 h) | passage of time)(%) | Remarks |
| 1A | Cellulose acetate | 3.4 | — | −3.4 | Comparative |
| | film 2a | | | | Example |
| 1B | Cellulose acetate | 3.4 | 247 | −3.3 | Invention |
| | film 2b | | | | |
| 1C | Cellulose acetate | 3.4 | 235 | −3.2 | Invention |
| | film 2c | | | | |
| 1D | Cellulose acetate | 3.3 | — | −3.1 | Comparative |
| | film 2d | | | | Example |
| 1E | Cellulose acetate | 3.3 | 227 | −2.9 | Invention |
| | film 2e | | | | |
| 1F | Cellulose acetate | 3.3 | 222 | −2.8 | Invention |
| | film 2f | | | | |
| 1G | Cellulose acetate | 2.7 | — | −2.2 | Comparative |
| | film 2g | | | | Example |
| 1H | Cellulose acetate | 2.7 | 193 | −2.3 | Invention |
| | film 2h | | | | |
| 1I | Cellulose acetate | 2.3 | — | −0.6 | Comparative |
| | film 2i | | | | Example |
| 1J | Cellulose acetate | 2.3 | 141 | −0.6 | Invention |
| | film 2j | | | | |

* The values of moisture permeability were of film samples having a thickness of 40 μm.

(Preparation of Optical Functional Film Samples 201 to 217: Forming of Light-Diffusing Layer and Low Refractive Index Layer by Coating))

Optical Functional Film samples 201 to 210 were prepared by repeating Example 1 for applying the coating solution II for a light diffusing layer and the coating solution a for a low refractive index layer onto the cellulose acetate films 2a to 2j as prepared. The light diffusing layer formed on each sample had a thickness of 4.6 μm and the low refractive index layer had a thickness of 0.09 μm.

(Evaluation of Optical Functional Film Samples 201 to 210)

Each sample was examined for its moisture permeability at 25° C. and a relative humidity of 90%. The results are shown in Table 6.

TABLE 6

| | | | | Moisture | |
|---|---|---|---|---|---|
| | | Coating solution | Coating solution | permeability at 25° C. | |
| Sample | Cellulose | for light diffusing | for low refractive | and 90% RH | |
| No. | acetate film | layer | index layer | (g/m² · 24 h) | Remarks |
| 201 | 2a | II | a | — | Comparative |
| | | | | | Example |
| 202 | 2b | II | a | 233 | Invention |
| 203 | 2c | II | a | 229 | Invention |
| 204 | 2d | II | a | — | Comparative |
| | | | | | Example |
| 205 | 2e | II | a | 223 | Invention |
| 206 | 2f | II | a | 220 | Invention |
| 207 | 2g | II | a | — | Comparative |
| | | | | | Example |
| 208 | 2h | II | a | 188 | Invention |
| 209 | 2i | II | a | — | Comparative |
| | | | | | Example |
| 210 | 2j | II | a | 139 | Invention |

It is obvious from the results shown in Table 6, that the use of the cellulose acetate films (2h, 2j) including the preferred hydrophobizing agents according to the present invention makes it possible to achieve a lower level of moisture permeability when comparing the optical functional films according to the invention to each other.

Optical functional film samples 202, 203, 205, 206, 208 and 210 of the present invention were each examined for its mirror surface reflectance and curl value by repeating Example 1. The results confirmed that all of the samples 202, 203, 205, 206, 208 and 210 of the present invention were desirable in view of the optical and physical properties as required by the present invention, since their mirror surface reflectances were all in the range of 1.9 to 2.1%, while their curl values were all in the range of 1.5 to 2.3.

### Example

(Preparation of Optical Functional Film Samples 301 to 307: Forming of Light-Diffusing Layer and Low Refractive Index Layer by Coating)

Optical functional film samples 301 to 307 were each prepared in the same manner as in the same light-diffusing layer of Example 1, to form a light diffusing layer differing in thickness from Example 1, by coating one of the coating solutions (X) to (XV) as prepared above and the coating solution (II) for a light diffusing layer according to Example 1 on the cellulose acetate film having the thickness of 40 μm prepared in Example 1 and further coating thereon the coating material (a) for low refractive index layer prepared in Example 1 in the same manner as in Example 1 (film thickness: 0.09 cm). The thickness of the light diffusing layer on each sample is shown in Table 7.

(Evaluation of Optical Functional Film Samples 301 to 307)

The results of evaluation of Samples 301 to 307 are shown in Table 7. For the items other than the following in Table 7, reference is made to the description of Example 1.

(10) Black Production Clarity

Each test specimen was prepared by attaching a polarizing plate having a smooth surface to each of two principal surfaces of a sheet of glass having a thickness of 1 mm (Micro Slide Glass S 9111 of MATSUNAMI) with crossed nicols and bonding the opposite side of the optical functional film of the present invention from its anti-reflection layer to the polarizing plate on one side of the glass. Then, the intensity I₀ of incident light was first measured by a Goniophotometer of K.K. Murakami Shikizai Kenkyujo in the absence of any test specimen.

Then, light of intensity I₀ was caused to fall on the low refractive index layer of each test specimen at an incident angle of −60° to the normal, the intensity of reflected light was measured by every 0.1° between 40° and 50°, values were read of the intensity I⁴⁵° of light reflected at an angle of 45°, the intensity I⁵⁰° of light reflected at an angle of 50° and the intensity I⁴⁰° of light reflected at an angle of 40° and the value of −LOG₁₀ (I/I₀) at each such angle was calculated.

A larger value is desirable as indicating a higher level of black reproduction clarity as compared with the level which is visually estimated.

(11) Steel Wool Resistance

A steel wool rubbing test was conducted on the light diff-using layer of each test specimen by using a rubbing tester. The test was conducted by using steel wool Grade No. 0000 of Nippon Steel Wool Co., Ltd. as the rubbing material with a braking distance (one way) of 13 cm, a rubbing rate of 13 cm/sec., a load of 4.9 N/cm², a contact area of 1 cm square and a rubbing frequency of 10 reciprocal motions. The surface of the outermost layer was visually inspected for any damage and the results were classified in four grades, as follows:

OO: No damage was visible at all even by any careful inspection.

O: Slight damage was visible by careful inspection.

Δ: Some damage was visible.

x: Damage was markedly visible at a glance.

TABLE 7

| | | | Coating | | | | |
|---|---|---|---|---|---|---|---|
| | Light diffusing layer | | material for | Black | | | Steel |
| | Coating | Film thickness | low refractive | reproduction | Anti-glare | Pencil | wool |
| Sample No. | solution | (μm) | index layer | clarity | property | hardness | resistance |
| 301 Invention | X | 2.2 | a | 4.2 | ◯ | Δ | ◯ |
| 302 Invention | XI | 2.3 | a | 4.2 | ◯ | ◯-Δ | ◯◯ |
| 303 Invention | XII | 2.2 | a | 4.2 | ◯ | ◯ | ◯◯ |
| 304 Invention | XIII | 2.3 | a | 4.3 | ◯ | ◯ | ◯◯ |
| 305 Invention | XIV | 2.1 | a | 4.7 | ◯ | Δ | ◯ |
| 306 Invention | XV | 2.2 | a | 4.6 | ◯ | Δ | ◯ |
| 307 Invention | II | 2.1 | a | 4.3 | ◯ | Δ | ◯ |

It is obvious from the results shown in Table 7 that the use of resin particles having a higher degree of compressive strength according to the present invention makes it possible to achieve higher levels of pencil hardness and steel wool resistance. It is also obvious that the use of flat resin particles like blood platelets according to the present invention is more beneficial for achieving an improved level of black clarity.

### Example 4

(Preparation of Optical Functional Film Samples 401 to 403: Forming of Light-Diffusing Layer and Low Refractive Index Layer by Coating)

Optical functional film samples 401 to 403 were each prepared by coating the coating solution (II) for a light diffusing layer according to Example 1 (film thickness: 4.6 μm) on the cellulose acetate film having the thickness of 40 μm prepared in Example 1 in the same manner as in Example 1 and further coating thereon the coating material (a) for low refractive index layer used in Example 1 and the coating materials (i) and 0) for low refractive index layer prepared in Example 1 in the same manner as in Example 1 (film thickness: 0.09 μm).

(Evaluation of Optical Functional Film Samples 401 to 403)

The results of evaluation of optical functional film samples 401 to 403 are shown in Table 8.

(12) Dynamic Friction Coefficient

After it had been left to stand at a temperature of 25° C. and a relative humidity of 60% for two hours, each sample was tested by using a HEIDON-14 (trade name) dynamic friction tester and employing 5 mm stainless steel balls under a load of 100 g and at a rate of 60 cm/min.

(13) Creasing

Creasing occurs if a sample film is low in its sliding property when it is heat treated, since its expansion and contraction occur in a non-uniform way, form winding creases on the film and thereby lower its surface smoothness. The results of visual inspection were classified by the standards as stated below.

O: No creasing was visible.

Δ:Creasing was visible in a film portion occupying less than 3% of its length.

X: Creasing was visible in a film portion occupying 3% or more of its length.

TABLE 8

| | Coating | Coating | | |
|---|---|---|---|---|
| | solution for | material for low | Dynamic | |
| | light diffusing | refractive index | friction | |
| Sample No. | layer | layer | coefficient | Crease |
| 401 Invention | II | a | 0.09 | Δ |
| 402 Invention | II | i | 0.06 | ◯ |
| 403 Invention | II | j | 0.06 | ◯ |

It is obvious from the results shown in Table 9 that the optical functional film of the present invention containing a silicone compound and thereby having a low dynamic friction coefficient is not or hardly creased when it is wound.

### Example 12

(Production of Polarizing Plate Samples 501 to 529)

Both surfaces of a polarizer produced by adsorbing iodine to polyvinyl alcohol and stretching the film were protected by bonding thereto a 80 μm-thick triacetyl cellulose film (TAC-TD80U, produced by Fuji Photo Film Co., Ltd.) subjected to dipping in 1.5 mol/liter of an aqueous NaOH solution at 55° C. for 2 minutes, neutralization and washing with water, and bonding the optical functional film samples 101 to 129 produced in Example 1 (after saponification treatment). In this way, a polarizing plate was produced. These polarizing plates are designated as Polarizing Plate Samples 501 to 529.

(Evaluation of Polarizing Plate)

The polarizing plate on the viewing side of an LCD panel (VA mode) having an image size of 32 inches was partially stripped, and each of the polarizing plate samples 501 to 529 was laminated instead. The obtained display device was evaluated on the following items.

(14) Dark Room Contrast

The front contrast was measured with an eye in a dark room.

(15) Glaring

The LCD panel was displayed in full green, and the degree of glaring (the state such that partial expansion/shrinkage of each pixel of B, G and R is non-uniformly viewed) was evaluated with an eye.

(16) Projection

A bare fluorescent lamp (8,000 cd/m²) without louver was projected on the obtained liquid crystal television from an angle of 45°, and the degree of projection of the fluorescent lamp observed from the direction of −45° was evaluated with an eye.

As a result, in LCD panels using on its viewing side Polarizing Plate Samples 501 to 529 in which the optical functional films is laminated as the protective films, the reduction of contrast was not worrisome and the glaring and projection were significantly improved as compared with the LCD panel using a polarizing plate in which only a TAC film was laminated as the protective film.

### Example 16

(Production of Polarizing Plate Samples 601 to 629)

A polarizing plate samples 601 to 629 obtained by changing the protective film comprising only a triacetyl cellulose film of the polarizing plate samples 501 to 529 to a view angle enlarging film (Wide View Film SA 12B, produced by Fuji Photo Film Co., Ltd.) was used for the polarizing film on the viewing side of a transmissive TN liquid crystal cell (the view angle enlarging film was on the liquid crystal cell side), and a polarizing plate using the view angle enlarging film and a triacetyl cellulose film as the protective film (the view angle enlarging film was on the liquid crystal cell side) was used for the polarizing plate on the backlight side, thereby producing a liquid crystal display device. The produced liquid crystal display device was evaluated with an eye, as a result, a clear image with less projection of the background light was obtained and at the same time, a high-grade liquid crystal display assured of a very wide view angle in the vertical and horizontal directions was obtained.

### Reference

The light-diffusing layer and the low refractive index layer of Example 1-1 were coated by the bar coating method. A #10 bar was used for the light-diff-using layer, and a #2.9 bar was used for the low refractive index layer. In the light-diff-using layer, streaked surface unevenness was generated at a coating speed of 15 m/min or more and in the low refractive index layer, streaked surface unevenness was generated at a coating speed of 20 m/min or more.

The optical functional film of the present invention is excellent in antireflective and other optical characteristics. Furthermore, a thin functional film excellent in anti-curling property and strength and having high moisture permeability can be provided steadily. The polarizing plate and the image display device of the present invention, in which such a film is disposed, are thin and lightweight, but can provide an excellently defined image of high quality

The optical functional film of the present invention is excellent in the antireflective or other various optical performances. Furthermore, a thinned functional film excellent in the curling preventing property or film strength can be provided. The polarizing plate and the image display device of the present invention, in which such a film is disposed, are thin and lightweight, nevertheless, can provide a high-quality image with excellent visibility.

The entire disclosure of each and every foreign patent application from which the benefit of foreign priority has been claimed in the present application is incorporated herein by reference, as if fully set forth.

What is claimed is:

1. An optical functional film comprising:
a transparent support comprising a cellulose acylate film and having a thickness of less than 80 μm; and
at least one coating layer on at least one surface of the transparent support,
wherein said at least one coating layer has a total thickness of 5 μm or less.

2. The optical functional film according to claim 1,
wherein the transparent support has a thickness of 10 to 40 μm.

3. The optical functional film as claimed in claim 1,
wherein said at least one coating layer comprises at least one inorganic fine particle-containing layer, and
at least one of said at least one inorganic fine particle-containing layer comprises an inorganic fine particle having an average particle diameter of 0.02 to 0.3 μm.

4. The optical functional film as claimed in claim 3,
wherein the inorganic fine particle in at lease one of said at least one inorganic fine particle-containing layer is an electrically conducting inorganic fine particle.

5. The optical functional film as claimed in claim 3,
wherein the coating layer comprising the electrically conducting inorganic fine particle is coated on the side closest to the support out of all of said at least one coating layer.

6. The optical functional film as claimed in claim 1,
wherein at least one of said at least one coating layer comprises a composition obtained by curing a polyfunctional acrylate-based compound having added thereto alkylene oxides.

7. The optical functional film as claimed in claim 1,
wherein said at least one layer comprises at least two layers including a light-diffusing layer and a low refractive index layer lower in the refractive index by 0.02 or more than the light-diffusing layer, and
the light-diffusing layer is provided on the side closer to the support than the low refractive index layer.

8. The optical functional film as claimed in claim 1,
wherein said at least one coating layer comprises a light-diffusing layer comprising a light-transparent fine particle, and
the light-transparent fine particle are a resin particle having a compressive strength of 22 to 59 N/mm².

9. The optical functional film as claimed in claim 1,
wherein said at least one coating layer comprises a light-diffusing layer comprising a light-transparent fine particle, and
the light-transparent fine particle has an average particle diameter of from 20 to 100% of a film thickness of the light-diffusing layer.

10. The optical functional film as claimed in claim 1,
wherein said at least one coating layer comprises a light-diffusing layer comprising a light-transparent fine particle, and
the light-transparent fine particle has a flat shape like that of a blood platelet and have an average thickness (T₁) to average maximum diameter (D₁) ratio (T₁/D₁) in the range of 0.4 to 0.7.

11. The optical functional film as claimed in claim 1,
wherein said at least one coating layer comprises a light-diff-using layer,
the light-diff-ising layer comprises: a light-transparent resin having a refractive index of 1.45 to 1.90; and a light-transparent fine particle, and
the difference in the refractive index between the light-transparent resin and the light-transparent fine particle is from 0 to 0.30.

12. The optical functional film as claimed in claim 1,
wherein any one of said at least coating layer comprises at least one of an organosilane compound represented by formula (a) and a derivative thereof:
(R¹⁰)ₛ—Si(Z)₄₋ₛ Formula (a):
wherein R¹⁰ represents a substituted or unsubstituted alkyl group or a substituted or unsubstituted aryl group, Z represents a hydroxyl group or a hydrolyzable group, and s represents an integer of 1 to 3.

13. The optical functional film as claimed in claim 7,
wherein the low refractive index layer comprises a hollow silica fine particle.

14. The optical functional film as claimed in claim 7,
wherein the low refractive index layer is formed by a crosslinking or polymerization reaction of a fluorine-containing compound represented by formula (1): 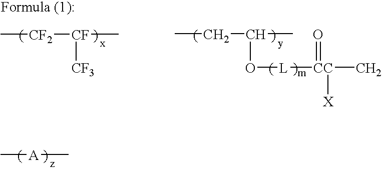
wherein L represents a linking group having a carbon number of 1 to 10, m represents 0 or 1, X represents a hydrogen atom or a methyl group, A represents an arbitrary vinyl monomer polymerization unit and may be a single polymerization unit or may comprise a plurality of polymerization units, x, y and z represent mol % of respective constituent polymerization units and each represents a value satisfying 30≦x≦60, 5≦y≦70 and 0≦z≦65.

15. The optical functional film as claimed in claim 14,
wherein the low refractive index layer comprises a silicone compound and its surface has a dynamic friction coefficient of 0.15 or less.

16. The optical functional film as claimed in claim 1,
wherein the cellulose acylate film is a cellulose acylate film having a water content of 2.9% by mass or less at 25° C. and a relative humidity of 80%.

17. The optical functional film as claimed in claim 1,
wherein the cellulose acylate film is a cellulose acylate film comprising: at least one hydrophobizing agent having a hydrogen-bonding and hydrogen- donating group; and at least one low-molecular compound having a mass-average octanol-water partition coefficient (log P) of 4 to 12 and a molecular weight of 100 to 2,000.

18. A method for producing the optical functional film claimed in claim 1, comprising
forming any one of said at least one coating layer by coating a coating solution according to a die coating method.

19. A polarizing plate comprising:
a polarizing film; and
two protective films for the polarizing film,
wherein the optical functional film claimed in claim 1 is used for at least one of the protective films.

20. An image display device comprising the optical functional film claimed in claim 1 disposed on an image display surface of the image display device.

21. An image display device comprising the polarizing plate claimed in claim 19 disposed on an image display surface of the image display device.

22. The image display device as claimed in claim 21,
wherein the image display device is a TN-mode, STN-mode, IPS-mode, VA-mode or OCB-mode transmissive, reflective or semi-transmissive liquid crystal display device.
